(19) United States
(12) Patent Application Publication
(10) Pub. No.: US 2024/0313223 A1
(43) Pub. Date: Sep. 19, 2024

(54) BATTERIES WITH ELECTRODES PROCESSED WITH A POLYMERIZABLE BINDER PRECURSOR

(71) Applicant: Sila Nanotechnologies, Inc., Alameda, CA (US)

(72) Inventors: Gleb Nikolayevich YUSHIN, Atlanta, GA (US); Samik JHULKI, Emeryville, CA (US); Sung Hyun LIM, Mountain View, CA (US)

(21) Appl. No.: 18/606,437

(22) Filed: Mar. 15, 2024

Related U.S. Application Data
(60) Provisional application No. 63/490,974, filed on Mar. 17, 2023.

(51) Int. Cl. H01M 4/62; H01M 4/38; H01M 4/587; H01M 10/0525

(52) U.S. Cl. CPC H01M 4/622; H01M 4/386; H01M 4/587; H01M 10/0525

(57) ABSTRACT

A method of making a battery electrode is disclosed. In some embodiments, the method includes stages (A1), (A2), and (A3). Stage (A1) includes providing a battery electrode precursor composition. The battery electrode precursor composition includes an electrochemically active material and a polymerizable binder precursor. Stage (A2) includes processing the battery electrode precursor composition to form a battery electrode precursor disposed on and/or in a current collector. Stage (A3) includes transforming the battery electrode precursor to form a battery electrode including a binder. The transforming of the battery electrode precursor includes polymerizing the polymerizable binder precursor in the battery electrode precursor to form the binder. A battery electrode, a lithium-ion battery, and a method of making a lithium-ion battery are also disclosed.

### CROSS-REFERENCE TO RELATED APPLICATIONS

The present Application for Patent claims the benefit of U.S. Provisional Application No. 63/490,974, entitled “BATTERIES WITH ELECTRODES PROCESSED WITHOUT CONVENTIONAL SOLVENTS,” filed Mar. 17, 2023, which is assigned to the assignee hereof, and expressly incorporated herein by reference in its entirety.

### BACKGROUND

### Field

Aspects of the present disclosure relate generally to energy storage devices, and more particularly to battery technology and the like.

### Background

Owing in part to their relatively high energy densities, relatively high specific energy, light weight, and potential for long lifetimes, advanced rechargeable batteries are desirable for a wide range of consumer electronics, electric vehicles, grid storage and other important applications. However, despite the increasing commercial prevalence of batteries, further development of these batteries is needed, particularly for applications in low- or zero-emission, hybrid-electric or fully electric vehicles, consumer electronics, wearable devices, energy-efficient cargo ships and locomotives, drones, aerospace applications, and power grids. Further improvements are desired for various rechargeable batteries, such as Li and Li-ion batteries, Na and Na-ion batteries, K and K-ion batteries, and dual-ion batteries, and dual ion batteries, to name a few.

In certain types of rechargeable batteries, at least some of the charge storing active materials in either the anode or the cathode or both may be produced as high-capacity nanocomposite powders, which exhibit moderately high volume changes (e.g., about 8-180 vol. %) during the first charge-discharge cycle and moderate volume changes (e.g., about 4-50 vol. %) during the subsequent charge-discharge cycles. A subset of such charge-storing particles includes particles with an average size (e.g., diameter or thickness) in the range of about 0.2 to about 40 microns (micrometers, or μm), as measured using laser particle size distribution analysis (LPSA), laser image analysis, electron microscopy, optical microscopy, or other suitable techniques.

In certain types of Li metal and Li-ion rechargeable batteries, charge storing anodes may comprise silicon (Si)-comprising anode particles with gravimetric capacities in the range from about 800 mAh/g to about 3000 mAh/g (per mass of Si-comprising anode particles in a Li-free state). A subset of such Si-comprising anode particles includes anode particles that are Si-comprising and C-comprising nanocomposite particles (referred to herein as Si—C composite or Si—C nanocomposite particles, even if such particles comprise elements other than Si and C in relatively small quantities of less than about 10-25 at. %). Such a class of charge-storing particles offers great promises for scalable manufacturing and achieving high cell-level energy density and other performance characteristics. A subset of such anodes includes anodes with the electrode layer exhibiting capacity in the range from about 400 mAh/g to about 2800 mAh/g (per mass of the electrode layer, not counting the mass of the current collector, in a Li-free state). Such a class of charge-storing anodes offers great potential for increasing gravimetric and volumetric energy of rechargeable batteries.

Conventional batteries, such as conventional Li-ion batteries, comprise anodes and cathodes that are produced from conventional solvent-comprising slurries coated on metal current collectors, which are then dried and calendered (densified). Herein, the term “conventional solvent,” in the context of a slurry used to form battery electrodes, is used to refer to a liquid substance in which solid components of the slurry (e.g., electrochemically active particles, conductive additive particles, etc.) are dispersed (e.g., suspended). Herein, “conventional solvents” may sometimes be referred to as “solvents” for brevity. After the slurry is coated on a substrate (e.g., current collector), most or substantially all of the conventional solvents are removed in a drying process. Unfortunately, such conventional battery electrodes typically suffer from poor mechanical properties or slow ion transport or both, particularly when produced at relatively high areal capacity loadings (e.g., above around 4 mAh/cm², more so above around 6 mAh/cm² and even more so above around 8 mAh/cm²). Some of such issues stem from non-ideal distribution of the binder, active material, and conductive additives in the solvent-comprising slurry-cast electrodes or stresses originating during solvent evaporation upon electrode drying. Furthermore, solvent evaporation during electrode drying may require significant time and energy, which increases battery production complexity and cost and requires high energy consumption. Furthermore, undesirable interactions between some moisture-sensitive active materials in the solvent-comprising slurries with the moisture typically present in such solvents may induce substantial battery degradation.

The development of “conventional solvent-free electrode production techniques may be an attractive alternative to slurry casting, as it may improve battery performance and reduce battery production cost and energy requirements. Unfortunately, conventional techniques utilized for solvent-free fabrication of electrodes still typically suffer from poor consistency, poor distribution of the binder and conductive additives, relatively poor performance (e.g., poor adhesion to the current collectors or insufficiently good rate or insufficiently good stability during cycling or storage, etc.) and may require undesirably large binder content.

Accordingly, there remains a need for improved batteries, components, and other related materials and manufacturing processes.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of making a battery electrode includes (A1) providing a battery electrode precursor composition comprising an electrochemically active material and a polymerizable binder precursor; (A2) processing the battery electrode precursor composition to form a battery electrode precursor disposed on and/or in a current collector; and (A3) transforming the battery electrode precursor to form a battery electrode comprising a binder, wherein: the transforming of the battery electrode precursor comprises polymerizing the polymerizable binder precursor in the battery electrode precursor to form the binder.

In some aspects, the electrochemically active material comprises silicon and carbon.

In some aspects, the electrochemically active material comprises graphite.

In some aspects, the polymerizable binder precursor comprises one or more of: a monomer, an oligomer, and a polymer.

In some aspects, the polymerizable binder precursor is in a liquid form at any temperature in a range of about 20° C. to about 30° C.

In some aspects, the battery electrode precursor composition comprises a polymerization inhibitor and/or a polymerization initiator.

In some aspects, the battery electrode precursor composition additionally comprises electrically conductive additives and/or functional additives.

In some aspects, the battery electrode precursor composition is substantially free of conventional solvents.

In some aspects, the battery electrode precursor composition additionally comprises a Li salt.

In some aspects, the providing of the battery electrode precursor composition comprises mixing the electrochemically active material and the polymerizable binder precursor.

In some aspects, the providing of the battery electrode precursor composition comprises making gas bubbles in the battery electrode precursor composition.

In some aspects, the processing of the battery electrode precursor composition comprises casting the battery electrode precursor composition onto and/or into the current collector or extruding the battery electrode precursor composition.

In some aspects, the processing of the battery electrode precursor composition comprises (1) granulating the battery electrode precursor composition and (2) extruding the granulated battery electrode precursor composition.

In some aspects, the processing of the battery electrode precursor composition comprises coating the battery electrode precursor composition onto and/or into the current collector by electrostatic spray coating.

In some aspects, the polymerizing of the polymerizable binder precursor comprises applying one or more of the following to the battery electrode precursor: (1) a heat treatment, (2) an ultraviolet light treatment, and (3) an electron beam treatment.

In some aspects, (A4) densifying the battery electrode.

In an aspect, a battery electrode, wherein: the battery electrode is made according to the method of claim 1.

In some aspects, the battery electrode is characterized by a reversible areal capacity loading in a range of about 2 mAh/cm² to about 16 mAh/cm².

In an aspect, a lithium-ion battery includes an anode current collector; a cathode current collector; an anode disposed on and/or in the anode current collector; a cathode disposed on and/or in the cathode current collector; and an electrolyte ionically coupling the anode and the cathode, wherein: at least one of the anode and the cathode comprises a battery electrode.

In some aspects, the lithium-ion battery additionally comprises a separator electrically separating the anode and the cathode.

In some aspects, an energy content of the lithium-ion battery is in a range of about 1 Wh to about 2000 Wh.

In an aspect, a method of making a lithium-ion battery includes (B1) making a first electrode according to the method of claim 1, the battery electrode being the first electrode, the first electrode being disposed on and/or in a first current collector; (B2) making or providing a second electrode disposed on and/or in a second current collector; and (B3) assembling a battery cell from the first electrode and the second electrode and filling a space between the first electrode and the cathode with an electrolyte ionically coupling the first electrode and the second electrode to form the lithium-ion battery, wherein: the first electrode is configured as an anode and the second electrode is configured as a cathode, or the first electrode is configured as a cathode and the second electrode is configured as an anode.

In an aspect, a lithium-ion battery, wherein: the lithium-ion battery is made according to the method of (B1), (B2) and (B3).

In some aspects, an energy content of the lithium-ion battery is in a range of about 1 Wh to about 2000 Wh.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of embodiments of the disclosure and are provided solely for illustration of the embodiments and not limitation thereof. Unless otherwise stated or implied by context, different hatchings, shadings, and/or fill patterns in the drawings are meant only to draw contrast between different components, elements, features, etc., and are not meant to convey the use of particular materials, colors, or other properties that may be defined outside of the present disclosure for the specific pattern employed.

FIG. 1 illustrates an example Li-ion battery in which the components, materials, processes, and other techniques described herein may be implemented.

FIG. 2 illustrates an example method for the formation of a Li-ion battery using electrodes that are processed without use of conventional solvents. In this illustrative example both electrodes (anode, cathode) are produced without use of conventional solvents. In other cases, just one of the anode and the cathode may be produced without use of conventional solvents. Herein, a process for making a battery electrode without use of conventional solvents or a process for making a battery electrode that is substantially free of conventional solvents is sometimes referred to as a “dry” process. Herein, an electrode coating process is regarded as being “substantially free of conventional solvents” when the coating formulation (e.g., “slurry”) that is coated to form the electrode contains conventional solvents, if any, at a volume fraction of about 3 vol. % or less.

FIG. 3 shows a general illustration of methods for making a battery electrode according to “dry” processes.

FIG. 4 illustrates an example casting method of making a battery electrode according to a “dry” process.

FIG. 5 schematically illustrates an example of a foamed battery electrode precursor composition (i.e., a battery electrode precursor composition comprising gas bubbles), which may be implemented in a “dry” process.

FIG. 6 illustrates an example extrusion method of making a battery electrode according to a “dry” process.

FIG. 7 illustrates an example method, including electrostatic spray coating, of making a battery electrode according to a “dry” process.

FIG. 8 illustrates an implementation of an example acrylate-based polymer binder chemistry for use in a “dry” electrode process.

FIG. 9 illustrates an implementation of an example acrylate-based copolymer binder chemistry for use in a “dry” electrode process.

FIG. 10 illustrates an example casting method of making a battery electrode according to one variation of a “dry” process, in which the electrode mass (battery electrode precursor composition) comprises a fluorinated polymer as a first binder and a F-free polymerizable binder precursor (e.g., monomers, oligomers, polymers) which polymerizes to form a second binder.

FIG. 11 illustrates an example casting method of making a battery electrode according to another variation of a “dry” process. According to the process of FIG. 11, a F-free polymerizable binder precursor is provided as part of a pre-mix that also comprises other components including electrode particles, conductive additives, and/or other additives.

### DETAILED DESCRIPTION

Aspects of the present invention are disclosed in the following description and related drawings directed to specific embodiments of the invention. The term “embodiments of the invention” does not require that all embodiments of the invention include the discussed feature, advantage, process, or mode of operation, and alternate embodiments may be devised without departing from the scope of the invention. Additionally, well-known elements of the invention may not be described in detail or may be omitted so as not to obscure other, more relevant details.

Any numerical range described herein with respect to any embodiment of the present invention is intended not only to define the upper and lower bounds of the associated numerical range, but also as an implicit disclosure of each discrete value within that range in units or increments that are consistent with the level of precision by which the upper and lower bounds are characterized. For example, a numerical distance range from 7 nm to 20 nm (i.e., a level of precision in units or increments of ones) encompasses (in nm) a set of [7, 8, 9, 10, . . . , 19, 20], as if the intervening numbers 8 through 19 in units or increments of ones were expressly disclosed. In another example, a temperature range from about −120° C. to about −60° C. encompasses (in ° C.) a set of temperature ranges from about −120° C. to about −119° C., from about −119° C. to about −118° C., from about −61° C. to about −60° C., as if the intervening numbers (in ° C.) between −120° C. and −60° C. in incremental ranges were expressly disclosed. In yet another example, a numerical percentage range from 30.92% to 47.44% (i.e., a level of precision in units or increments of hundredths) encompasses (in %) a set of [30.92, 30.93, 30.94, . . . , 47.43, 47.44], as if the intervening numbers between 30.92 and 47.44 in units or increments of hundredths were expressly disclosed. Hence, any of the intervening numbers encompassed by any disclosed numerical range are intended to be interpreted as if those intervening numbers had been disclosed expressly, and any such intervening number may thereby constitute its own upper and/or lower bound of a sub-range that falls inside of the broader range. Each sub-range (e.g., each range that includes at least one intervening number from the broader range as an upper and/or lower bound) is thereby intended to be interpreted as being implicitly disclosed by virtue of the express disclosure of the broader range. In yet another example, a numerical range with upper and lower bounds defined at different levels of precision shall be interpreted in increments corresponding to the bound with the higher level of precision. For example, a numerical percentage range from 30.92% to 47.4% (i.e., levels of precision in units or increments of hundredths and tenths, respectively) encompasses (in %) a set of [30.92, 30.93, 30.94, . . . , 47.39, 47.40], as if 47.4% (tenths) was recited as 47.40% (hundredths) and as if the intervening numbers between 30.92 and 47.40 in units or increments of hundredths were expressly disclosed.

It will be appreciated that the level of precision of any particular measurement, threshold or other inexact parameter may vary based on various factors such as measurement instrumentation, environmental conditions, and so on. Below, reference to such measurements or thresholds may thereby be interpreted as a respective value assuming a pseudo-exact level of precision (e.g., a threshold of 80% comprises 80.0000 . . . %). Alternatively, reference to such measurements or thresholds may be described via a qualifier that captures pseudo-exact value(s) plus a range that extends above and/or below the pseudo-exact value(s). For example, the above-noted threshold of 80% may be interpreted as “about”, “approximately”, “around”, “˜” or “˜” 80%, which encompasses “exactly” 80% (e.g., 80.0000 . . . %) plus some range around 80%. In some designs, the range encompassed around a measurement or threshold via the “about”, “approximately”, “around” or “˜” qualifier may encompass the level of precision for which the respective measurement or threshold is capable of being measured by the most accurate commercially available instrumentation as of the priority date of the subject application.

In the following description, various material properties are described so as to characterize materials (e.g., molecules, particles, powders, slurries, electrodes, separators, electrolytes, battery cells, etc.) in various states. Note that one of ordinary skill in the art is generally capable of selecting (and is herein assumed to select) the most appropriate measurement technique for any particular measurement. Moreover, in some cases, the most appropriate measurement technique may include a combination of techniques. While the following Table characterizes various measurement type options for particular material types and particular material properties, certain embodiments of the disclosure may be more specifically characterized in context with a specific measurement technique and/or specific commercially available instrumentation, if warranted. Note that while the Table below characterizes measurements with respect to active material particles, similar measurements may also be made with respect to other particle types such as precursor particles (e.g., carbon particles, etc.). Hence, unless otherwise indicated, the following Table provides examples of how such material properties may be readily measured by one of ordinary skill in the art using commercially available instrumentation:

Table of Techniques and Instrumentation for Material Property Measurements

| | | Measurement | |
|---|---|---|---|
| Material Type | Property Type | Instrumentation | Measurement Technique |
| Active | Coulombic | Potentiostat | Charge (current) is passed to an |
| Material | Efficiency | | electrode containing the active |
| | | | material of interest until a given |
| | | | voltage limit is reached. Then, |
| | | | the current is reversed until a |
| | | | second voltage limit is reached. |
| | | | The ratio of the charge passed |
| | | | determines the coulombic |
| | | | efficiency. |
| Active | Partial Vapor | Manometer | The partial vapor pressure of an |
| Material | Pressure (e.g., | | active material in a mixture |
| | Torr.) at a | | (e.g., composite particle) at a |
| | Temperature | | particular temperature is given |
| | (e.g., K) | | by the known vapor pressure of |
| | | | the active material multiplied by |
| | | | its mole fraction in the mixture. |
| Active | Volume | Gas pycnometer | Gas pycnometer measures the |
| Material | | | skeletal volume of a material by |
| Particle | | | gas displacement using the |
| | | | volume-pressure relationship of |
| | | | Boyle's Law. A sample of |
| | | | known mass is placed into the |
| | | | sample chamber and maintained |
| | | | at a constant temperature. An |
| | | | inert gas, typically helium, is |
| | | | used as the displacement |
| | | | medium. |
| | | | Note: A vol. % change may be |
| | | | calculated from two volume |
| | | | measurements of the active |
| | | | material particle. |
| Active | Open Internal | nitrogen | nitrogen sorption/desorption |
| Material | Pore Volume | sorption/desorption | isotherm technique |
| Particle | (e.g., cc/g or | isotherm | |
| | cm³/g) | | |
| Active | Volume- | PSA, scanning | PSA using laser scattering, |
| Material | Average Pore | electron microscope | electron microscopy (SEM, |
| Particle | Size (e.g., nm) | (SEM), transmission | TEM, STEM), laser microscopy |
| | | electron microscope | (for larger particles), optical |
| | | (TEM), scanning | microscopy (for larger |
| | | transmission | particles), neutron scattering, X- |
| | | microscope (STEM), | ray microscopy imaging |
| | | laser microscope, | |
| | | Synchrotron X-ray, | |
| | | X-ray microscope | |
| Active | Closed | Gas pycnometer | Closed porosity may be |
| Material | Internal Pore | | measured by analyzing true |
| Particle | Volume (e.g., | | density values measured by |
| | cc/g or cm³/g) | | using an argon gas pycnometer |
| | | | and comparing to the theoretical |
| | | | density of the individual |
| | | | material components present in |
| | | | Si-comprising particles |
| Active | Closed | Gas pycnometer | With a pycnometer, the amount |
| Material | Internal | | of a certain medium (liquid or |
| Particle | Volume- | | Helium or other analytical |
| | Average Size | | gases) displaced by a solid can |
| | (e.g., nm) | | be determined. |
| Active | Size | TEM, STEM, SEM, | Laser particle size distribution |
| Material | (e.g., nm, μm, | X-Ray, PSA, etc. | analysis (LPSA), laser image |
| Particle | etc.) | | analysis, electron microscopy, |
| | | | optical microscopy or other |
| | | | suitable techniques |
| | | | transmission electron |
| | | | microscopy (TEM), scanning |
| | | | transmission electron |
| | | | microscopy (STEM), scanning |
| | | | electron microscopy (SEM)), X- |
| | | | ray microscopy, X-ray |
| | | | diffraction, neutron scattering |
| | | | and other suitable techniques |
| Active | Composition | Balance | Note #1: A wt. % change may |
| Material | (e.g., mass | | be calculated by comparing the |
| Particle | fraction or wt. | | mass fraction of a material in |
| | %, mg, | | the particle relative to the total |
| | number of | | particle mass. |
| | atoms, etc.) | | Note #2: The capacity |
| | | | attributable to particular active |
| | | | material(s) in the particle may |
| | | | be derived from the |
| | | | composition, based on the |
| | | | known theoretical capacit(ies) |
| | | | of each active material. |
| | | | Note #3: The composition of the |
| | | | particle may be characterized in |
| | | | terms of weight (e.g., mg). The |
| | | | composition of may |
| | | | alternatively be characterized by |
| | | | a number of atoms of a |
| | | | particular element (e.g., Si, C, |
| | | | etc.). In case of atoms, the |
| | | | number of atoms may be |
| | | | estimated from the weight of |
| | | | that atom in the particle (e.g., |
| | | | based on gas chromatography) |
| Active | Specific | Potentiostat | An electrode containing an |
| Material | Capacity | | active anode or cathode material |
| Particle, | | | of interest is charged or |
| Battery Half- | | | discharged (by passing electrical |
| Cell | | | current to the electrode) within |
| | | | certain potential limits using an |
| | | | electrochemical cell with |
| | | | suitable reference electrode, |
| | | | typically lithium metal. The |
| | | | total charge passed divided by |
| | | | the active material mass gives |
| | | | this quantity. The active mass is |
| | | | computed by multiplying the |
| | | | total mass of the electrode by |
| | | | the active material mass |
| | | | fraction. Both reversible and |
| | | | irreversible capacity during |
| | | | charge or discharge may be |
| | | | calculated in this way. |
| Active | BET SSA | BET instrument | A sample is placed into a sealed |
| Material | (e.g., m²/g) | | chamber, where nitrogen is |
| Particle | | | introduced. The change in |
| | | | pressure of the nitrogen is used |
| | | | to calculate the surface area of |
| | | | the sample. |
| Active | Aspect Ratio | SEM, TEM | The dimensions and shape of |
| Material | | | the particles are measured in |
| Particle | | | SEM or TEM. |
| Active | True Density | Argon Gas | True density values may be |
| Material | of Particle | Pycnometer | measured by using an argon gas |
| Particle | (e.g., g/cc or | | pycnometer and comparing to |
| | g/cm³) | | the theoretical density of the |
| | | | individual material components |
| | | | present in the particle. |
| Active | Particle Size | Dynamic light | laser particle size distribution |
| Material | Distribution | scattering particle | analysis (LPSA) on well- |
| Particle | (e.g., nm or | size analyzer, | dispersed particle suspensions in |
| Population | μm) | scanning electron | one example or by image |
| | | microscope | analysis of electron microscopy |
| | | | images, or by other suitable |
| | | | techniques. While there are |
| | | | diverse processes of measuring |
| | | | PSDs, laser particle size |
| | | | distribution analysis (LPSA) is |
| | | | quite efficient for some |
| | | | applications. Note that other |
| | | | types of particle size |
| | | | distribution (e.g., by SEM |
| | | | image analysis) could also be |
| | | | utilized (and may even lead to |
| | | | more precise measurements, in |
| | | | some experiments). Using |
| | | | LPSA, particle size parameters |
| | | | of a population's PSD may be |
| | | | measured, such as: a tenth- |
| | | | percentile volume-weighted |
| | | | particle size parameter (e.g., |
| | | | abbreviated as D₁₀), a fiftieth- |
| | | | percentile volume-weighted |
| | | | particle size parameter (e.g., |
| | | | abbreviated as D₅₀), a ninetieth- |
| | | | percentile volume-weighted |
| | | | particle size parameter (e.g., |
| | | | abbreviated as D₉₀), and a |
| | | | ninety-ninth-percentile volume- |
| | | | weighted particle size parameter |
| | | | (e.g., abbreviated as D₉₉). |
| Active | Width (e.g., | PSA | Parameters relating to |
| Material | nm) | | characteristic widths of the PSD |
| Particle | | | may be derived from these |
| Population | | | particle size parameters, such as |
| | | | D₅₀ − D₁₀ (sometimes referred to |
| | | | herein as a left width), D₉₀ − D₅₀ |
| | | | (sometimes referred to herein as |
| | | | a right width), and D₉₀ − D₁₀ |
| | | | (sometimes referred to herein as |
| | | | a full width). |
| Active | Cumulative | Computed via LPSA | A cumulative volume fraction, |
| Material | Volume | data | defined as a cumulative volume |
| Particle | Fraction | | of the composite particles with |
| Population | | | particle sizes of a threshold |
| | | | particle size or less, divided by a |
| | | | total volume of all of the |
| | | | composite particles, may be |
| | | | estimated by LPSA. |
| Active | Composition | Balance | The mass of active materials |
| Material | (e.g., wt. %) | | added to the electrode divided |
| Particle | | | by the total mass of the |
| Population | | | electrode. |
| Active | BET SSA | BET Isotherm | obtained from the data of |
| Material | (e.g., m2/g) | | nitrogen sorption-desorption at |
| Particle | | | cryogenic temperatures, such as |
| Population | | | about 77 K |
| Electrolyte | Salt | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar mass of the |
| | | | salt is then used to calculate the |
| | | | total number of moles of salt in |
| | | | the solution. The moles of salt is |
| | | | then divided by the total volume |
| | | | to obtain the solvent |
| | | | concentration in M (mol/L). |
| Electrolyte | Solvent | balance, volumetric | Total volume of the solution is |
| | Concentration | pipette | computed either via the sum of |
| | (e.g., M or | | the volume of the constituents |
| | mol. %) | | (measured by volumetric |
| | | | pipette), or by the mass of the |
| | | | constituents divided by the |
| | | | density. The molar volume of |
| | | | each solvent is then used to |
| | | | calculate the total number of |
| | | | moles of solvent in the solution. |
| | | | The moles of solvent is then |
| | | | divided by the total volume to |
| | | | obtain the solvent concentration |
| | | | in M (mol/L). |
| Electrode | Composition | Balance | The mass fraction of a material |
| | (e.g., mass | | (e.g., active material, active |
| | fraction or wt. | | material particle, binder, etc.) in |
| | %) | | the electrode is calculated based |
| | | | on a measured or estimated |
| | | | mass of the material and a |
| | | | measured or estimated mass of |
| | | | the electrode, excluding the |
| | | | electrode current collector. |
| | | | Note: The mass of individual |
| | | | components (e.g., composite |
| | | | active material particles, |
| | | | graphite particles, binder, |
| | | | function additive(s), etc.) of the |
| | | | battery electrode composition |
| | | | may be measured before being |
| | | | mixed into a slurry to estimate |
| | | | their mass in a casted electrode. |
| | | | The mass of materials deposited |
| | | | onto and/or into the casted |
| | | | electrode may be measured by |
| | | | comparing the weight of the |
| | | | casted electrode before/after the |
| | | | material deposition. |
| Electrode | Areal Binder | balance | A mass fraction of the binder in |
| | Loading (e.g., | | the battery electrode, divided by |
| | mg/m²) | | a product of (1) a mass fraction |
| | | | of the active material (e.g., Si—C |
| | | | nanocomposite, etc.) particles in |
| | | | the battery electrode, and (2) a |
| | | | Brunauer-Emmett-Teller (BET) |
| | | | specific surface area of the |
| | | | population |
| Electrode | Capacity | Calculated | Measure mass (wt.) of active |
| | Attributable to | | material in electrode, and |
| | Active | | calculate electrode capacity |
| | Material | | based on known theoretical |
| | (active | | capacity of the active material. |
| | material | | For example, the average wt. % |
| | capacity | | of active material in each active |
| | fraction) | | material particle may be |
| | | | measured, and used to calculate |
| | | | the mass of the active material |
| | | | based on the mass of the active |
| | | | material particles before being |
| | | | mixed in slurry. This process |
| | | | may be repeated if the electrode |
| | | | includes two or more active |
| | | | materials to calculate the |
| | | | relative capacity attribution for |
| | | | each active material in the |
| | | | electrode. |
| Electrode | Capacity | Potentiostat and | Determine average specific |
| | Attributable to | balance | capacity (g/mAh) of active |
| | Active | | material particles. For example, |
| | Material | | the average specific capacity |
| | Particles | | may be estimated from the |
| | (active | | average wt. % of active |
| | material | | material(s) in each particle and |
| | particle | | its associated known theoretical |
| | capacity | | capacit(ies). Then, measure |
| | fraction) | | mass (wt.) of active material |
| | | | particles in electrode before |
| | | | being mixed in slurry, which |
| | | | may be used to calculate the |
| | | | capacity attributable to that |
| | | | active material. This process |
| | | | may be repeated if the electrode |
| | | | includes two or more active |
| | | | material particle types to |
| | | | calculate the relative capacity |
| | | | attribution for each active |
| | | | material particle type in the |
| | | | electrode. |
| Electrode | Mass of | balance | The average wt. % of active |
| | Active | | material in each active material |
| | Material in | | particle may be measured, and |
| | Electrode | | used to calculate the mass of the |
| | | | active material based on the |
| | | | mass of the active material |
| | | | particles before being mixed in |
| | | | slurry. |
| Electrode | Mass of | balance | Measure the active material |
| | Active | | particle before the active |
| | Material | | material particle type is mixed |
| | Particle in | | in slurry. |
| | Electrode | | |
| Electrode | Areal | Potentiostat and | Areal capacity loading is weight |
| | Capacity | balance | of the coated active material per |
| | Loading (e.g., | | unit area (g/cm²) multiplied by |
| | mAh/cm²) | | the gravimetric capacity of the |
| | | | active material (not the |
| | | | electrode, but the active material |
| | | | itself with zero binder and zero |
| | | | electrolyte; mAh/g). |
| Electrode | Coulombic | Potentiostat | The change in charge inserted (or |
| | Efficiency | | extracted) to an electrode |
| | | | divided by the charge extracted |
| | | | (or inserted) from the electrode |
| | | | during a complete |
| | | | electrochemical cycle within |
| | | | given voltage limits. Because the |
| | | | direction of charge flow is |
| | | | opposite for cathodes and |
| | | | anodes, the definition is |
| | | | dependent on the electrode. |
| | | | Coulombic Efficiency is |
| | | | measured for both materials by |
| | | | constructing a so-called half- |
| | | | cell, which is an electrochemical |
| | | | cell consisting of a cathode or |
| | | | anode material of interest as the |
| | | | working electrode and a lithium |
| | | | metal foil which functions as |
| | | | both the counter and reference |
| | | | electrode. Then, charge is either |
| | | | inserted or removed from the |
| | | | material of interest until the cell |
| | | | voltage reaches an appropriate |
| | | | limit. Then, the process is |
| | | | reversed until a second voltage |
| | | | limit is reached, and the charge |
| | | | passed in both steps is used to |
| | | | calculate the Coulombic |
| | | | Efficiency, as described above. |
| Battery Cell | Rate | Potentiostat | This is the time it takes to |
| | Performance | | charge or discharge a battery |
| | | | between a given state of charge. |
| | | | It is measured by charging or |
| | | | discharging a battery and |
| | | | measuring the time until a |
| | | | specified amount of charge is |
| | | | passed, or until the battery |
| | | | operating voltage reaches a |
| | | | specified value. |
| Battery Cell | Cell | Potentiostat | A battery consisting of a |
| | Discharge | | relevant anode and cathode is |
| | Voltage (e.g., | | charged and discharged within |
| | V) | | certain voltage limits and the |
| | | | charge-weighted cell voltage |
| | | | during discharge is computed. |
| Battery Cell | Operating | Potentiostat and | Average temperature of battery |
| | Temperature | thermocouples | cell as measured at the |
| | | | positive/negative terminal/cell |
| | | | shaft/etc. while |
| | | | charging/discharging, or at a |
| | | | certain voltage level, or while a |
| | | | load is applied, etc. |
| Battery Half- | Anode | Potentiostat | An electrode containing an |
| Cell | Discharge (de- | | active anode material (or |
| | lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to de-lithiation of the anode) is |
| | | | computed. |
| Battery Half- | Cathode | Potentiostat | An electrode containing an |
| Cell | Discharge | | active cathode material (or |
| | (lithiation) | | mixture of active materials) of |
| | Potential | | interest is charged and |
| | (e.g., V) | | discharged (by passing electrical |
| | | | current to the electrode) within |
| | | | certain potential limits using an |
| | | | electrochemical cell with |
| | | | suitable reference electrode, |
| | | | typically lithium metal. The |
| | | | charge-averaged cell potential |
| | | | upon discharge (corresponding |
| | | | to lithiation of the cathode) is |
| | | | computed. |
| Battery Cell | Volumetric | Potentiostat | the VED is calculated by first |
| | Energy | | calculating the energy per unit |
| | Density | | area of the battery, and then |
| | (VED) | | dividing the energy per unit area |
| | | | by the sum of the illustrative |
| | | | anode, cathode, separator, and |
| | | | current collector thicknesses |
| Battery Cell | Internal | Potentiostat | The internal resistance (also |
| | Resistance | | known as impedance in many |
| | (impedance) | | contexts) is measured by |
| | | | applying small pulses of current |
| | | | to the battery cell and recording |
| | | | the instantaneous change in cell |
| | | | voltage. |
| Any Liquid | Surface | Surface Tensiometer | Surface Tension in mN/m may |
| | Tension | (e.g., Bubble | be measured at room |
| | | Pressure | temperature |
| | | Tensiometer) | |
| Any Liquid | Viscosity (cP) | Viscometer (e.g., | Viscosity of a liquid may be |
| | | Brookfield | measured at room temperature |
| | | Viscometer) | |

While the description below may describe certain examples in the context of Li metal and Li-ion batteries (for brevity and convenience, and because of the current popularity of Li technology), it will be appreciated that various aspects may be applicable to other rechargeable and primary batteries (such as Na and Na-ion, Mg and Mg-ion, K and K-ion, Ca and Ca-ion, and other metal and metal-ion batteries, dual ion batteries, alkaline or alkaline ion batteries, flow batteries, etc.) as well as electrochemical capacitors and hybrid energy storage devices.

Aspects of the present invention particularly benefit relatively large battery cells, such as cells with the energy more than about 1 Wh (in some designs, from about 1 Wh to about 20 Wh; in other designs, from about 20 Wh to about 100 Wh; in other designs, from about 100 Wh to about 250 Wh; in yet other designs, from about 250 Wh to about 500 Wh; in yet other designs, from about 500 Wh to about 2 kWh or about 2000 Wh). This is because relatively large cells may become particularly sensitive to self-heating induced by large internal resistance, particularly if electrodes with relatively large areal capacity loadings are utilized. Some aspects of this disclosure describe processes to reduce electrode resistance by utilizing suitable conventional solvent-free electrode fabrication techniques.

While the description below may describe certain examples in the context of composites comprising specific (e.g., alloying-type or conversion-type) active anode materials (such as Si, among others) or specific (e.g., intercalation-type or conversion-type) active cathode materials, it will be appreciated that various aspects may be applicable to many other types and chemistries of conversion-type anode and cathode active materials, intercalation-type anode and cathode active materials, pseudocapacitive anode and cathode active materials, and materials that may exhibit mixed electrochemical energy storage mechanisms.

While the description below may also describe certain examples of the material formulations in a Li-free state (for example, as in silicon-comprising nanocomposite anodes or metal fluoride cathodes or sulfur cathodes, etc.), it will be appreciated that various aspects may be applicable to Li-comprising electrodes and active materials (for example, partially or fully lithiated Si-comprising anodes or partially or fully lithiated Si-comprising anode particles, partially or fully lithiated metal fluoride comprising cathodes (such as a mixture of LiF and metals such as Cu, Fe, Ni, Bi, Zr, Ti, Mg, Nb, and various other metals and metal alloys and mixtures of such and other metals, etc.) or partially or fully lithiated metal halide comprising cathode particles, partially or fully lithiated chalcogenides (such as Li₂S, Li₂S/metal mixtures, Li₂Se, Li₂Sc/metal mixtures, Li₂S—Li₂Se mixtures, various other compositions comprising lithiated chalcogenides etc.), partially or fully lithiated metal oxides (such as Li₂O, Li₂O/metal mixtures, etc.), partially or fully lithiated intercalation-type cathode materials, partially or fully lithiated carbons, among others). In some designs, various material properties (e.g., at particle level, at inter-particle level, at electrode level, etc.) may change based on whether active material particle(s) are in a Li-free state, a partially lithiated state, or a fully lithiated state. Such Li-dependent material properties may include particle pore volume, electrode pore volume, and so on. Below, unless stated or implied otherwise, reference to such Li-dependent anode material properties (e.g., at particle level, at inter-particle level, at electrode level, etc.) may be assumed to be provided as if the active material particles are in the Li-free state. Further, some examples below are characterized at the electrode level (e.g., as opposed to particle level or interparticle level or cell level, etc.). Below, unless stated or implied otherwise, reference to such electrode level properties (e.g., electrode porosity or areal capacity loading or gravimetric/volumetric capacity, etc.) may be assumed to refer to the electrode components (e.g., active material particles, binder, conductive additives, etc.), excluding the current collector.

While the description below may describe certain examples in the context of some specific alloying-type, conversion-type and intercalation-type chemistries for anode active materials and conversion-type and intercalation-type chemistries for cathode active materials for Li-ion batteries (such as silicon-comprising anodes or metal fluoride-comprising or lithium sulfide-comprising cathodes), it will be appreciated that various aspects may be applicable to other chemistries for Li-ion batteries (other conversion-type and alloying-type electrodes as well as various intercalation-type anodes and cathodes) as well as to other battery chemistries. In the case of metal-ion batteries (such as Li-ion batteries), examples of other suitable conversion-type electrodes include, but are not limited to, metal fluorides, metal oxyfluorides, metal chlorides, metal iodides, metal bromides, sulfur, metal sulfides (including, but not limited to lithium sulfide), selenium, metal selenide (including, but not limited to lithium sulfide), metal oxides, metal nitrides, metal phosphides, metal hydrides, their various mixtures, composites (including nanocomposites) and alloys and others.

During battery (such as a Li-ion battery) operation, conversion materials change (convert) from one crystal structure to another (hence the name “conversion”-type), where a material structure and composition may chemically and structurally change to one or multiple structures. This process is also accompanied by breaking chemical bonds and forming new ones. During battery (e.g., Li-ion battery) operation, Li ions are inserted into alloying type materials forming lithium alloys (hence the name “alloying”-type). Sometimes, “alloying”-type electrode materials are considered to be a subclass of “conversion”-type electrode materials.

While the description below may describe certain examples in the context of Si—C composite (e.g., nanocomposite) anode active materials (e.g., nanocomposite particles which comprise silicon (Si) and carbon (C) and may comprise other elements, such as nitrogen (N), phosphorus (P), boron (B), oxygen (O), hydrogen (H), sulfur (S), fluorine (F), to name a few and where a total mass of the Si and the C atoms may contribute from about 75 wt. % to about 100 wt. % of the total mass of the composite particles), it will be appreciated that various aspects may be applicable to other types of high-capacity silicon-comprising anode active materials (including but not limited to, for example, various silicon-comprising or silicon oxide-comprising or silicon nitride-comprising or silicon oxy-nitride-comprising or silicon phosphide-comprising particles or particles comprising a mixture or alloy or other combinations of such active materials, various other types of Si-comprising composites including, but not limited to core-shell or hierarchical or nanocomposite particles, etc.).

An aspect is directed to a battery anode and/or a battery anode precursor composition comprising a population of Si-comprising particles (e.g., nanocomposite particles, among others), in which some or all of the Si-comprising particles comprise silicon (Si) and carbon (C) elements and may comprise other elements, such as nitrogen (N), phosphorus (P), boron (B), oxygen (O), hydrogen (H), sulfur (S), fluorine (F), to name a few. In some embodiments, the total mass of the Si and the C (on average) in the Si-comprising particles may contribute from about 75 wt. % to about 100 wt. % of the total mass of the Si-comprising particles. Such composite particles are sometimes referred to herein as Si—C composites (or nanocomposites, if Si and/or C are nanostructures, for example). In some embodiments, the total mass of O may contribute (on average) from about 0 wt. % to about 10 wt. % of the total mass of the Si-comprising particles (in some designs, from about 0 wt. % to about 1 wt. %; in other designs, from about 1 wt. % to about 2.5 wt. %; in other designs, from about 2.5 wt. % to about 5 wt. %; in other designs, from about 5 wt. % to about 10 wt. %). In some embodiments, the total mass of O may contribute (on average) to less than about 5 wt. % of the total mass of the Si-comprising particles. In some embodiments, the total mass of N may contribute (on average) from about 0 wt. % to about 10 wt. % of the total mass of the Si-comprising particles (in some designs, from about 0 wt. % to about 0.1 wt. %; in other designs, from about 0.1 wt. % to about 2 wt. %; in other designs, from about 2 wt. % to about 5 wt. %; in yet other designs, from about 5 wt. % to about 10 wt. %). In some embodiments, the total mass of P may contribute (on average) from about 0 wt. % to about 10 wt. % of the total mass of the Si-comprising particles (in some designs, from about 0 wt. % to about 0.1 wt. %; in other designs, from about 0.1 wt. % to about 1 wt. %; in other designs, from about 1 wt. % to about 5 wt. %; in yet other designs, from about 5 wt. % to about 10 wt. %). In some embodiments, the total mass of B may contribute (on average) from about 0 wt. % to about 5 wt. % of the total mass of the Si-comprising particles (in some designs, from about 0 wt. % to about 0.1 wt. %; in other designs, from about 0.1 wt. % to about 2.5 wt. %; in yet other designs, from about 2.5 wt. % to about 5 wt. %). In some embodiments, the total mass of H may contribute (on average) from about 0 wt. % to about 2 wt. % of the total mass of the Si-comprising particles (in some designs, from about 0 wt. % to about 0.5 wt. %; in other designs, from about 0.5 wt. % to about 1 wt. %; in yet other designs, from about 1 wt. % to about 2 wt. %). In some embodiments, the total mass of S may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %). In some embodiments, the total mass of F may contribute (on average) from about 0 wt. % to about 2.5 wt. % of the total mass of the Si-comprising particles (in some designs, from about 0 wt. % to about 0.1 wt. %; in other designs, from about 0.1 wt. % to about 0.5 wt. %; in yet other designs, from about 0.5 wt. % to about 2.5 wt. %).

In some embodiments, a total atomic fraction of the Si and the C may contribute from about 75 at. % to about 100 at. % of the overall composite particles. Such composite particles are sometimes referred to herein as Si—C composites. In some embodiments, such composite particles comprise nano-sized or nanostructured elements (e.g., nano-sized or nanostructured Si, nano-sized or nanostructured C, or both), which may be referred to as nanocomposite particles. In some implementations, the Si or Si-comprising material present in such nanocomposites may be in the form of nanoparticles. In some implementations, the mass-average size of Si or Si-comprising material nanoparticles may range from about 1 nm to about 200 nm (in some designs, from about 1 nm to about 10 nm; in other designs, from about 10 nm to about 30 nm; in yet other designs, from about 30 nm to about 100 nm; in yet other designs, from about 100 nm to about 200 nm), as measured using image analysis of electron microscopy (e.g., transmission electron microscopy (TEM), scanning transmission electron microscopy (STEM), scanning electron microscopy (SEM)), X-ray microscopy, X-ray diffraction, neutron scattering and other suitable techniques. As used here, a “nano”-material (e.g., nanostructure or nanoparticle or nanocomposite, etc.) may refer to any material that exhibits at least one dimension that is less than about 200 nm.

An aspect is directed to a battery anode and/or a battery anode precursor composition comprising a population of Si-comprising particles (e.g., nanocomposite particles, among others), in which each of the particles comprises Si and C, and the Si-comprising particles have certain characteristics. In some embodiments, a mass fraction of the silicon in the Si-comprising particles is in a range of about 3 wt. % to about 80 wt. % (in some designs, from about 3 wt. % to about 20 wt. %; in other designs, from about 20 wt. % to about 35 wt. %; in yet other designs, from about 35 wt. % to about 50 wt. %; in yet other designs, from about 50 wt. % to about 80 wt. %; in yet other designs, from about 50 wt. % to about 60 wt. %; in yet other designs, from about 60 to about 70 wt. %; in yet other designs, from about 70 wt. % to about 80 wt. %; in yet other designs, from about 20 wt. % to about 80 wt. %; in yet other designs, from about 35 wt. % to about 60 wt. %). In some embodiments, a Brunauer-Emmett-Teller (BET) specific surface area (SSA) of the Si-comprising particles (e.g., nanocomposite particles, among others) is in a range of about 0.5 m²/g to about 170 m²/g (in some designs, from about 0.5 to about 3 m²/g; in other designs, from about 3 m²/g to about 12 m²/g; in yet other designs, from about 12 m²/g to about 18 m²/g; in yet other designs, from about 18 m²/g to about 30 m²/g; in other designs, from about 30 m²/g to about 50 m²/g; in yet other designs, from about 50 m²/g to about 170 m²/g). In some embodiments, about 90% or more of the Si-comprising particles (e.g., nanocomposite particles, among others) in the population are characterized by aspect ratios of about 2.3 or less, or aspect ratios of about 2.1 or less. In some embodiments, about 50% or more of the composite particles in the population are characterized by aspect ratios of about 1.25 or more, or aspect ratios of about 1.35 or more.

An aspect is directed to a battery electrode and/or a battery electrode precursor composition comprising a population of Si-comprising particles (e.g., nanocomposite particles, among others). The particle size distribution (PSD) that characterizes a particle population may be determined by laser particle size distribution analysis (LPSA) on well-dispersed particle suspensions in one example or by image analysis of electron microscopy images, or by other suitable techniques. While there are diverse processes of measuring PSDs, laser particle size distribution analysis (LPSA) is quite efficient for some applications. Using LPSA, particle size parameters of a population's PSD can be measured, such as: a tenth-percentile volume-weighted particle size parameter (e.g., abbreviated as D₁₀), a fiftieth-percentile volume-weighted particle size parameter (e.g., abbreviated as D₅₀), a ninetieth-percentile volume-weighted particle size parameter (e.g., abbreviated as D₉₀), and a ninety-ninth-percentile volume-weighted particle size parameter (e.g., abbreviated as D₉₉). Additionally, parameters relating to characteristic widths of the PSD may be derived from these particle size parameters, such as D₅₀−D₁₀ (sometimes referred to herein as a left width), D₉₀−D₅₀ (sometimes referred to herein as a right width), and D₉₀−D₁₀ (sometimes referred to herein as a full width). A cumulative volume fraction, defined as a cumulative volume of the composite particles with particle sizes of a threshold particle size or less, divided by a total volume of all of the composite particles, may be estimated by LPSA. In some embodiments, a fiftieth-percentile volume-weighted particle size parameter (D₅₀) of the PSD of Si-comprising particles may advantageously be in a range of about 0.5 to about 25.0 μm, or in a range of about 0.5 to about 4.0 μm, or in a range of about 4.0 to about 6.0 μm, or in a range of about 6.0 to about 8.0 μm or in a range of about 8.0 to about 16.0 μm or in a range of about 16.0 to about 25.0 μm. A cumulative volume fraction, defined as a cumulative volume of the composite particles with particle sizes of a threshold particle size or less, divided by a total volume of all of the composite particles, may be estimated by LPSA. In some embodiments (e.g., when the D₅₀ is in a range from about 0.5 μm to about 4.0 μm), the cumulative volume fraction, with the threshold particle size at about 5 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 4.0 μm to about 6.0 μm), the cumulative volume fraction, with the threshold particle size at about 7 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 6.0 μm to about 8.0 μm), the cumulative volume fraction, with the threshold particle size at about 10 μm, may advantageously be about 99 vol. % or less, or about 95 vol. % or less, or about 90 vol. % or less, or about 85 vol. % or less, or about 80 vol. % or less. In other embodiments (e.g., when the D₅₀ is in a range from about 8.0 μm to about 16.0 μm), the cumulative volume fraction, with the threshold particle size at about 20 μm, may advantageously be about 99 vol. % or less, or about 95 vol. % or less, or about 90 vol. % or less, or about 85 vol. % or less, or about 80 vol. % or less. In yet other embodiments (e.g., when the D₅₀ is in a range from about 16.0 μm to about 25.0 μm), the cumulative volume fraction, with the threshold particle size at about 30 μm, may advantageously be about 99 vol. % or less, or about 95 vol. % or less, or about 90 vol. % or less, or about 85 vol. % or less, or about 80 vol. % or less.

Note that in some designs the presence of excessively large particles comprising Si (e.g., in the form of nanocomposite particles, among others) may reduce cell performance characteristics (e.g., reduce cell stability, increase its impedance, reduce rate performance, reduce packing density, reduce electrode smoothness or uniformity, reduce electrode mechanical properties, reduce volumetric capacity, increase (e.g., localized) volume expansion, etc.). In some embodiments (e.g., when the D₅₀ is in a range from about 0.5 μm to about 4.0 μm), the cumulative volume fraction, with the threshold particle size at about 10 μm, may advantageously be about 80 vol. % or more, or about 85 vol. % or more, or (in some designs) even about 90 vol. % or more. In some embodiments (e.g., when the D₅₀ is in a range from about 0.5 μm to about 4.0 μm), the cumulative volume fraction, with the threshold particle size at about 12 μm, may advantageously be about 90 vol. % or more, or about 95 vol. % or more, or (in some designs) even about 98 vol. % or more. In other embodiments (e.g., when the D₅₀ is in a range from about 4.0 μm to about 6.0 μm), the cumulative volume fraction, with the threshold particle size at about 15 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 25 μm, may advantageously be about 90 vol. % or more, or about 95 vol. % or more, or (in some designs) even about 98 vol. % or more. In other embodiments (e.g., when the D₅₀ is in a range from about 6.0 μm to about 8.0 μm), the cumulative volume fraction, with the threshold particle size at about 18 μm, may advantageously be about 80 vol. % or more, or about 85 vol. % or more, or (in some designs) even about 90 vol. % or more. In other embodiments (e.g., when the D₅₀ is in a range from about 4.0 μm to about 6.0 μm), the cumulative volume fraction, with the threshold particle size at about 35 μm, may advantageously be about 90 vol. % or more, or about 95 vol. % or more, or (in some designs) even about 98 vol. % or more. In other embodiments (e.g., when the D₅₀ is in a range from about 8.0 μm to about 16.0 μm), the cumulative volume fraction, with the threshold particle size at about 40 μm, may advantageously be about 80 vol. % or more, or about 85 vol. % or more, or (in some designs) even about 90 vol. % or more. In other embodiments (e.g., when the D₅₀ is in a range from about 8.0 μm to about 16.0 μm), the cumulative volume fraction, with the threshold particle size at about 50 μm, may advantageously be about 90 vol. % or more, or about 95 vol. % or more, or (in some designs) even about 98 vol. % or more.

In one or more embodiments of the present disclosure, Si-comprising active material (composite) particles may exhibit true density (e.g., as measured by using an argon gas pycnometer) in the range from about 1.1 g/cc to about 2.8 g/cc (in some designs, from about 1.1 g/cc to about 1.5 g/cc; in other designs, from about 1.5 g/cc to about 1.8 g/cc; in other designs, from about 1.8 g/cc to about 2.1 g/cc; in other designs, from about 2.1 g/cc to about 2.4 g/cc; in yet other designs, from about 2.4 g/cc to about 2.8 g/cc).

In one or more embodiments of the present disclosure, Si-comprising active material (composite) particles may comprise internal pores. In some designs, the open (e.g., to nitrogen gas at 77K) pore volume (e.g., as measured by nitrogen sorption/desorption isotherm measurement technique and including the pores in the range from about 0.4 nm to about 100 nm) may range from about 0.00 cc/g to about 0.50 cc/g (assuming theoretical density of the individual material components present in Si-comprising particles)—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g. In some designs, the closed (e.g., to nitrogen gas at 77K) pore volume (e.g., measured by analyzing true density values measured by using an argon gas pycnometer and comparing to the theoretical density of the individual material components present in Si-comprising (composite) particles) may range from about 0.00 cc/g to about 1.00 cc/g—in some designs, from about 0.00 cc/g to about 0.10 cc/g; in other designs, from about 0.10 cc/g to about 0.20 cc/g; in other designs, from about 0.20 cc/g to about 0.30 cc/g; in other designs, from about 0.30 cc/g to about 0.40 cc/g; in other designs, from about 0.40 cc/g to about 0.50 cc/g; in other designs, from about 0.50 cc/g to about 0.60 cc/g; in other designs, from about 0.60 cc/g to about 0.70 cc/g; in other designs, from about 0.70 cc/g to about 0.80 cc/g; in other designs, from about 0.80 cc/g to about 0.90 cc/g; in other designs, from about 0.90 cc/g to about 1.00 cc/g). In some designs, the volume-average size of the open (e.g., to nitrogen gas at 77K) pores may range from about 0.5 nm to about 100 nm—in some designs, from about 0.5 nm to about 5 nm; in other designs, from about 5 nm to about 20 nm; in other designs, from about 20 nm to about 50 nm; in yet other designs, from about 50 nm to about 100 nm. In some designs, the volume-average size of the closed (e.g., to nitrogen gas at 77K) pores (e.g., measured by image analysis of cross-sectional electron microscopy images such as SEM or TEM or measured by the neutron scattering or other suitable technique) may range from about 0.5 nm to about 200 nm—in some designs, from about 0.5 nm to about 5 nm; in other designs, from about 5 nm to about 20 nm; in other designs, from about 20 nm to about 50 nm; in other designs, from about 50 nm to about 100 nm; in yet other designs, from about 100 nm to about 200 nm.

In one or more embodiments of the present disclosure, Si-comprising active material (composite) particles may exhibit moderate (e.g., about 7-120 vol. %) or high (e.g., about 120-200 vol. %) volume changes during initial lithiation (e.g., down to around 0.01 V vs. Li/Li+). In some designs, Si-comprising active material particles may exhibit volume changes in the range from about 8 vol. % to about 180 vol. % during one or more charge-discharge cycles of the battery cell. In one or more embodiments of the present disclosure, Si-comprising active material particles may exhibit moderately small (e.g., about 3-7 vol. %) or moderate (e.g., about 7-120 vol. %) volume changes during electrochemical battery cycling from about 0-5% state of charge (SOC) to about 90-100% SOC and back during battery operation.

In one or more embodiments of the present disclosure, a preferred anode for a battery cell may comprise a mixture of Si-comprising active material particles (e.g., nanocomposite Si—C particles, nanocomposite Si particles, among others) and graphite active material particles (or, more broadly, carbon active material particles) as the anode active material, a so-called blended anode. In addition to the anode active material particles, an anode may comprise inactive material, such as binder(s) (e.g., polymer binder) and other functional additives (e.g., surfactants, electrically conductive additives, etc.). In some implementations, the anode active material may be in a range of about 85 wt. % to about 98 wt. % of the total weight of the anode (not counting the weight of the current collector)—in some designs, from about 85 wt. % to about 89 wt. %; in other designs, from about 89 wt. % to about 91 wt. %; in other designs, from about 91 wt. % to about 93 wt. %; in other designs, from about 93 wt. % to about 95 wt. %; in yet other designs, from about 95 wt. % to about 98 wt. %.

In some implementations, blended anodes may comprise Si-comprising particles (e.g., Si—C nanocomposite particles, among others) ranging from about 7 wt. % to about 98 wt. % of all the anode active material particles and the graphite (e.g., particles) making up the remainder of the mass (the weight) of the anode active material particles (from about 2 wt. % to about 93 wt. %). In some designs, the Si-comprising particles (e.g., Si—C nanocomposite particles, etc.) comprise from about 7 wt. % to about 15 wt. % of the blended anode active material particles; in other designs—from about 15 wt. % to about 25 wt. % of the blended anode active material particles; in other designs—from about 25 wt. % to about 40 wt. % of the blended anode active material particles; in other designs—from about 40 wt. % to about 60 wt. % of the blended anode active material particles; in other designs—from about 60 wt. % to about 80 wt. % of the blended anode active material particles; in yet other designs—from about 80 wt. % to about 98 wt. % of the blended anode active material particles.

While the descriptions below may also describe certain examples of the blended anode formulations expressed as mass (wt. %) of Si-comprising particles (e.g., Si—C nanocomposite particles, among others) among the anode active materials or as mass (wt. %) of Si-comprising particles (e.g., Si—C nanocomposite particles, etc.) in the total anode (not counting the weight of the current collector), it will be appreciated that various aspects of this disclosure may be applicable to blended anode formulations expressed as wt. % of Si in the anode (counting the weight of all the active materials, binder, conductive and other additives, but not counting the weight of the current collector). In some implementations, a blended anode formulation of about 7 wt. % of Si-comprising particles (e.g., Si—C nanocomposite particles, among others) (relative to the total weight of all the active materials in the anode, binder(s), conductive and other additive(s), but not counting the weight of the current collector) may correspond, for example, to about 3 wt. % of Si in the blended anode. In some implementations, a blended anode formulation of about 19 wt. % of Si-comprising particles (e.g., Si—C nanocomposite particles, among others) may correspond, for example, to about 8 wt. % of Si in the blended anode. In some implementations, a blended anode formulation of about 35 wt. % of Si-comprising particles (e.g., Si—C nanocomposite particles, among others) may correspond, for example, about 15 wt. % of Si in the blended anode. In some implementations, a blended anode formulation of about 50 wt. % of Si-comprising particles (e.g., Si—C nanocomposite particles, among others) may correspond, for example, to about 21 wt. % of Si in the blended anode. In some implementations, a blended anode formulation of about 70 wt. % of Si-comprising particles (e.g., Si—C nanocomposite particles, among others) may correspond, for example, to about 30 wt. % of Si in the blended anode. In some implementations, a blended anode formulation of about 90 wt. % of Si-comprising particles (e.g., Si—C nanocomposite particles, among others) may correspond, for example, to about 38 wt. % of Si in the blended anode. The wt. % of Si in the anode depends on the wt. % of Si in the Si-comprising particles, the wt. % of the binder and conductive additives and the wt. % of the graphite in the blended anode. Smaller fractions of inactive materials (e.g., binder and conductive or other additives), higher fraction of Si in the Si-comprising anode material particles (e.g., Si—C composite particles) and smaller fraction of graphite in the blended anode result in higher wt. % Si in the anode. For example, in some implementations, a blended anode formulation of about 80 wt. % of Si-comprising particles (e.g., Si—C nanocomposite particles, among others) and about 20 wt. % of the total of binder(s), conductive or other additive(s) (if present) and graphite may correspond, for example, to about 30 wt. % of Si in the blended anode. In other implementations, a blended anode formulation of also about 80 wt. % of Si-comprising particles (e.g., Si—C nanocomposite particles, among others) and about 20 wt. % of the total of binder(s), conductive or other additive(s) (if present) and graphite may correspond, for example, to about 40 wt. % of Si in the blended anode. In other implementations, a blended anode formulation of also about 80 wt. % of Si-comprising particles (e.g., Si—C nanocomposite particles, among others) and about 20 wt. % of the total of binder(s), conductive or other additive(s) (if present) and graphite may correspond, for example, to about 50 wt. % of Si in the blended anode. In other implementations, a blended anode formulation of also about 80 wt. % of Si-comprising particles (e.g., Si—C nanocomposite particles, among others) and about 20 wt. % of the total of binder(s), conductive or other additive(s) (if present) and graphite may correspond, for example, to about 60 wt. % of Si in the blended anode. In respective implementations, blended anodes may be obtained in which the mass (weight) of the silicon is in a range of about 3 wt. % to about 60 wt. % of a total mass of the anode (not counting the weight of the current collector).

While the descriptions below may also describe certain examples of the blended anode formulations expressed as mass (wt. %) of Si-comprising particles (e.g., Si—C nanocomposite particles, etc.) in the active material blends, it will be appreciated that various aspects of this disclosure may be applicable to blended anode formulations attributing a fraction (e.g., %) of the total capacity of the blended anode to the capacity of the Si-comprising particles. In some implementations, for example, about 25% of the total capacity of the blended anode may be obtained from the Si-comprising particles (e.g., Si—C nanocomposite particles, etc.) in a blended anode formulation of about 5-8 wt. % of Si-comprising particles (e.g., Si—C nanocomposite particles, etc.) relative to the total weight of active material particles (both Si-comprising and graphite particles). In some other implementations, as another example, about 50% of the total capacity of the blended anode may be obtained from the Si-comprising particles (e.g., Si—C nanocomposite particles, etc.) in a blended anode formulation of about 15-21 wt. % of Si-comprising particles (e.g., Si—C nanocomposite particles, etc.). In some other implementations, about 70% of the total capacity of the blended anode may be obtained from the Si-comprising particles (e.g., Si—C nanocomposite particles, etc.) in a blended anode formulation of about 30-40 wt. % of Si-comprising particles (e.g., Si—C nanocomposite particles, etc.). In some other implementations, about 80% of the total capacity of the blended anode may be obtained from the Si-comprising particles (e.g., Si—C nanocomposite particles, etc.) in a blended anode formulation of about 45-55 wt. % of Si-comprising particles (e.g., Si—C nanocomposite particles, etc.). In some other implementations, about 92% of the total capacity of the blended anode may be obtained from the Si-comprising particles (e.g., Si—C nanocomposite particles, etc.) in a blended anode formulation of about 65-75 wt. % of Si-comprising particles (e.g., Si—C nanocomposite particles, etc.). In some other implementations, about 95% of the total capacity of the blended anode may be obtained from the Si-comprising particles (e.g., Si—C nanocomposite particles, etc.) in a blended anode formulation of about 75-85 wt. % of Si-comprising particles (e.g., Si—C nanocomposite particles, etc.). In some other implementations, about 98% of the total capacity of the blended anode may be obtained from the Si-comprising particles (e.g., Si—C nanocomposite particles, etc.) in a blended anode formulation of about 85-95 wt. % of Si-comprising particles (e.g., Si—C nanocomposite particles, etc.). Note that the exact % capacity provided by the Si-comprising particles in the blended anode having a specific wt. % of the Si-comprising particles depends on the specific capacity of the plurality of the Si-comprising active material particles and the specific capacity of the plurality of graphite (or, broadly, carbon) active material particles.

In some embodiments, the battery electrode (e.g., anode) and/or battery electrode (e.g., anode) precursor composition may advantageously comprise one or more carbon-comprising functional additives (e.g., additives that enhance electrical conductivity or rate performance of mechanical properties of the electrode). In some embodiments, the carbon-comprising functional additive is selected from: carbon nanotubes (e.g., single walled carbon nanotubes (SWCNTs), multi-walled carbon nanotubes (MWCNTs), carbon nanofibers, carbon black, graphite, exfoliated graphite, graphene oxide and graphene. In some embodiments, the battery electrode (e.g., anode) precursor composition comprises a polymerizable binder precursor (e.g., polymerizable monomers, oligomers, and/or polymers). In addition, the battery electrode (e.g., anode) precursor composition may comprise one or more binder components. In some embodiments, the battery electrode (e.g., anode) may comprise a binder formed by polymerization of the polymerizable binder precursor present in the battery electrode (e.g., anode) precursor composition. In addition, the battery electrode (e.g., anode) may comprise one or more binder components (in some designs, two or more binder components).

An aspect is directed to a battery anode. In some embodiments, the battery anode is formed from any of the foregoing battery anode electrode precursor compositions, disposed on and/or in a current collector (e.g., Cu-based or Cu-containing current collector, such as a dense or porous foil or a mesh or a foam or a nanowire-comprising or nanoflake-comprising current collector, etc.). In some embodiments, a coating density of the battery electrode is in a range of about 0.8 to about 1.7 g/cm³ (in some designs, from about 0.8 to about 0.9 g/cm³; in other designs, from about 0.9 to about 1.0 g/cm³; in other designs, from about 1.0 to about 1.2 g/cm³; in other designs, from about 1.2 to about 1.4 g/cm³, in yet other designs, from about 1.4 to about 1.7 g/cm³). Higher fraction of suitable graphite material in a blended anode may benefit from higher anode density for better performance (e.g., better stability, better rate performance, higher volumetric capacity, lower swell during cycling, etc.), although excessive density may also be detrimental for the same or other characteristics. As such, detailed optimization would need to be conducted for a particular battery design, electrode thickness, areal capacity loading, battery cycling environment and regime, among other factors.

An aspect is also directed to a blended battery anode, wherein both the Si-comprising active anode particles (e.g., nanocomposite Si—C particles, among others) and graphite (or, broadly, carbon-based) active anode material may be present. The anode may preferably comprise a binder amount optimized for the properties of both the Si-comprising active material particles and the graphite particles. For example, the anode may be characterized by an areal binder loading, defined as a mass of the binder in the battery anode (e.g., measured in mg) normalized by the surface area of the active material particles (e.g., Si-comprising (e.g., nanocomposite, etc.) active anode material particles and (if present) graphite active material particles in the same battery anode (e.g., measured in m² and defined by the mass of active material particles (in g) multiplied Brunauer-Emmett-Teller (BET) specific surface area (SSA, in m²/g)). Since a BET SSA of both the Si-comprising active material particle population and the graphite active material particle population may vary from slurry to slurry, in some designs, the binder loading may preferably be adjusted based on the desired areal binder loading. Higher BET SSA of the active anode materials (measured in m²/g) typically require a higher mass fraction of the binder in the anode electrode. For example, the anode electrode comprising active material particle population (e.g., Si-comprising (e.g., nanocomposite, etc.) active anode material particle population or a blend of Si-comprising active material(s) and a graphite active material(s)) with BET SSA of about 10 m²/g would typically require from about 20 mg to about 150 mg of the binder per 1 g of active material (e.g., composite) particles (approximately 2-13 wt. % relative to the total weight of the binder+active material (e.g., composite) particle composition, not counting the weight of conductive or other additives or the weight of the current collector), while another anode electrode comprising another active material particle population (e.g., Si-comprising (e.g., nanocomposite, etc.) active anode material particle population or a blend of Si-comprising active material(s) and a graphite active material(s)) with BET SSA of only 1 m²/g would typically require from about 2 mg to about 40 mg of the binder per 1 g of active material (e.g., composite) particles (approximately 0.2-4 wt. % relative to the total weight of the binder+active material (e.g., composite) particle composition, not counting the weight of conductive or other additives or the weight of the current collector). However, in some designs, an areal binder loading of the battery anode in both cases is in the range from about 2.0 mg/m² to about 40.0 mg/m² (e.g. in some designs, from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²). In some designs, a higher fraction of Si-comprising (e.g., nanocomposite, etc.) active anode material particle population in the anode (relative to the total weight of all active material particles in the anode, inclusive of Si-comprising (composite) active material particles and graphite particles) may preferably be used in conjunction with a higher areal binder loading. In some designs, a larger average size of Si-comprising (e.g., nanocomposite, etc.) active anode material particle population in the anode may preferably be used in conjunction with a slightly higher areal binder loading. In some designs, a larger BET SSA of Si-comprising (e.g., nanocomposite, etc.) active anode material particle population in the anode may preferably be used in conjunction with a slightly smaller areal binder loading. In some designs, the areal binder loading may also depend on the binder composition and properties (e.g., adhesion, chemical composition, hardness, clastic modulus when exposed to electrolyte, maximum elongation at break, among others). Thus, in some designs, the optimal areal binder loading content within a relatively a range of about 2.0 mg/m² to about 40.0 mg/m² depends on the anode formulation. So, the optimal areal binder loading content in some designs may range from about 2.0 mg/m² to about 5.0 mg/m²; in other designs, from about 5.0 mg/m² to about 9.0 mg/m²; in yet other designs, from about 9.0 mg/m² to about 15.0 mg/m²; in yet other designs, from about 15.0 mg/m² to about 40.0 mg/m²).

While the description below may describe certain examples of suitable intercalation-type graphites to be used in combination with Si-comprising (e.g., Si—C nanocomposites, etc.) active anode material particles in a blend, it will be appreciated that various aspects of this disclosure may be applicable to various soft-type synthetic graphite (or soft carbon, broadly), various hard-type synthetic graphite (or hard carbon, broadly), and various natural graphite (which may, for example, be pitch carbon coated, among others); including but not limited to those which exhibit discharge capacity from about 320 to about 372 mAh/g (e.g., in some designs, from about 320 to about 350 mAh/g; or in other designs, from about 350 to about 362 mAh/g; or in other designs, from about 362 to about 372 mAh/g); including but not limited to those which exhibit low (e.g., swelling of up to about 20 vol. %), moderate (e.g., swelling in a range of about 20 to 40 vol. %) and high swelling (e.g., swelling of greater than about 40 vol. %, such as swelling in a range of about 40 to about 50 vol. %); including but not limited to those which exhibit good (e.g., Cx in a range of about 10 to 40 MPa) and poor compression (e.g., Cx in a range of 1 to 10 MPa) (Cx (MPa) is the pressure required to deform the particle by 10% (linear dimensions)), including but not limited to those which exhibit BET SSA of about 0.5 to about 40 m²/g (e.g., in some designs, from about 0.5 to about 2 m²/g; or in other designs, from about 2 to about 4 m²/g; or in other designs, from about 4 to about 6 m²/g; or in other designs, from about 6 to about 8 m²/g; or in other designs, from about 8 to about 10 m²/g; or in other designs, from about 10 to about 14 m²/g; or in other designs, from about 14 to about 20 m²/g; or in other designs, from about 20 to about 40 m²/g); including but not limited to those which exhibit lithiation efficiency of about 85-90% and more; including but not limited to those which exhibit true densities ranging from about 1.5 g/cm³ to about 2.3 g/cm³ (e.g., in some designs, from about 1.5 to about 1.8 g/cm³, in other designs, from about 1.8 to about 2.3 g/cm³); including but not limited to those which exhibit poor (e.g., N80 is about 800 cycles or less), moderate (e.g., N80 is in a range of about 800 to about 1400 cycles), or good (e.g., N80 is in a range of about 1400 to about 2000 cycles or more than 2000 cycles in some examples) (N80 is the number of cycles to reach 80% of cycling-start gravimetric charge capacity) cycle life when used in Li-ion battery anodes on their own (e.g., without Si-comprising or other active material particles); including but not limited to those which are coated and comprise coatings with coating thickness to appreciably improve compression and springing during cycling.

An aspect is directed to a battery and an anode comprising Si-comprising particles that also comprise C (e.g., Si—C nanocomposite particles, C-coated particles, etc.), wherein the average domain size of C ranges from around 10 Å (1 nm) to around 60 Å (6 nm), as determined by Synchrotron X-ray diffraction (XRD) atomic pair distribution function (PDF) analysis.

An aspect is directed to a battery and an anode comprising Si-comprising particles that also comprise C (e.g., Si—C nanocomposite particles, C-coated particles, etc.), wherein the ratio of intensities of the carbon D band and carbon G band (I_{D}/I_{G}) in the Raman spectra of the majority of Si- and C-comprising particles (measured, for example, using the laser wavelength of about 532 nm; and analyzed, for example, in the spectral range from about 1000 to about 2000 wavenumber cm⁻¹ by fitting two Gaussian peaks after a linear background subtraction in this range) to range from I_{D}/I_{G} of about 0.7 to I_{D}/I_{G} of about 2.7 (in some designs, from about 0.7 to about 0.9; in other designs, from about 0.9 to about 1.2; in other designs, from about 1.2 to about 1.5; in other designs, from about 1.5 to about 1.8; in other designs, from about 1.8 to about 2.1; in other designs, from about 2.1 to about 2.4; in yet other designs, from about 2.4 to about 2.7).

An aspect is also directed to a Li-ion battery comprising: (i) a suitable battery anode, wherein the suitable anode may comprise one or more of the following, in some designs: (ia) Si-comprising anode comprising Si-comprising anode particles (e.g., nanocomposite Si—C particles, silicon oxide particles, silicon nitride particles, among others), which, in some design may also be a blended battery anode (wherein both the Si-comprising active anode particles (e.g., nanocomposite Si—C particles or silicon oxide particles or silicon nitride particles, among others) and suitable graphite (or, broadly, carbon-based) active anode particles are present in the anode), (ib) intercalation-type carbon (C)-comprising anode comprising natural graphite, synthetic graphite, hard carbon or soft carbon or their various combinations or (ic) metal oxide-comprising anode (e.g., Li, Ti, Nb, Mo, V and/or W-comprising metal oxides, such as, for example, lithium titanium oxide, niobium titanium oxide, niobium molybdenum oxide, niobium molybdenum titanium oxide, niobium tungsten oxide, niobium tungsten molybdenum oxide, niobium tungsten molybdenum titanium oxide, vanadium oxide, their various combinations and mixtures, etc.) or (id) their various combinations and (ii) a suitable battery cathode, wherein the suitable cathode may comprise one or more of the following, in some designs: (iia) intercalation-type cathode or (iib) conversion-type cathode (which may include a displacement-type cathode, a chemical transformation type cathode or a true conversion-type cathode) or (iic) a mixed intercalation/conversion type cathode (either a physical mixture of (iia) and (iib) or a cathode that exhibits both intercalation-type or conversion-type Li-ion storage).

In some designs, a suitable cathode may advantageously comprise one, two or more of the following additives (e.g., in the form of particles, nanoparticles, nanofibers, flakes or nanoflakes): natural graphite, synthetic graphite, graphene, exfoliated graphite, hard carbon, soft carbon, carbon black, carbon fibers, carbon nanofibers, carbon nanotubes in the total amount from around 0.1 wt. % to about 15 wt. % relative to the total weight of the cathode layer but not counting the weight of the cathode current collector (in some designs, from about 0.1 wt. % to about 0.5 wt. %; in other designs, from about 0.5 wt. % to about 2 wt. %; in other designs, from about 2 wt. % to about 5 wt. %; in yet other designs, from about 5 wt. % to about 15 wt. %).

Illustrative examples of suitable intercalation-type cathodes to be used in preferable cells may include, but are not limited to: lithium nickel cobalt aluminum oxides (NCA), lithium nickel cobalt manganese aluminum oxides (NCMA), lithium nickel oxides (LNO), lithium manganese oxides (LMO), lithium nickel manganese cobalt oxides (NCM), lithium cobalt oxide (LCO), lithium cobalt aluminum oxides (LCAO), lithium iron phosphate (LFP), lithium cobalt phosphate (LCP), lithium manganese phosphate (LMP), lithium manganese iron phosphate (LMFP), lithium nickel phosphate (LiNiPO₄), lithium vanadium fluoro phosphate (LiVFPO₄), lithium iron fluoro sulfate (LiFeSO₄F), various Li excess materials (e.g., lithium excess (rocksalt) transition metal oxides and oxy-fluorides such as those comprising Mn, Mo, Cr, Ti, and/or Nb, such as, for example, Li_{1.211}Mo_{0.467}Cr_{0.3}O₂, Li_{1.3}Mn_{0.4}Nb_{0.3}O₂, Li_{1.2}Mn_{0.4}Ti_{0.4}O₂, Li_{1.2}Ni_{0.333} Ti_{0.333}Mo_{0.133}O₂ and many others), various high capacity Li-ion based materials with partial substitution of oxygen for fluorine or iodine (e.g., disordered or ordered rocksalt compositions comprising Mn, Mo, Cr, Ti and/or Nb, such as, for example, Li₂Mn_{2/3}Nb_{1/3}O₂F, Li₂Mn_{1/2}Ti_{1/2}O₂F, Li_{1.5}Na_{0.5}MnO_{2.85}I_{0.12}, among others) and many other types of Li-comprising disordered, layered, tavorite, olivine, or spinel type active materials or their mixtures comprising at least oxygen or fluorine or sulfur and at least one transition metal and other lithium transition metal (TM) oxides or phosphates or sulfates (or mixed) cathode active materials that rely on the intercalation of lithium (Li) and changes in the TM oxidation state (including, but not limited to those that may be doped or heavily doped; including, but not limited to those that have gradient in composition or core-shell morphology; including, but not limited to those that may be partially fluorinated or comprise some meaningful fraction of fluorine (e.g., about 0.001-10 at. %) in their composition, etc.). It will also be appreciated that various aspects may be applicable to high-voltage lithium transition metal oxide (or phosphate or sulfate or mixed or other) cathodes where TMs and oxygen (O) are covalently bonded and both TM and O take part in electrochemical reduction-oxidation (redox) reactions during charge and discharge (including, but not limited to, those oxides or phosphate or sulfate or mixed cathodes that may comprise at least about 0.25 at. % of Mn, Fe, Ni, Co, Nb, Mg, Cr, Mo, Zr, W, Ta, Ti, Hf, Y, La, Sb, V, Sn, Si, or Ge).

Illustrative examples of suitable conversion-type cathodes to be used in preferable cells may include, but are not limited to: metal fluorides, metal oxy-fluorides, metal chlorides, metal sulfides, metal selenides, their various mixtures, composites and others. Illustrative examples of metal fluorides, in a Li-free state, include, but are not limited to FeF₃, FeF₂, MnF₃, CuF₂, NiF₂, BiF₃, BiF₅, SnF₂, SnF₄, SbF₃, SbF₅, CdF₂, ZnF₂, TiF₃, TiF₄, AgF, AgF₂, NbF₅, NbF₄, MoF₅, MoF₄, MoF₃, ZrF₄, BaF₂, SrF₂, YF₃, LaF₃, PbF₂, PbF₄, CeF₃, CeF₄, SmF₃, CaF₂, their various mixtures, alloys and combinations, among others. In some designs, Fe may contribute to the majority (e.g., about 50-100 at. %; in some designs, about 75-100 at. %) of the transition metals in the metal fluoride cathodes. In some designs, Cu may contribute to the majority (e.g., about 50-100 at. %; in some designs, about 75-100 at. %) of the transition metals in the metal fluoride cathodes. In some designs, it may be advantageous to produce nanocomposites and/or core-shell structures comprising metal fluorides to enhance their performance and stability. In some designs, it may be advantageous to dope metal fluorides with oxygen or utilize metal oxy-fluorides. In a fully lithiated state, pure metal fluorides convert to a composite comprising a mixture of metal and LiF clusters (or nanoparticles). Examples of the overall reversible reactions of the conversion-type metal fluoride cathodes may include 2Li+CuF₂⇔2LiF+Cu for CuF₂-based cathodes or 3Li+FeF₃⇔3LiF+Fe for FeF₃-based cathodes. It will be appreciated that metal fluoride-based cathodes may be prepared in Li-free or partially lithiated or fully lithiated states. In addition to fluorides, other illustrative examples of conversion-type active electrode materials may include, but are not limited to, various metal oxy-fluorides, sulfo-fluorides, chloro-fluorides, oxy-chloro-fluorides, oxy-sulfo-fluorides, fluoro-phosphates, sulfo-phosphates, sulfo-fluoro-phosphates, mixtures of metals (e.g., Fe, Cu, Ni, Co, Bi, Cr, Zn, Ti, other metals, their various mixtures and alloys, partially oxidized metals and metal alloys, etc.) and salts (metal fluorides (including LiF or NaF), metal chlorides (including LiCl or NaF), metal oxy-fluorides, metal oxides, metal sulfo-fluorides, metal fluoro-phosphates, metal sulfides, metal oxy-sulfo-fluorides, their various combinations, etc.), and other salts that comprise halogen or sulfur or oxygen or phosphorous or a combination of these elements, among others. In some designs, F in metal fluorides may be fully or partially replaced with another halogen (e.g., Cl or Br or I, etc.) or their mixtures to form the corresponding metal chlorides or metal fluoride-chlorides and other metal halide compositions. Yet another example of a promising and suitable conversion-type cathode active material is sulfur (S) (in a Li-free state) or lithium sulfide (Li₂S, in a fully lithiated state). In some designs, selenium (Se) may also be used together with S or on its own for the formation of such cathode active materials. In some designs, it may be advantageous to produce nanocomposites and/or core-shell structures comprising S, Li₂S, Se, Li₂Se or their various mixtures and combinations to enhance their performance and stability. In some designs, conversion-type active cathode materials may also advantageously comprise metal oxides or mixed metal oxides. In some designs, such (nano)composites may advantageously comprise metal sulfides or mixed metal sulfides. In some examples, mixed metal oxides or mixed metal sulfides may comprise lithium. In some examples, mixed metal oxides may comprise titanium or vanadium or manganese or iron metal. In some examples, lithium-comprising metal oxides or metal sulfides may exhibit a layered structure. In some examples, metal oxides or mixed metal oxides or metal sulfides or mixed metal sulfides may advantageously be both ionically and electrically conductive (e.g., in the range from around 10⁻⁷ to around 10⁺⁴ S/cm). In some examples, various other intercalation-type active materials may be utilized instead of or in addition to metal oxides or metal sulfides. In some designs, such an intercalation-type active material exhibits charge storage (e.g., Li insertion/extraction capacity) in the potential range close to that of S or Li₂S (e.g., within around 1.5-3.8 V vs. Li/Li⁺). In some designs, the use of so-called Li-air cathodes (e.g., cathodes with active material in the form of Li₂O₂, Li₂O, LiOH in their lithiation state) or similar metal-air cathodes based on Na, K, Ca, Al, Fe, Mn, Zn and other metals (instead of Li) may similarly be beneficial due to their very high capacities. In some designs, such cathode active materials should ideally reversibly react with oxygen or oxygen containing species in the electrochemical cell and may fully disappear upon full de-lithiation (metal removal). These are also considered to belong to conversion-type cathodes.

In some of the preferred examples a surface of cathode active materials (e.g., intercalation-type cathode materials, such as LCO, NCM, NCMA, NCA, LMO, LMNO, LFP, LMP, LMFP, etc. or conversion-type active materials comprising S, Li₂S, metal sulfides, metal fluorides, etc.) may be coated with a layer of ceramic material. In some of the preferred examples a surface of cathode active materials may be coated with a layer of a polymeric material. Illustrative examples of a preferred coating material for such cathodes include, but are not limited to, various oxides and oxy-fluorides, such as titanium oxide (e.g., TiO₂), aluminum oxide (e.g., Al₂O₃), tungsten oxide (e.g., WO), molybdenum oxide (e.g., MoO or MoO₂), chromium oxide (e.g., Cr₂O₃), niobium oxide (e.g., NbO or NbO₂) and zirconium oxide (e.g., ZrO₂) and their various mixtures. In some designs, such ceramic materials may additionally comprise lithium (Li)—e.g., as lithium titanium oxide (or oxyfluoride), lithium aluminum oxide (or oxyfluoride), lithium tungsten oxide (or oxyfluoride), lithium chromium oxide (or oxyfluoride), lithium niobium oxide (or oxyfluoride), lithium zirconium oxide (or oxyfluoride) and their various alloys, mixtures and combinations. In other preferred examples, LCO, NCM, NCMA, NCA, LFP, LMFP, LMP, LMO or LMNO may be doped with Al, Ti, Mg, Nb, Zr, Cr, Hf, Ta, W, Mo or La. In some designs, a preferred cathode current collector material is aluminum or aluminum alloy or an aluminum-comprising composite. In some designs, a preferred battery cell includes a polymer or polymer-comprising separator membrane or a polymer-comprising separator layer. In some of the preferred examples, a polymer separator is made of or comprises polyethylene, polypropylene or a mixture thereof. In some of the preferred examples, a surface of a polymer separator (membrane or layer) is coated with a layer of ceramic material, or a polymer separator (membrane or layer) comprising ceramic material. Examples of a preferred coating material for polymer separators may include, but not limited to titanium oxide (TiO₂), aluminum oxide (Al₂O₃), aluminum hydroxide or oxyhydroxide, zirconium oxide (ZrO₂), magnesium oxide (MgO) or magnesium hydroxide or oxyhydroxide.

An aspect is directed to a Li-ion battery with a Si-comprising anode or with a blended anode (e.g., comprising Si-comprising active material and graphite active material, etc.) that exhibits a relatively high areal capacity loading and properly matched (by areal capacity) cathode (with slightly smaller areal capacity loadings, selected according to the desired negative (N) to positive (P) ratio, N/P in the range of around 0.95 to around 1.35—in some designs, from around 0.95 to around 1.10; 1.01 to around 1.05; in other designs, from around 1.05 to around 1.10; in other designs, from around 1.10 to around 1.15; in other designs from around 1.15 to around 1.20; in other designs from around 1.20 to around 1.25; in yet other designs, from around 1.25 to around 1.35; wherein the N/P ratio corresponds to the ratio of the reversible areal capacities of the anode to cathode). Note that both the performance characteristics and cycle stability of Li-ion battery cells may become particularly unsatisfactory for applications requiring long calendar life or long cycle life or low first cycle losses or other properties, if the electrode areal capacity loading exceeds around 1-2 mAh/cm², even more if the electrode areal capacity exceeds around 4-5 mAh/cm², yet even more if the electrode areal capacity exceeds around 6 mAh/cm² and yet even more if the electrode areal capacity exceeds around 8 mAh/cm². Higher loading, however, is advantageous for reducing cost of energy storage devices and increasing their energy density. One or more embodiments of the present disclosure are directed to fabrication processes, compositions and various physical and chemical properties of anodes and cathodes that enable satisfactory performance for electrode area loadings in the range from around 2 mAh/cm² to around 4 mAh/cm² and more so for loadings in the range from around 4 mAh/cm² to around 8 mAh/cm² and even more so for loadings in the range from around 8 mAh/cm² to around 16 mAh/cm² (e.g., in some designs, an areal capacity loading of an electrode may range from around 2 mAh/cm² to around 16 mAh/cm²).

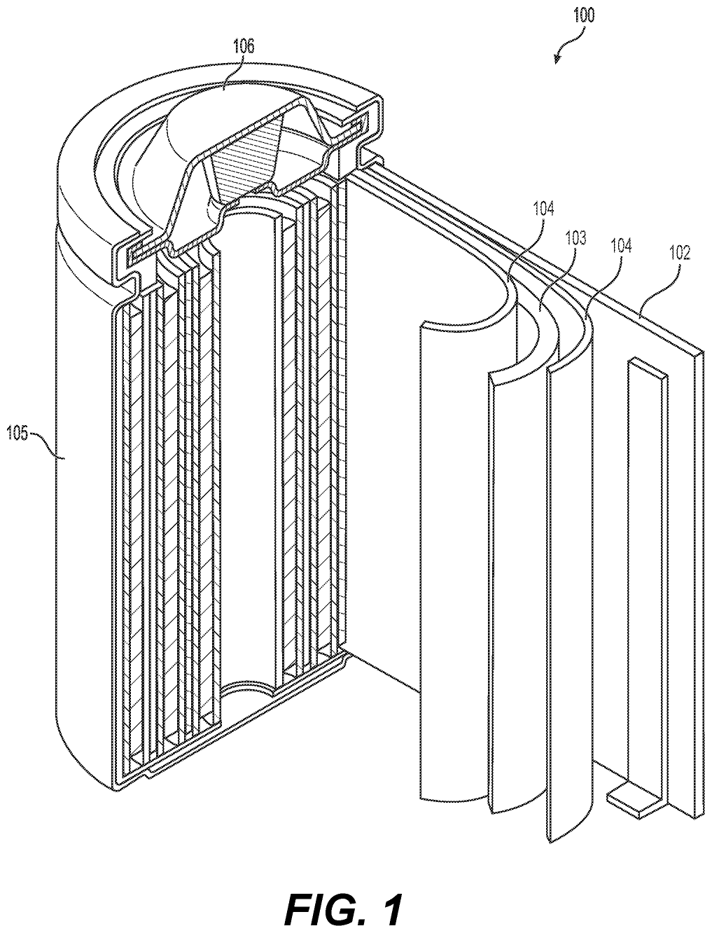

FIG. 1 illustrates an example metal-ion (e.g., Li-ion) battery in which the electrode particles, components, materials, processes, and other techniques described herein, or combinations thereof, may be applied according to various embodiments. A cylindrical battery is shown here for illustration purposes, but other types of arrangements, including prismatic or pouch (laminate-type) batteries, may also be used as desired. The example battery 100 includes a negative electrode (anode electrode or anode) 102, a positive electrode (cathode electrode or cathode) 103, a separator 104 interposed between the anode 102 and the cathode 103, an electrolyte (shown implicitly) impregnating the separator 104, a battery case 105, and a sealing member 106 sealing the battery case 105. The electrolyte ionically couples the anode (negative electrode) and the cathode (positive electrode). The electrolyte is interposed between the anode electrode and the cathode electrode. In some implementations, battery 100 also includes an anode current collector and a cathode current collector. The anode is disposed on and/or in the anode current collector and the cathode is disposed on and/or in the cathode current collector.

Conventional electrode processing typically relies on the preparation of a slurry that comprises 65-75 vol. % of solvents and 25-35 vol. % of solids (active materials, polymer binder, conductive and other additives). The use of solvent(s) may enable formation of uniform electrodes that adhere well to current collectors, but such solvent(s) need to be slowly evaporated and (in some cases) re-used, which increases electrode production cost, energy consumption and CO2 emission. In addition, the processing of a solvent-comprising slurry into electrodes becomes particularly challenging, time-consuming, and expensive for thicker, higher-loading electrodes (e.g., above about 4 mAh/cm², even more so above 6 mAh/cm², yet even more so above 8 mAh/cm²). Such high-loading electrodes require very slow drying conditions and may suffer from a non-uniform binder distribution. It is, therefore, desirable to develop electrode processing methods that either do not use conventional solvents at all (“dry” process) or use significantly reduced amounts of solvents in the slurry. From this perspective, the smaller the amount of conventional solvent, the better. In some implementations of a slurry in which the amount of solvents is “significantly reduced,” it may be preferable to reduce the amount of solvent in the slurry by a factor of about 4 to 20 times, compared to a conventional slurry, or use a slurry in which the volume fraction of solvents in the slurry is in a range of 3 to about 20 vol. %.

Conventional solvent-free electrode processing typically relies on the use of relatively soft thermoplastic polymers such as certain thermoplastic fluorinated polymers as binders for electrode processing. One example of such a polymer is polytetrafluoroethylene (PTFE), which is a polymer of tetrafluoroethylene. Other examples of such polymers include copolymers of tetrafluoroethylene: ethylene tetrafluoroethylene (ETFE), which is a copolymer of tetrafluoroethylene and ethylene; fluorinated ethylene propylene (FEP), which is a copolymer of tetrafluoroethylene and hexafluoropropylene; and perfluoroalkoxy alkanes (PFA), which are copolymers of tetrafluoroethylene and perfluoroethers. Perfluoroethers have a structure C₂F₃OR where R is a perfluorinated group such as trifluoromethyl. Another example of such as polymer is polychlorotrifluoroethylene (PCTFE) which is a polymer of chlorotrifluoroethylene. Other examples of such polymers include copolymers of chlorotrifluoroethylene, such as ethylene-chlorotrifluoroethylene (E-CTFE), which is a copolymer of chlorotrifluoroethylene and ethylene. Thermoplastic fluoropolymers (including chlorofluoropolymers) as exemplified in these foregoing example polymers and copolymers, including PTFE, are sometimes referred to as PTFE-like polymers herein. Such soft thermoplastic polymers may enable processing of mixtures by extrusion. Some of such methods rely on pre-fibrillation of such (e.g., PTFE-like) polymers, mixing the fibrillated polymers with active materials and conductive additives and extruding thin electrode films using pressure rollers. However, such polymers are typically soft, which results in poor cohesive forces between active materials and poor adhesion to current collectors, causing electrodes to degrade during cycling (e.g., due to the volume changes within active materials upon ion insertion and extraction and/or overall swell in electrodes during “battery formation”, long-term cycling and/or storage, electrolyte decomposition, etc.). In addition, it is often difficult to attain (a desired) uniform distribution of active materials, conductive additives and fibrillated (e.g., PTFE-like) polymers in such “dry” (solvent-free) processed electrodes. Agglomerated active materials, in turn, may induce mechanical damage to the equipment (e.g., extrusion rollers), negatively affect electrode stability or battery rate performance, or significantly reduce production yield. Excessive mixing/processing of these “dry” electrode slurries (e.g., needed in some designs to achieve a higher level of electrode uniformity) may undesirably “over-fibrillate” these (e.g., PTFE-like) polymers to the level when they lose their mechanical integrity, which may, in turn, produce defects in the processed electrodes and negatively affect their performance in battery cells. In some occasions, F-comprising polymers on the surface of anode may also react with Li ions on the anode, leading to some additional irreversible capacity losses, although bulk polymer's integrity may largely remain intact.

An aspect is directed to alternative solvent-free “dry” (or with significantly reduced amount of solvent) fabrication that enhances mechanical strength, improves electrode uniformity, improves electrode adhesion to the current collectors (e.g., without needing a surface coating interlayer between the electrode and the current collector foils or specially processed current collectors with high surface roughness), reduces the amount of binder needed for fabrication of electrodes and improves one or more of Li-ion battery performance characteristics (e.g., rate, stability, energy density, specific energy, etc.) and/or production yield.

It is typically desirable to minimize the mass and volume fraction of the binder(s) within the electrodes to enhance volumetric and gravimetric energy densities, lower electrode impedance and improve rate capability. It may be particularly advantageous, for example, for the electrode to comprise less than about 25-30 vol. % binder relative to the combined volume of the binder, conductive and other additives and active material particles (not counting the volume of the pores left within the electrode during or after its fabrication and also excluding the current collector)—in some designs, less than about 25 vol. %; in other designs, less than about 20 vol. %; in other designs, less than about 16 vol. %; in other designs, less than about 12 vol. %; in other designs, less than about 8 vol. %; in yet other designs, less than about 6 vol. %). It may also be advantageous, for the electrode to comprise less than about 14-16 wt. % binder relative to the combined weight of the binder, conductive and other additives, and active material particles—in some designs, less than about 14 wt. %; in other designs, less than about 12 wt. %; in other designs, less than about 10 wt. %; in other designs, less than about 8 wt. %; in other designs, less than about 6 wt. %; in other designs, less than about 5 wt. %; in other designs, less than about 4 wt. %; in other designs, less than about 3 wt. %).

An aspect is directed to the advantageous use of a suitable binder precursor in a “dry” electrode fabrication process. A suitable binder precursor may be a reactive precursor which undergoes polymerization under certain conditions to form a binder or binder component. Such a polymerizable binder precursor may be in a liquid form at ambient temperatures (e.g., any temperature within a range of about 20° C. to about 30° C.). The polymerizable binder precursor may include polymerizable organic compounds (e.g., monomers, oligomers, and/or polymers). Such a suitable binder precursor (e.g., including liquid monomers or liquid oligomers or liquid polymers) may be advantageously mixed with active electrode materials, conductive (or other functional) additives, and (optionally) additional (liquid or solid) binder component(s), thus obtaining a battery electrode precursor composition. Accordingly, a battery electrode precursor composition may comprise a liquid component (i.e., a polymerizable binder precursor in a liquid form) although (in some designs,) the battery electrode precursor composition may be substantially free of conventional solvents (e.g., water, conventional organic solvents). Herein, a battery electrode precursor composition may sometimes be referred to as “electrode mass.” The battery electrode precursor composition may be deposited onto a suitable current collector by a suitable process (described in greater detail hereinbelow) to form a battery electrode precursor disposed or in the current collector. Then, the battery electrode precursor may be converted into a battery electrode. As part of this conversion, the polymerizable binder precursor in the battery electrode precursor undergoes partial or complete polymerization and is transformed into polymers suitable for use as a binder in the battery electrode produced thereby. In some implementations, the transformation of the polymerizable binder precursor to binder may occur prior to assembly of the electrodes into a battery or prior to electrolyte (e.g., liquid electrolyte) infiltration into the battery or into the respective electrodes of the battery.

In some designs, the reactive (e.g., polymerizable) binder precursor(s) for the final binder formation may be selected from the following: (i) a liquid, (ii) a mixture of two or more liquids, (iii) a solid that melts in the temperature range about 30 to about 450° C., and (iv) a mixture of a liquid and solid, where the solid is either meltable (e.g., with a melting point in a range of about 30 to about 450° C.) or a non-melting solid (e.g., with a melting point above about 450° C.). In some designs, the use of at least one liquid component in a binder precursor may be particularly advantageous to obtain uniform mixing and/or improving tribological properties of the electrode precursor composition mixture prior to full electrode solidification (e.g., the transformation of a battery electrode precursor to a battery electrode). Herein, a binder precursor (e.g., monomers, oligomers, polymers) is referred to as being a partial or complete liquid if some or all of the binder precursor is a liquid at ambient temperature. In some implementations, a boiling point of one or more components of the binder precursor can be in the range about 70 to about 400° C.

In some designs, the formation of polymer binder(s) from the polymerizable binder precursor (e.g., liquid monomer or oligomer precursor(s)) may include (i) homo-polymerization reactions or (ii) hetero-polymerization reactions or (iii) both homo- and hetero-polymerization reactions. Illustrative examples for the formation of polymer binder(s) from the polymerizable binder precursor include, but are not limited to, the following reactions: (i) free radical polymerization (e.g., acrylate/(meth)acrylates), (ii) ring opening copolymerization of epoxies with anhydrides or amines, (iii) condensation polymerization of amino acids (e.g., glutamic acid), (iv) condensation of isocyanates with polyols or amines (e.g., polyurethane and polyurea, respectively), (v) azide-alkyne cycloaddition, (vi) thiol-ene click reaction, (vii) Diels-Alder cycloaddition, (viii) Michael addition reaction, (ix) olefin metathesis polymerization reaction, (x) acid (including both Lewis and Bronsted acids) or base (including both Lewis and Bronsted bases) mediated condensation polymerization, (xi) Friedel-Crafts polymerization, (xii) heat mediated condensation hetero-polymerization (e.g., between amine/alcohol and carboxylic acids/carboxylic acid anhydrides/esters/boronic acids), and (xii) heat mediated homocondensation polymerization (e.g., boronic acid condensation).

Note that the binder curing (polymerization) method is chemistry-specific. For example, in case of the acrylate chemistry, it may be advantageous to use one or more of the following: (i) application of heat with thermal initiators, (ii) application of ultraviolet (UV) light with UV initiators, (iii) a combination of both heat and UV light, including use of respective initiators.

Acrylate chemistry involves polymerization of unsaturated ester monomers/oligomers. Examples of acrylate precursor include, but not limited to, methyl acrylate, methyl methacrylate, ethyl acrylate, ethyl methacrylate, n-propyl acrylate, n-propyl methacrylate, isopropyl acrylate, isopropyl methacrylate, lauryl acrylate, stearyl acrylate, butyl acrylate, 2-hydroxyethyl acrylate, 2-hydroxyethyl methacrylate, 3-hydroxypropyl methacrylate, 3-glycidyl propyl methacrylate, trimethylolpropane triacrylate, polyethylene glycol diacrylate, 1,6-hexanediol diacrylate, ethoxylated bisphenol A dimethacrylate, isobornyl acrylate, polyurethane acrylate, epoxy acrylate, polyethylene glycol monomethacrylate, aliphatic urethane acrylate oligomers, and aromatic urethane acrylate oligomers. Suitable commercially available acrylates include ARKEMA's SARTOMER products, such as SR-307, SR-306, SR-454, SR-9053, CN-131B, CN-502, CN-975, CN-986 and CN-301. Examples of thermal initiators include, but are not limited to, azobisisobutyronitrile (AIBN), 2,2′-azobis(2-methylpropionamidine) dihydrochloride (V-50), 2,2′-azobis(2,4-dimethylvaleronitrile) (ADMVN), benzoyl peroxide (BPO), di-tert-butyl peroxide (DTBP), diisopropyl peroxydicarbonate (DIPC), cumyl hydroperoxide (CHP), 2,2′-azobis(2-amidinopropane) dihydrochloride (V-511), and 2,2′-Azobis[2-(2-imidazolin-2-yl)propane] dihydrochloride (VA-044). Some examples of UV initiators are 2,2-dimethoxy-1,2-diphenylethan-1-one, 2-hydroxy-2-methyl-1-phenylpropanone, 1-hydroxy-cyclohexylphenylketone, benzophenone, and isopropyl thioxanthone. Suitable commercially available photoinitiators include DAROCUR 1173, DAROCUR 4265, IRGACURE 184, IRGACURE 369, IRGACURE 651, IRGACURE 819, IRGACURE 907, IRGACURE 1700, ESACURE KIP 150, ESACURE TZT, and LUCIRIN TPO-L.

In the case of epoxy chemistry, various epoxy resins can be used with different cross-linking agents. Examples include bisphenol A diglycidyl ether, Novolac epoxy resin, aliphatic epoxy resin, cycloaliphatic epoxy resin, and glycidyl amine epoxy resin. These epoxy resins can be used with hardening agents or curing agents. These are typically amine-based reagents, such as diethylenetriamine, triethylenetetramine, and polyamines, which react with the epoxide functional groups to form a crosslinked network. Amines could be nonaromatic (e.g., alkane, ether-functionalized alkane based containing suitable O, S or F functionalization), or aromatic amines (e.g., phenyl, naphthyl, or other heteroaromatic systems). Commercially available amines include JEFFAMINE products sold by HUNTSMAN, which include a range of monoamines, diamines and triamines attached to a polyether backbone. Selected examples are JEFFAMINE M-600, D-230, D-400, D-2000, ED-600, ED-900, EDR-148, T-403, T-3000, SD-2001, and RFD-270. Alternatively, anhydrides, such as phthalic anhydride and maleic anhydride, can react with the epoxide groups. Other anhydride examples include tetrahydrophthalic anhydride, methyltetrahydrophthalic anhydride, hexahydrophthalic anhydride, and nadic methyl anhydride. For the formation of epoxy resins using aromatic amines, polyanhydrides, dicyandiamide and combinations, with phenol formaldehyde and melamine formaldehyde, etc.), it may be advantageous in some designs to use one of the following curing methods: (i) application of heat, (ii) application of an electron beam (e-beam), (iii) a combination of both heat and e-beam exposure.

In case of the urethane/urea chemistry, it may be advantageous to utilize heat. Polyurethane can be formed by mixing a polyisocyanate with a polyol. Polyurethane chemistry can be further modified by the choice of polyol, polyisocyanate, and crosslinking agent. For example, the final properties of the polyurethane can be custom tailored by using polyols with different molecular weights, functionalities and structures. Examples of polyols include polyester polyols, polyether polyols, polycaprolactone polyols, acrylic polyols, and polysaccharide polyols. Similarly, the choice of polyisocyanate and crosslinking agent can be used to modify the reactivity and performance of the polyurethane. Examples of isocyanates include toluene diisocyanate (TDI), diphenylmethane diisocyanate (MDI), hexamethylene diisocyanate (HDI), isophorone diisocyanate (IPDI), naphthalene diisocyanate (NDI), and polymethylene polyphenyl isocyanate (PAPI). These isocyanates can be blocked to temporarily suppress their reactivity towards polyols at ambient temperature, but activated at an elevated temperature. When a blocked isocyanate is heated, the blocking agent is released, allowing isocyanate groups to react with the polyols. Some common blocking agents used in the preparation of blocked isocyanates include phenols, oximes and lactams. Polyurethane prepolymers can further react with a low molecular weight diol or diamine to extend the polymer chain length or crosslinked with a crosslinking agent. In some designs, the crosslinking agent may be a compound with multiple isocyanate reactive groups, such as a polyol or a polyamine.

An aspect is directed to an application of heat during “dry” (i.e., substantially free of conventional solvents) electrode processing or electrode processing with significantly reduced amount of solvents by one or more of the following processes: (i) heating the current collector (e.g., by passing an electrical current through the current collector) to heat the electrode precursor disposed thereon or therein, (ii) application of (e.g., infrared) radiation to the electrode precursor surface (e.g., by passing the electrode precursor through a suitable oven or by using a lamp), (iii) application of electrical current through the electrode precursor (or at least a part of the electrode precursor), (iv) application of a hot gas (e.g., air, nitrogen, etc.) to a surface of the current collector and/or the electrode precursor, (v) physical contact of the current collector and/or the electrode precursor with one or more hot roller(s), (vi) application of a low power laser to a surface of the current collector and/or the electrode precursor, and (vii) application of reactive gasses to the electrode precursor.

In some designs, some or all of the following properties (numbered i through xiv) of the polymerizable binder precursor (e.g., monomers, oligomers, polymers) are particularly advantageous in the context of one or more embodiments of the present disclosure: (i) The polymerizable binder precursor allows or enhances dispersion or individualization of the particles (and conductive additives) such that formed polymers are attached to individual particles and not their agglomerates (in some designs, the viscosity of the precursor can range between 0.001 to 1 Pascal seconds (Pa-s)). In some designs, the polymerizable binder precursor may be transparent and in others opaque. (ii) The reactivity of the polymerizable binder precursor is such that an external stimulus allows initiation of a controllable polymerization. (iii) The polymerizable binder precursor is selected to have no or minimal amount of reactive functional groups remaining in the formed polymer binder after the polymerization (for example, no or minimal amount of nitro or carboxaldehyde groups which may be reduced at the anode, or no or minimal amount of hydroxy, ether, or carboxaldehyde groups which may be oxidized at the cathode). (iv) The backbone of the formed polymer binder may preferably be (mostly or fully) composed of unreactive chemical bonds (such as carbon-carbon), which may remain intact during electrode operation (battery cycling) (note that only specific carbon-carbon bond forming polymerization reactions would lead to attaining this property). (v) In some designs where a flexible binder is needed, the polymer binder backbone may preferably have fragment(s) composed of a monomer (or oligomer) with reactive units (responsible for polymerization) which are separated by a flexible spacer (such as oligoether, alkyl oligoether, propyl, butyl, or longer alkyl chains, to name a few). (vi) In some designs where a stiffer binder is needed, the polymerizable binder precursor may preferably contain short spacer(s), such as ethyl (as in polystyrene) in one example. (vii) In some designs where a flexible binder is needed, the pendant groups of the polymerizable binder precursor may preferably be also flexible and devoid of functional groups (for example, hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc.) that can participate in inter/intra-chain interactions, such as hydrogen-bonding. (viii) In some designs where a stiffer binder is needed, the pendant groups polymerizable binder precursor may preferably contain functional groups (hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc.). (ix) In some designs where strong adhesion to the particle surface is desirable, functional groups such as hydroxy, carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides, etc. may preferably be present in the polymerizable binder precursor. (x) In some designs where the swell of final binder may preferably be tuned, it may also be advantageous to utilize above discussed functional groups in the polymerizable binder precursor (e.g., the most preferable functional groups may be dictated by the electrolyte with which the binder will come into contact; for example, in order to reduce or minimize swell in commonly used carbonate-based electrolytes, the presence of more polar functional groups, such as carboxylic acids or their salts with Li⁺, Na⁺, K⁺, Ca²⁺, Mg²⁺, etc., sulfonic acids or their salts with Li⁺, Na⁺, K⁺, Ca²⁺, Mg²⁺, amides, imides, sulfonamides may be preferred). (xi) In some designs, the polymerizable binder precursor may be functionalized with Li⁺ ions in order to supplement Li⁺ ions in the battery cell. (xii) In some designs, it may be advantageous for the polymerizable binder precursor to comprise oligoether pendant groups in order to promote ionic conduction through the polymer binder and thus reduce a binder-induced ionic resistance contribution. (xiii) In some designs, the formed binder's rigidity or hardness may additionally be improved by adding bi-/tri-/tetra-functional monomers in the polymerizable binder precursor which can cross-link and provide sufficiently rigid networks. (xiv) In some designs, the polymerizable binder precursor may be selected to allow wetting of the particle surfaces and, more importantly, the formed polymers may preferably form relatively smooth interface with the particle surface (note that this property is also dependent on particle surface chemistry and roughness, which means specific binder precursor compounds would be applicable for a particular particle surface).

In some designs, in addition to the use of liquid monomer(s) and/or liquid oligomer(s), one or more of additive liquid or solid polymer(s) may be effectively utilized as an additional binder component for electrode fabrication that is “dry” (solvent-free) or with significantly reduced amount of solvent.

An aspect is directed to suitable physical properties of binders formed after polymerization of the polymerizable binder precursor (e.g., liquid monomers and/or oligomers). In some designs, the molecular weights of linear homopolymers or copolymers, after polymerization, may range between about 10,000 kDa to about 2,000,000 kDa. In some designs, the molecular weight may range from about 10,000 to about 100,000 kDa, while in other designs from about 100,000 kDa to about 500,000 kDa, in other designs from about 500,000 kDa to about 1,000,000 kDa, while in yet other designs from about 1000,000 to about 2,000,000 kDa. Molecular weights of polymers dictate properties of binders including: glass transition temperatures, hardness, swelling behavior in presence of electrolytes, among others.

In some designs, the additive liquid polymers may be used as a lever to (1) achieve appropriate overall hardness/softness of the solid electrode such that cohesive forces between particles are maintained and adhesion of the particles to the current collector are maintained, (2) enable appropriate electrode swelling in the presence of an electrolyte (e.g., to permit or enhance ion diffusion), and (3) control tribological properties.

In some designs, the additive liquid polymers may help to disperse the active material particles in the battery electrode precursor composition before the polymerization of a polymerizable binder precursor (e.g., liquid monomers and oligomers). Functional groups on the additive liquid polymer such as ethylene glycol (EG) and propylene glycol (PG) groups may facilitate the liquid polymer coating the particle surfaces and reducing inter-particle Van der Waals forces, thereby facilitating dispersion of the particles in the battery electrode precursor composition.

Another aspect is directed to the ability of some liquid polymers to enhance interfacial properties, such as improving the wettability of monomers and oligomers on the surfaces of electrode particles (e.g., Si—C composite particles). In particular, since some liquid monomers and liquid oligomers exhibit poor wettability on the surfaces of electrode particles, additive liquid polymers may be utilized to modify the surfaces of electrode particles (e.g., improve the wettability of some liquid monomers and liquid oligomers, which may be employed as components of a polymerizable binder precursor, on the surfaces of the electrode particles) before mixing the particles with the liquid monomers and the liquid oligomers, which may be employed as components of a polymerizable binder precursor, in some designs.

Illustrative example of suitable liquid polymers include, but are not limited to, the following: poly(ethylene glycol) (PEG), poly(propylene glycol) (PPG), poly(tetrahydrofuran) (PTHF), poly(dimethylsiloxane) (PDMS), and poly(methylphenylsiloxane) (PMPS).

An aspect is directed to the application of a binder comprising nanofibers (or nanowires) for “dry” (solvent-free) electrode processing or electrode processing with significantly reduced amount of solvents. In some designs, such nanofibers (or nanowires) may exhibit an aspect ratio in a range from about 1:5 to about 1:5000. In some designs, such fibers (or nanofibers) may exhibit average diameters in the range of about 5 nm to about 500 nm (in some designs, from about 5 nm to about 25 nm; in other designs, from about 25 nm to about 100 nm; in other designs, from about 100 nm to about 500 nm). In some designs, such nanofibers (or nanowires) may exhibit lengths from about 10 nm (about 0.01 micron) to about 500 micron (in some designs, from about 10 nm to about 1 micron (μm); in other designs, from about 1 micron to about 25 micron; in other designs, from about 25 micron to about 100 micron; in yet other designs, from about 100 micron to about 500 micron).

In some designs, such nanofibers (or nanowires) may comprise an electrically conductive material. In other designs, such nanofibers (or nanowires) may comprise an electrically insulative material. In some designs, such nanofibers (or nanowires) may comprise polymer(s). In other designs, such nanofibers (or nanowires) may comprise ceramic(s). In some designs, at least some of such nanofibers (or nanowires) may be chemically or physically attached to the active electrode material particles, conductive additive particles, or other functional additive particles. Examples of advantages for using such nanofiber-shaped binder (or binder component) may include one or more of the following: changed (e.g., increased) average separation distance between the particles during electrode deposition, improved electrode uniformity, reduced needed amount of the liquid binder precursor, reduced curing time, simplified curing conditions, simplified conditions for activation of curing, enhanced mechanical properties of the “dry” (solvent-free) processed electrodes or electrodes processed with significantly reduced amount of solvents, and reduced tortuosity of the “dry” processed electrodes or electrodes processed with significantly reduced amount of solvents, to name a few.

An aspect is directed to the application of a binder comprising nanoflakes (which may be highly curved in some designs; the radii of curvature of curved nanoflakes may range between about 2 nm to about 200 μm, for example) for “dry” electrode processing. In some designs, such nanoflakes may exhibit aspect ratios in a range from about 1:5 to about 1:5000. In some designs, such nanoflakes may exhibit an average thickness in the range of about 0.3 nm to about 100 nm (in some designs, from about 0.3 nm to about 5 nm; in other designs, from about 5 nm to about 20 nm; in other designs, from about 20 nm to about 100 nm). In some designs, such nanoflakes may exhibit average lateral dimensions from around 10 nm (0.01 micron) to about 20 micron (in some designs, from around 10 nm to about 1 micron; in other designs, from about 1 micron to about 5 micron; in other designs, from about 5 micron to about 20 micron).

In some designs, such nanoflakes may comprise an electrically conductive material. In other designs, such nanoflakes may comprise an electrically insulative material. In some designs, such nanoflakes may comprise polymer(s). In other designs, such nanoflakes may comprise ceramic(s). In some designs, at least some of such nanoflakes may be chemically or physically attached to the active electrode material particles, conductive additive particles, or other functional additive particles. Examples of advantages for using such nanoflake-shaped binder (or binder component) may include one or more of the following: changed (e.g., increased) average separation distance between the particles during electrode deposition, improved electrode uniformity, reduced needed amount of the liquid binder precursor, reduced curing time, simplified curing conditions, simplified conditions for activation of curing, enhanced mechanical properties of the “dry” (solvent-free) processed electrodes or electrodes processed with a significantly reduced amount of solvents, and/or reduced tortuosity of the “dry” processed electrodes or electrodes processed with a significantly reduced amount of solvents, to name a few.

In some designs, the use of a significant fraction (e.g., about 10-100 wt. %) of spheroid or oblate spheroid shaped electrode active electrode material particles and/or additive particles may be advantageous in “dry” (solvent-free) electrode formation or electrode formation with a significantly reduced amount of solvents as such particles may often exhibit superior tribological, compaction and/or fluidization properties.

In other designs, the use of significant fraction (e.g., about 10-100 wt. %) of elongated (e.g., 1D) or flattened (e.g., 2D) (e.g., with aspect ratios in the range from about 1.5 to about 1500; in some designs, with aspect ratios from about 1.5 to about 5; in other designs, from about 5 to about 20; in other designs, from about 20 to about 100; in yet other designs, from about 100 to about 1500) active electrode material particles and/or additive particles and/or separator layer particles may be advantageous. In some designs, such particles may orient themselves parallel to the electrode surface and thus improve electrode uniformity and mechanical properties.

An aspect is directed to a suitable size distribution of active material particles (e.g., Si—C composite particles) used in “dry” (i.e., substantially free of conventional solvents) electrode processing or electrode processing with a significantly reduced amount of solvents. In some (e.g., most) designs, however, the suitable D₅₀ values of the suitable active material particles may range from about 0.025 μm to about 15 μm (in some designs, from about 0.025 μm to about 0.2 μm; in other designs, from about 0.2 μm to about 1 μm; in other designs, from about 1 μm to about 2 μm; in other designs, from about 2 μm to about 5 μm; in yet other designs, from about 5 μm to about 15 μm). In some (e.g., most) designs, suitable D₉₀ values of the suitable active material particles (e.g., Si—C composite particles) may range from about 0.1 μm to about 30 μm (in some designs, from about 0.1 μm to about 0.5 μm; in other designs, from about 0.5 μm to about 2 μm; in other designs, from about 2 μm to about 5 μm; in other designs, from about 5 μm to about 15 μm; in other designs, from about 15 μm to about 30 μm;). In some (e.g., most) designs, the suitable D₁₀ values of the suitable active material particles (e.g., Si—C composite particles) may range from about 0.05 μm to about 2 μm (in some designs, from about 0.05 μm to about 0.5 μm; in other designs, from about 0.5 μm to about 2 μm). The presence of too large particles may lead to undesirable defects in the “dry” electrodes (or electrodes processed with a significantly reduced amount of solvents) during processing, while the presence of too small particles may induce undesirably fast degradation in cells and also lead to agglomeration and excessive tortuosity in the electrodes.

An aspect is directed to polymer binder properties used in “dry” (solvent-free) electrode processing or electrode processing with a significantly reduced amount of solvents. In some designs, the primary function of a polymer binder is to hold the active battery materials (e.g., cathode or anode) together and provide mechanical stability, and stable operation of a battery cell. In some designs, this requires one or more of the following characteristics, numbered (i) through (vi): (i) Good adhesion between active materials particles and between the particles and the current collector (e.g., copper foil for anode and aluminum foil for cathode). Adhesion strength or “peel strength” is a measure of how strongly the coated materials are adhered to the substrate (e.g., aluminum or copper foil), and is measured by estimating the force (common unit is Newton (N)) acting across the width of the coated surface when peeled at a constant velocity. The peel strength of the coatings formed upon polymerization should preferably range between about 0.001 N/cm to about 10 N/cm. (ii) no significant chemical or electrochemical degradation of the binder at the applied voltages in the presence of electrolytes. This is typically ensured by having strong chemical bonds having bond energy in the range from about 60 kcal/mol to about 250 kcal/mol. The constituent elements of such bonds may preferably include, but are not limited to: carbon, nitrogen, fluorine, phosphorus, oxygen, sulfur, chlorine, bromine, and silicon, to name a few. These chemical bonds may be single bonds, double bonds, and/or triple bonds, or in some cases may comprise aromatic moieties, including but not limited to heteroaromatic moieties, such as pyridine, pyrimidine, triazine, triazole, tetrazole, furan, pyrrole, thiophene, and their higher homologues, to name a few. In some designs, these rather stringent requirements may preferably be maintained during battery cycling, including elevated temperature operations. This is particularly important in some designs for high capacity electrodes (e.g., conversion cathodes and anodes) that undergo large volume changes during charge-discharge cycles. Furthermore, in some designs, the polymeric binder may preferably (iii) not dissolve in the employed electrolyte, and may swell to only a relatively small degree (in some designs, below about 50 vol. %, on average; in other designs, below about 40 vol. %; in other designs, below about 30 vol. %; in other designs, below about 20 vol. %; in yet other designs, below about 10 vol. %) that allows or enhances ion transportation through the binder to reduce or prevent its adhesion properties from being significantly degraded to the extent that the polymeric binder cannot maintain mechanical stability, which may cause capacity fade over time. Other key preferences for the binder in some designs may include (iv) good thermal stability (especially suitable thermal expansion coefficient in the range about 0.01 to about 40 K⁻¹) to allow stable operation of different batteries at different temperatures (e.g., about −10 to about 50° C.), (v) low outgassing (e.g., binder should not contribute to outgassing, which is primarily contributed by electrolyte and the SEI formed therefrom), and (vi) low fatigue (for example, less than about 10% after 2000 cycle life) over time; fatigue refers to loss of a physical property upon cyclic operation for a long time. In general, binder's fatigue is most commonly related to mechanical properties, but in the case of electrochemical testing, binder's fatigue can be related to other polymer properties as well, such as swelling, adhesion and cohesion properties, ion-conduction ability, among others. In some designs, it is desirable that the polymers maintain their original properties, and if fatigue is inevitable, then the loss of the above properties is not more than about 10% over a period of 2000 cycles.

An aspect is directed to an electrode fabricated using a casting technique (e.g., tape casting, etc.) or its variation or combination of casting with other methods. For high-precision electrode thickness control and uniformity, a doctor blade system may be applied. In some implementations, an electrode mass (e.g., active material particles, conductive and other functional additives, polymerizable binder precursor(s), and optionally other binder components, etc.) is poured from a reservoir onto a moving current collector (e.g., a metal foil, etc.). The gap between the bottom of the reservoir (defined by the position of the doctor blade) and the substrate (i.e., current collector) determines the initial thickness (prior to thickness changes caused by densification and/or polymerization of the polymerizable binder precursor) and areal mass loading of the electrode. The thickness is also controlled by the movement speed, electrode mass viscosity, the particular composition of the electrode mass, and other factors.

In conventional electrode manufacturing, a typical electrode slurry (which is analogous to what is referred to as “electrode mass” or the battery electrode precursor composition according to some embodiments) suitable for casting requires a binder (or binder solution including solvents) at a volume fraction of about 50 to about 80 vol. % in the electrode slurry. However, the final electrode (after drying of solvents and any densification) preferably comprises a much smaller volume fraction of the binder (e.g., the binder is from about 2 vol. % up to about 20-25 vol. % relative to the total volume of the electrode, including active material, conductive and other additives, and the binder, but excluding the current collector). For this reason, electrode casting using conventional solvents is typically used in conventional electrode fabrication since a significant fraction of the binder solution is taken up by solvents that are removed (by evaporation) from the electrode after casting. It is challenging to carry out uniform, “dry” (i.e., substantially free of conventional solvents) casting of electrodes in which the binder takes up a small weight fraction and a small volume fraction of the electrode. For example, increasing the volume fraction of solids in the electrode slurry to above around 50-70 vol. % (less than about 30-50 vol. % binder or binder solution) typically leads to rapid increase in the viscosity of the electrode slurry and highly undesirable aggregation of the solids in the electrode slurry.

In some designs, an ultrasound treatment, a vibration treatment and/or continuous stirring (e.g., at high rates) may be applied during the casting procedure to break-up agglomerates and reduce slurry viscosity when a small volume fraction of the binder is used in the electrode slurries (e.g., below about 20-25 vol. %).

In some designs, the use of ultra-low viscosity binder precursors in a range of 0.3 to 3 cP (e.g., monomers and/or oligomers, which can be polymerized after casting by a suitable process, such as a thermal, a UV light, an e-beam, or a chemical polymerization process) may be highly advantageous for electrode casting. In some designs, a binder precursor molecule (e.g., monomer, oligomer) may preferably bear at least two reactive functional groups (e.g., to enable effective cross-polymerization). In some designs, mixtures of two or more precursor molecules may be effectively employed. For example, a first precursor molecule may undergo linear polymerization, a second precursor molecule may act as a cross-linking agent, and a third precursor molecule may reduce binder viscosity. In some designs, a chemical initiator (in some designs, also a catalyst) may be added to the electrode mass (e.g., immediately before the casting procedure). The initiator ignites (initiates) the polymerization, and the catalyst may increase the polymerization rate and/or decrease the polymerization temperature. The catalyst may also contribute to adjusting the molecular weight or polydispersity index. In some designs, it may be advantageous to adjust the temperature ranges at which polymerization occurs. For example, suppose that casting of the electrode mass is to be carried out at a first elevated temperature (e.g., a moderately high temperature range that is higher than ambient temperature, e.g., in a range of 30-70° C.) in which the viscosity of the electrode mass (battery electrode precursor composition) is lower than at ambient temperature. In this case, it may be preferable to substantially prevent polymerization at this first elevated temperature range. After the electrode precursor has been formed by the casting process, polymerization may be carried out by (1) heating the electrode precursor to a second temperature that is higher than the first temperature, e.g., in a range of 60-200° C., or (2) another process such as UV light treatment or e-beam treatment. In such designs, for example, a polymerization inhibitor may be used instead of the catalyst. In some designs, an inhibitor prevents polymerization of polymerizable molecules (e.g., monomer, oligomer) at moderate or ambient temperature conditions (e.g., the first elevated temperature, ambient temperature). Accordingly, the use of an inhibitor may lower the viscosity of a battery electrode precursor composition such that it is in the form of a slurry or a paste. A catalyst or initiator can effectively overcome this polymerization inhibiting effect of the inhibitor. Thus, an initiator may be applied to the electrode precursor after the casting stage (e.g., onto a top surface electrode precursor, during or immediately before densification (e.g., hot calendering, hot press, etc.)) to enable casting of electrodes in a slurry or paste form. In some designs, the inhibitors may be removed from precursor molecules (e.g., monomer, oligomer) just prior to their use (e.g., mixing of the precursor molecules into a battery electrode precursor composition), because the efficiency of polymerization may be affected by the presence of the inhibitors. In other words, the degree of polymerization can be tuned by removal of the inhibitor often present in ppm (parts per million) quantities in commercially available polymerizable monomers and oligomers.

In some designs, the use of solid lubricants (e.g., carbon or graphite-based particles) may also be highly advantageous for electrode casting since these may reduce viscosity, agglomeration, and inter-particle friction.

In some designs, it may be advantageous to introduce gas bubbles (in some designs, air or nitrogen bubbles) into the battery electrode precursor composition (electrode mass) to reduce the viscosity of the composition and increase the physical separation of some of the particles within the composition. Note that in conventional solvent-comprising slurry casting, there is a preference to minimize or prevent bubble formation because the presence of bubbles may degrade electrode resistivity, rate performance, and energy density. In “dry” electrode fabrication (solvent-free) or electrode fabrication with a significantly reduced amount of solvents, however, this process of introducing gas bubbles (which may be called “foaming”) may be used advantageously. However, in some implementations, it is important to control the size of the gas bubbles. For example, it may be preferable for the average size of the gas bubbles not to exceed around 250 μm (in some designs, not to exceed around 200 μm; in other designs, not to exceed around 150 μm; in other designs, not to exceed around 100 μm; in other designs, not to exceed around 50 μm; in other designs, not to exceed around 30 μm; in yet other designs, not to exceed around 20 μm). The optimal gas bubble size may depend on the particle size distribution within the electrode mass (larger active material particles generally require larger gas bubble sizes). However, gas bubbles that are excessively large may lead to significant non-uniformities within the electrode during their collapse and are found to be undesirable. The beneficial effects of the use of a “foamed” electrode mass may include the following: (1) reduce (in some cases, significantly reduce) the viscosity of the electrode mass, (2) help to separate individual active material particles in the electrode mass, (3) reduce agglomeration during casting, (4) enable relatively uniform electrode casting, and/or (4) reduce tortuosity within the electrode.

It should be noted that electrode mass foams are thermodynamically unstable and tend to collapse or decay over time, which may be undesirable if it happens too quickly. Indeed, foamed electrode mass should preferably be stable for sufficient time to prevent pore collapse prior to (or during) casting to maintain desired uniformity of the casted electrodes. Several strategies and properties for foamed electrode mass were found to be effective for kinetic foam stabilization. Foam stability may be improved by figuring out how to slow down (effectively prevent during a time period that is sufficiently long for casting) collapse of two neighboring foam gas bubbles. This is related to the surface tension of the bubbles and may be tunable by (1) the chemistry of the precursor molecules (e.g., monomers) undergoing polymerization, (2) by the presence of suitable additives, and (3) the conditions (including stimulus conditions such as energy in the form of heat or light and their rate of exposure) used for polymerization.

The dispersed phase in the “foamed” electrode mass may comprise active material particles, the polymerizable binder precursor (as well as optionally, other binder components), and (e.g., conductive or other functional) additives. In some designs, attaining certain properties of the individual components of this dispersed phase and how they interact with the binder precursor (and/or other binder components) is critically important for achieving sufficiently stable electrode mass foam. In some designs, it may be advantageous for the foamed electrode mass to comprise foaming agents (foamers) or emulsifiers (e.g., from about 0.01 wt. % to about 5 wt. %-in some examples, from about 0.01 wt. % to about 0.1 wt. %; in other designs, from about 0.1 wt. % to about 0.25 wt. %; in other designs, from about 0.25 wt. % to about 1 wt. %; in other designs, from about 1 wt. % to about 2 wt. %; in yet other designs, from about 2 wt. % to about 5 wt. %, relative to the total weight of the electrode mass). Insufficient amounts of the foaming agents or emulsifiers may not provide sufficient stability, while excessive amounts may negatively affect electrode performance in the battery cells. In some designs, such foaming agents or emulsifiers may be modified (e.g., linked with a binder, transformed, or partially or fully decomposed) or (e.g., partially) evaporated or otherwise removed from the slurry during subsequent heat treatment, ultraviolet (UV) treatment, or other polymerization treatments.

Examples of suitable foaming agents or emulsifiers include but are not limited to: molecular surfactants (including, but not limited to fatty acids, alcohols, etc.), polymers or oligomers, large protein or protein-like structures, among others. Suitable molecular surfactants may generally be sub-divided into the following groups: (i) anionic surfactants (e.g., sulfates, sulfonates, phosphates, carboxylate derivatives, among others; specific illustrative examples: sodium lauryl sulfate (SDS), ammonium lauryl sulfate, sodium laureth sulfate, sodium myreth sulfate, docusate, perfluorooctanesulfonate, perfluorobutanesulfonate, alkyl-aryl ether phosphates, alkyl ether phosphates, etc.); (ii) cationic head group surfactants (e.g., primary, secondary or tertiary amines, quaternary ammonium salts, cetrimonium bromide (CTAB), cetylpyridinium chloride (CPC), benzalkonium chloride (BAC), benzethonium chloride (BZT), dimethyldioctadecylammonium chloride, dioctadecyldimethylammonium bromide (DODAB), etc.); (iii) zwitterionic (amphoteric) surfactants (with both cationic and anionic centers attached to the same molecule), where the cationic part is commonly based on primary, secondary or tertiary amines or quaternary ammonium cations; while the anionic part can be more variable and comprise, for example, sulfonates, phosphates, carboxylate, etc. (e.g., lauryldimethylamine oxide, myristamine oxide, etc.); and (iv) non-ionic surfactants (e.g., surfactants with covalently bonded oxygen-containing hydrophilic (polar) group-such as hydrophilic polyethylene oxide chain- and an aromatic hydrocarbon lipophilic or hydrophobic (non-polar) group). The solubility of the polar group of the non-ionic surfactants in a polar binder (or a polar binder precursor) may originate from hydrogen bonding, which commonly decreases at higher temperatures. Illustrative examples of the non-ionic surfactants include but are not limited to: (i) ethoxylates; (ii) fatty alcohol ethoxylates (e.g., octaethylene glycol monododecyl ether; pentaethylene glycol monododecyl ether, etc.); (iii) alkylphenol ethoxylates (e.g., Triton X-100; nonoxynols, etc.); (iv) fatty acid ethoxylates; (v) ethoxylated fatty esters and oils; (vi) ethoxylated amines and fatty acid amides (e.g., polyethoxylated tallow amine, cocamide monoethanolamine, cocamide diethanolamine, etc.); (vi) terminally blocked ethoxylates (e.g., poloxamers); (vii) fatty acid esters of polyhydroxy compounds; (viii) fatty acid esters of glycerol (e.g., glycerol monostearate, glycerol monolaurate, etc.); (ix) fatty acid esters of sorbitol (e.g., sorbitan monolaurate, sorbitan monostearate, sorbitan tristearate, Tween 20, Tween 40, Tween 60, Tween 80, etc.); (x) fatty acid esters of sucrose; and (xi) alkyl polyglucosides (e.g., decyl glucoside, lauryl glucoside, octyl glucoside, etc.), to name a few.

The surfactants from the foamed electrode mass may preferentially adsorb at the gas (e.g., air, nitrogen, etc.) bubble/dispersed phase (polymerizable binder precursor or other binder components, active material particles, additives, etc.) interface (e.g., because only one end of the surfactant may “like” this dispersed phase). In some designs, the dispersed phase may be polar. In this case the polar (or hydrophilic) end of the surfactant would be immersed into such a phase and the other end of the surfactant would face the gas in the bubble, thereby reducing interfacial surface energy (surface tension) and thus reducing the driving force for the bubble coalescence or collapse. Polymers, oligomers, and proteins enhance stability of the bubbles through electric and steric repulsion, by contributing to higher viscosity of the dispersed phase (e.g., relative to monomer components) and other complex interactions. In some designs, at least a portion of the polymerizable binder precursor or other binder components may effectively function as a foaming agent or emulsifier.

Wetting behavior of solid particles present in a dispersed phase (e.g., active material particles, conductive additive particles, other functional particles, etc.) may have a major impact on the stability of the foamed electrode mass. In addition, the particle-particle interactions, particle shape and particle size distribution may have a significant impact on foamed electrode mass stability. For example, it may be advantageous for the conductive or other functional particle additives to exhibit a wetting angle in contact with the binder precursor (or binder precursor/surfactant in the dispersed phase) below 90 degrees (e.g., from about 10 to about 90 degrees; in some designs, from about 20 to about 85 degrees; in some designs, from about 40 to about 80 degrees; in some designs, from about 50 to about 75 degrees; in some designs, from about 60 to about 70 degrees; in some designs, from about 10 to about 40 degrees; in other designs, from about 40 to about 80 degrees). A wetting angle above 90 degrees (poor wetting) may significantly reduce electrode mass foam stability. On the other hand, a suitable wetting angle may significantly enhance electrode mass foam stability. For example, particles with polar surfaces (e.g., oxides, such as silica, alumina, magnesia, other metal or semimetal oxides and suboxides, sulfates, phosphates, clay particles, functionalized or defective conductive carbon particles, latex particles, etc.) may often enhance electrode mass foam stability. Such particles may, for example, create a steric barrier at the interface and prevent coalesces of neighboring bubbles. Interestingly, a small level of flocculation of particles (particularly small particles) may be advantageous to foamed electrode mass stability. Such particles may also increase viscosity of the dispersed phase and form inter-bubble networks. It may be particularly advantageous for at least a large portion of such particles to be significantly (e.g., about 10× or more) smaller than the average size of the bubbles to be effective. In some designs, the size (e.g., diameter or thickness or average characteristic dimension, etc.) of such particles may preferably range from about 5 nm to about 500 nm (in some designs, from about 5 nm to about 50 nm; in other designs, from about 50 nm to about 200 nm; in other designs, from about 200 nm to about 500 nm). Smaller particles typically enable higher stability. Smaller particles often enable higher packing efficiency at the bubble interfaces and are more effective in preventing bubble coalescence or collapse. The shape of the small particles may also play a meaningful role. The use of smooth spheroidal (e.g., near-spherical) particles may be advantageous in some designs. The use of platelet-shaped particles (particles with aspect ratio more than 4; in some designs more than 10; in some designs, more than 40) may also be advantageous in some designs. In some designs, the use of suitable small particles (e.g., conductive or functional additives) in the dispersed phase in combination with the surfactants or foaming agents may be particularly advantageous. In some designs, it may be advantageous for the conductive or functional particles to contribute from about 0.01 wt. % to about 10 wt. % of the total weight of the electrode mass (comprising conductive and/or functional additives, binder precursor (and optionally, other binder components), surfactant(s) or foaming agents, active material particles, etc.) to be effective (in some designs, from about 0.01 wt. % to about 0.5 wt. %; in other designs, from about 0.5 wt. % to about 2 wt. %; in other designs, from about 2 wt. % to about 5 wt. %; in yet other designs, from about 5 wt. % to about 10 wt. %). In some designs, it may be advantageous for the conductive and/or functional additive particles to exhibit average particle size significantly (by over 10 times; in some designs, by over 25 times; in some designs, by over 50 times) smaller than the size of the active material particles. In some designs, it may be advantageous for the conductive and/or functional additive particles to comprise, two or three or more distinctly different (by composition and/or shape and/or size) particle distributions (e.g., comprise conductive carbon black or conductive carbon nanotube particles and, for example, spheroidal (e.g., near-spherical) silicon oxide particles and/or spheroidal (e.g., near-spherical) latex particles and/or spheroidal (e.g., near-spherical) and/or elongated aluminum (or magnesium) oxide or hydroxide particles and/or flake-shaped clay particles, etc.). In some designs, at least some of such conductive and/or functional additive particles may comprise surface coating(s) (e.g., with the thickness from about 0.1 nm to about 20 nm, on average) or functional groups fully or partially covering their surface.

A useful factor that may link how well small conductive or functional additive particles stabilize a foamed electrode mass is the particles' detachment energy (the free energy required to be supplied to remove an adsorbed particle from the bubble interface). As such particles may create a steric barrier for bubbles to coalescence, a higher particle detachment energy typically results in more force or longer time required to disrupt the particle layers and allow bubble coalescence.

In some designs, it may be advantageous to utilize small conductive or functional additive particles that exhibit both polar (e.g., hydrophilic) and non-polar (e.g., hydrophobic) sections. Such particles are often termed “Janus” particles in the literature. The use of such particles may significantly increase the particle detachment energy and thus enhance foamed electrode mass stability.

Collapsing or coalescing the gas bubbles in an electrode mass foam may also involve gas diffusion through the dispersed phase between the bubbles (typically leading to shrinking the smaller bubbles and growing the larger bubbles). By serving as a barrier to the gas diffusion, conductive or functional (e.g., small) particles may also help to enhance foamed electrode mass stability. In this regard, the use of flake-shaped particles accumulated at the interface may be particularly advantageous.

For electrode mass bubbles to coalesce, the wall thinning between the bubbles and eventual formation of holes in the wall would need to take place. If the bubble surface is covered with stabilizing species (foaming agents, small conductive or functional particles, etc.) a higher energy barrier would need to be overcome to form a critically sized (sufficiently large to expand) hole in the wall. If the (e.g., small conductive or functional) particles are strongly adsorbed at the surface (at the bubble-dispersed phase interface), they may tend to be laterally moved along the contact interface during bubble shape change or bubble volume changes, rather than expulsed into the open medium during wall thinning. As such, particle-particle forces (such as electric double layer repulsion, dipole-dipole repulsion, van der Waals attraction, capillary forces, etc.) impact the overall stability of foams, and may, in some cases, even dominate interactions over particle-interface attachment. For particles with ionizable surface groups, the part of the particles exposed to the dispersed phase may become charged, creating asymmetric charge distribution on the particles, thus inducing a dipole oriented perpendicular to the bubble/dispersed phase interface. When small conductive or functional particles form networks in the dispersed phase they may also help prevent bubble shape or size change.

In some designs, at least a small fraction of the binder precursor (or other binder component) in an electrode mass may include one or more of the following: (1) polyethylene oxide (PEO) polymer or oligomer, (2) PEO-like polymer or oligomer, (3) PEO-comprising co-polymer, and (4) polymer, co-polymer, or oligomer comprising a PEO-like chain or functional group. This is advantageous from the viewpoint of metal-ion conduction (e.g., Lit ion conduction in the case of Li⁺ ion battery).

In some designs, as previously mentioned, the combination of surfactants or foaming agents and small conductive or functional particles may be particularly advantageous for foamed electrode mass stability. The surfactants or foaming agents may help reduce interfacial tension, reduce contact (wetting) angle, promote particle flocculation or network formation, to name a few examples of favorable complementary interactions.

The wetting angle of the binder/binder precursor/surfactant(s) on the surface of active material particles may also have a major impact on the stability of the foamed electrode mass. In some designs, it may be preferable to minimize the exposure of active material particles to the surface/interface of the bubbles. In some designs, it may be preferable for the wetting angle to range from about 0 to about 90 degrees (in some designs, from about 0 to about 80 degrees; in some designs, from about 0 to about 70 degrees; in some designs, from about 0 to about 60 degrees; in some designs, from about 0 to about 50 degrees; in some designs, from about 0 to about 40 degrees; in some designs, from about 0 to about 30 degrees). Small wetting angle may be attained, for example, by depositing a surface coating on the active material particles, by functionalizing the active material particles, by using surfactants, by tuning (selecting) binder or binder precursor composition, by controlling the electrode mass temperature during casting and/or by using other strategies.

The size and shape of the active material particles may also play a significant role in stabilizing the foamed electrode mass. For example, using relatively small active material particles may be advantageous (e.g., with D₉₀ smaller than about 50% of the final calendered coating thickness; in some designs with Doo smaller than about 30% of the final calendered coating thickness; in other designs with Doo smaller than about 20% of the final calendered coating thickness; in other designs, with Doo smaller than about 30 μm; in other designs, with D₉₀ smaller than about 20 μm; in other designs, with D₉₀ smaller than about 15 μm; in other designs, with D₉₀ smaller than about 10 μm; in other designs, with D₅₀ smaller than 20 μm; in other designs, with D₅₀ smaller than about 15 μm; in other designs, with D₅₀ smaller than about 10 μm; in other designs, with D₅₀ smaller than about 7 μm; in other designs, with D₅₀ smaller than about 5 μm; in other designs, with D₅₀ smaller than about 3 μm; in other designs, with D₅₀ smaller than about 2 μm; in other designs, with D₅₀ smaller than about 1.5 μm). Also, using relatively rounded (e.g., spheroidal or near-spherical or near-elliptical or round or potato-shaped) active material particles may be advantageous.

An aspect is directed to an electrode fabricated using an extrusion technique or its variation (singly or combination with other processes).

Suitable extrusion temperature may typically range from about ambient temperature to about 200° C. (in some designs, from about ambient temperature to about 50° C.; in other designs, from about 50° C. to about 100° C.; in other designs, from about 100° C. to about 150° C.; in yet other designs, from about 150° C. to about 200° C.), the optimal value or range being dependent on the properties of the binder precursor (or other binder components), amount of the binder precursor (or other binder components), properties of the electrodes, the specifics of the extrusion apparatus and other factors.

Note that each of the active materials, the conductive and other additives, and the binder precursor (or other binder components) may have a different shape, size distribution, density, mechanical, chemical, thermal and/or tribological properties. Such differences may lead to the formation of inhomogeneous distribution of these components within the extruded electrode precursor, which is typically important to prevent.

Also note that during the mixing, the compression, and the overall movement of the electrode mass components (e.g., active materials, conductive and/or other additive(s), binder precursor, any other binder components, etc.) through the extrusion apparatus, friction forces arise (i) between the individual components of the electrode mass particles (internal friction) and (ii) between the components of the electrode mass and extruder walls (external friction). Reducing these friction forces is typically advantageous. External friction, for example, may lead to the formation of cracks or nonuniformities within processed electrodes. Thus, it may be advantageous to try to decrease the internal friction and/or the external friction either by adding a special (e.g., solid) lubricant (in some designs, carbon-based solid lubricant, such as natural or artificial graphite, soft carbon, carbon black or carbon onions, etc.) or by using a special material (e.g., coating or film, in some designs-replaceable film), characterized by a smaller friction coefficient. In some designs (e.g., when a film is used to minimize friction), it may be advantageous for the film thickness to range from about 5 μm to about 2.5 mm (in some designs, from about 0.005 mm to about 0.1 mm; in other designs, from about 0.1 mm to about 0.25 mm; in other designs, from about 0.25 mm to about 1 mm; in yet other designs, from about 1 mm to about 2.5 mm). A film that is too thin (e.g., thinner than 5 μm, in some designs) may break too quickly, while a film that is too thick (e.g., above 2.5 mm, in some designs) may be difficult to use in production due to its mechanical properties. In some designs, an elastic film mold may be utilized at one or more stage(s) (e.g., final stage) of the extrusion process.

Localized over-pressure during the electrode mass extrusion process may lead to the formation of cracks and defects. To minimize this undesirable outcome, in some designs, it may be advantageous to increase the pressure in several (e.g., 2-10) stages (in some designs, by about equal increments, e.g., for a 4-stage process-first press to about ¼ of the maximum pressure in stage 1; then to about ½ of the maximum pressure in stage 2; then to about ¾ of the maximum pressure in stage 3 and finally to the maximum pressure in stage 4). In some designs, it may also be advantageous to relax the extruded electrode mass in between such stages.

To accelerate electrode compaction during extrusion, to maximize the uniformity of the electrode mass during extrusion and/or to minimize the probability of the local overpressure cracks and defects, it may be advantageous in some designs to pre-process the electrode mass into (e.g., round or tubular or spheroidal or near-spherical) granules, where the electrode mass components (e.g., active materials, conductive and other additive(s), binder precursor, etc.) are uniformly mixed and densified. In addition, at the early stages of compression, trapped air may more easily escape the extrusion apparatus through intergranular pores. In some designs, the strength of the granules may be tailored to withstand handling and avoid pulverization and formation of fines (smaller sized active material particles) during processing, and yet the granules should fully disaggregate when the extrusion pressure approaches the maximum extrusion pressure in order to fill all the pores and enable high and uniform electrode density. In some designs, the size of the granules may preferably range from about 0.1 mm to about 10 mm (e.g., in some designs, from about 0.1 mm to about 0.5 mm; in other designs, from about 0.5 mm to about 2 mm; in other designs, from about 2 mm to about 5 mm; in yet other designs, from about 5 mm to about 10 mm). Granules that are too small may not provide sufficient uniformity (e.g., when some of the larger particle sizes in the distribution become comparable to the granule size) and may be more difficult to produce and handle. Granules that are too large may more easily break up (disaggregate) during handling and produce fine powders. The optimal size (or size range) of the granules is dependent on the size distribution of active material, properties and amount of the binder precursor, and other factors. To reduce external friction, it may be advantageous to add lubricants (in some designs, solid lubricants, etc.) into the battery electrode precursor composition or to the binder precursor or on the interface with extruder walls. In some designs, it may be advantageous to use molds with ceramic surfaces instead of metallic ones because the frictions between electrode mass components is typically higher in contact with metal relative to the contact with ceramic (e.g., ceramic-ceramic friction may be substantially lower than ceramic-metal friction). In addition, ceramic may be more durable as it exhibits higher hardness. The addition of carbon (e.g., carbon black or graphite, particularly relatively soft graphite) to the electrode mass may be advantageous because of its ability to reduce internal friction and/or external friction.

In some designs, it may be advantageous to apply ultrasound to at least parts of the extrusion apparatus during extrusion. Under comparable applied pressures, the application of ultrasound may enable a higher degree of uniformity and/or a greater density of the extruded electrode mass. Alternatively, for comparable densities of the extruded electrode mass, the application of ultrasound may reduce the necessary applied pressure and thereby reduce the external friction. In some designs, an extruded electrode mass may be attached to the current collector at a later (or final) stage of the extrusion process or at a subsequent calendering (additional densification, in addition to the extrusion) stage. The electrode mass, for example, may be laminated to both sides of the current collector (e.g., metal foil) and compressed. In some designs, the ultrasound may be applied to the current collector (e.g., to increase electrode density near the current collector).

In some designs, it may be advantageous to apply dynamic compaction (including, but not limited to a pulse or a wave-like compaction or vibrational compaction, instead of constant force or gradually increasing force compaction) to at least a portion of the extrusion apparatus. Under comparable applied pressures, the application of dynamic compaction may enable a higher degree of uniformity and/or a greater density of the extruded electrode mass. Alternatively, for comparable densities of the extruded electrode mass, the application of dynamic compaction may reduce the necessary applied pressure and thereby reduce the external friction. A shock-wave compaction may enable very rapid electrode consolidation, in some designs. In some designs, the duration of the pulse or the compression waves may range from about 1 microsecond to about 5 seconds (in some designs, from about 1 us to about 10 μs; in other designs, from about 10 us to about 100 μs; in other designs, from about 100 us to about 500 μs; in yet other designs, from about 500 us to about 5 s). In some designs (e.g., when vibration compaction is utilized), the intensity or frequency of the vibrations may change during the extrusion or during subsequent densification (e.g., during pressure-rolling or calendering). The optimal frequency of the vibration compaction depends on the composition and properties of the electrode mass and the particle size distribution. Smaller electrode particles typically require higher vibrational frequency. For example, for electrode particles with D₅₀ from around 0.25 to about 10 μm, the vibrational frequency may range from about 100 Hz to about 1 kHz (in some designs, from about 200 Hz to about 300 Hz); while for electrode particles with D₅₀ from around 5 to about 25 μm, the vibrational frequency may range from about 50 Hz to about 500 Hz (in some designs, from about 100 Hz to about 200 Hz). In some designs, the electrode particle sizes and the wavelength of vibrations should preferably be of the same order of magnitude (thus vibrational frequency should increase for smaller particles). Smaller electrode particles also typically require higher pressure. In some designs, an extruded electrode mass may be attached to the current collector at a later (or final) stage of the extrusion process or at a subsequent calendering (additional densification, in addition to the extrusion) stage. The electrode mass, for example, may be laminated to both sides of the current collector (e.g., metal foil) and compressed. In some designs, dynamic compaction may be applied to a stack of the electrode mass layer, current collector, and another electrode mass layer.

The suitable maximum pressure applied during extrusion or post-extrusion electrode densification may typically range from about 1 MPa (˜10 atm) to about 500 MPa (˜5,000 atm) (in some designs, from about 1 MPa to about 10 MPa; in other designs, from about 10 MPa to about 50 MPa; in other designs, from about 50 MPa to about 200 MPa; in yet other designs, from about 200 MPa to about 500 MPa), depending on the mechanical properties of the electrode particles, current collector foils, the amount and properties of the binder precursor, the desired target density, and other factors.

The foregoing extrusion techniques may be applied not only to polymerizable binder precursors but to other binder materials in making electrodes. Such polymers may have desirable properties (elastomeric or thermoplastic) for extrusion purposes. When the desired properties are not available in one polymer, a combination of polymers may be used to fine-tune the extrusion process. Examples of binder systems include, but are not limited to carboxymethyl cellulose (and its derivative with different degrees of substitution), polytetrafluoroethylene (PTFE) (and its derivatives), polyvinylidene fluoride, alginate, xanthan gum, polystyrene, poly(styrene-butadiene) rubber (SBR), poly(acrylonitrile-butadiene-styrene) (ABS), polymethylmethacrylate (PMMA), high- and low-density polyethylene, polycarbonate, polypropylene, polyurethane, polyvinylchloride-acrylic acid/ester copolymers, polychlorotrifluoroethylene (PCTFE), ethylene-chlorotrifluoroethylene (E-CTFE), fluorinated ethylene propylene (FEP), ethylene tetrafluoroethylene (ETFE), perfluoroalkoxy alkanes (PFA), styrene-acrylonitrile (SAN), styrene-co-acrylic acid and salts thereof, styrene-maleic anhydride (SMA), polyethylene terephtalate (PET), polyesters, polybutylene terephtalate (PBT), polyarylate (PAR), polyamides (nylons) of different types, polyimides, polyetherimides, polyaryletherketone (PAEK), polysulfone (PSF), polyethersulfone (PES), chitosan, polyacrylic acid, polyacrylonitrile, polyvinyl alcohol, xanthan gum, poly(3,4-ethylenedioxythiophene) polystyrene sulfonate (PEDOT:PSS), polymers with heterocycles (e.g., pyridine, thiophene), polyacrylamide, polyacrylamide-acrylic acid (or salts) copolymers, etc. Extrusion techniques may be applied to: (1) a mixture of polymerizable binder precursor and a binder polymer, (2) a mixture of binder polymers including a first binder polymer and a second binder polymer, and (3) a mixture of a binder polymer and another polymer that is not a binder polymer such as a melt-processable polymer.

An aspect is directed to an application of “dry” (solvent-free) electrostatic spray coating technology or electrostatic spray coating technology with a significantly reduced amount of solvents for the “dry” formation of battery electrodes from suitable materials. In some designs, a current collector foil is sprayed with suitable electrostatically charged particles of active material and optionally, other components that are often desirable, such as conductive additives and other functional additives (e.g., charged electrode mass powder). In some designs, the active material particles may additionally include a coating of a polymerizable binder precursor (or other binder component) on the surfaces of the active material particles prior to the deposition of the particles onto and/or into the current collector (or electrode foil). In some designs, the active material particles may additionally include conductive additives coated on or attached to the surfaces of active material particles prior to the deposition of the particles onto and/or into the current collector (or electrode foil). In some designs, the suitable electrode mass particles (including active material, binder precursor and other binder components, conductive and other additives, etc.) are fluidized prior to being deposited onto and/or into the current collector by the application of a voltage.

In some designs, the powder of electrode mass particles is first fluidized in a reservoir (e.g., by blowing air through it from a perforated base) and the fluidized powder is then blown along a feed pipe to a dispensing and charging gun (e.g., a triboelectric gun or a corona gun or a mixed triboelectric/corona gun, in some examples). In some examples, a fluidized powder is blown vigorously through a barrel of a triboelectric gun to maximize triboelectric charging, the fluidized powder emerges from the triboelectric gun in a charged state, and the fluidized powder is blown towards the current collector. In other examples, a corona gun charges particles of the electrode mass powder as they pass through a corona discharge in the gun's exit region. In a simple implementation, a gun may include a (e.g., cylindrical) barrel at the end thereof, at which there are one or more sharply pointed electrodes which are maintained at a high negative potential in a range of about 10 to about 200 kV. The high voltage gradient in the vicinity of the electrode tips sets up a stable corona discharge through which the emerging powder particles pass. As air flow blows the charged electrode mass powder from the gun towards the current collector, it is important to achieve a sufficiently long adhesion time of the electrode mass powder on the current collector. This adhesion time is regarded as being sufficiently long if there is enough time to transfer the electrode precursor to subsequent processing stations (e.g., a first processing station for carrying out polymerization by heat treatment or UV treatment or e-beam treatment, a second processing station for additional densification (compaction)) and carry out the additional processing stages at the respective processing stations. Accordingly, if the adhesion time is sufficiently long, it becomes possible to produce a smooth and dense electrode coating. In some designs, it may be advantageous to use an array of guns (e.g., from about 2 to about 2,000; in some designs, from about 2 to about 20; in other designs, from about 20 to about 200; in yet other designs, from about 200 to about 2000) instead of a single gun per current collector roll in order to achieve high electrode coating uniformity and speed.

All electrode mass powder coating guns may require a smooth delivery of fluidized powder and the powder fluidity is very important. In some designs, it may be advantageous to utilize vibration and stirring to enhance uniformity and fluidity of the fluidized electrode mass and avoid formation of channeling within the fluidized bed. In some designs, it may be advantageous to functionalize or coat the surface of the electrode mass particles (e.g., coat the surface of the particles with certain binders) to increase fluidization.

One of the benefits of electrostatic spray coating for the formation of electrodes (compared to, for example, regular spray coating) is the precise control over the coating uniformity and minimization of losses and contaminations (e.g., electrode particles being kicked back in the air). In some designs, it may be preferable for the current collector (and everything in the vicinity of the current collector) to be grounded to prevent static buildup and arcing. All conveyors, hangers, and rollers (including nearby pressure rollers) should preferably be cleaned thoroughly and frequently to ensure a good connection to ground and minimize potential of a severe shock.

After electrostatic spray deposition, the electrode typically needs to be densified (compacted or calendered) by using pressure rollers or another suitable technique. As in other “dry” electrode deposition techniques described herein (e.g., casting, extrusion), in some designs, it may be advantageous to apply dynamic compaction (including, but not limited to a pulse or a wave-like compaction or vibrational compaction, instead of constant force or gradually increasing force compaction) for “dry” electrode densification. A shock-wave compaction (e.g., with the duration of the pulse or the compression waves in a range from about 1 microsecond to about 5 seconds) may enable very rapid electrode consolidation, in some designs. In some designs, the vibrational frequency of wave-like compaction/densification may range from about 50 Hz to about 1 kHz. In some designs, the electrode particle sizes and the wavelength of vibrations may be of the same order of magnitude (thus vibrational frequency should increase for smaller particles). As previously described in greater detail elsewhere herein, the suitable maximum pressure applied during electrode densification may typically range from about 1 MPa (˜10 atm) to about 500 MPa (˜5,000 atm).

An aspect is directed to suitable properties of graphite particles that may be advantageously used in “dry” (solvent-free) electrode processing or electrode processing with a significantly reduced amount of solvents. In some designs, graphite particles with suitable properties may work effectively as solid lubricant(s) or as active material(s) (e.g., within the anode) that also function as solid lubricant(s). Such graphite particles may enhance various properties (e.g., volumetric capacity, rate performance, stability, etc.) of electrodes produced using “dry” processing techniques (or processing techniques with a significantly reduced amount of solvents) (in some designs, when used in an electrode mass during electrode fabrication by extrusion processes (in some designs, followed by densification or calendering); in other designs, when used in an electrode mass during electrode fabrication by casting followed by densification or calendering; in yet other designs, when used during electrode fabrication by spraying or electro-spraying, followed by densification or calendering). In contrast to wet electrode fabrication (where solvent helps to distribute binder and conductive additives uniformly, which may also simplify uniform densification process), “dry” electrode processing (or electrode processing with a significantly reduced amount of solvents) may benefit particularly strongly from, for example, specific graphite “softness” range, its lubricating properties, its specific physical properties, its specific microstructure and structural (microstructural) features to enable high-performance, dense electrodes.

In some designs, it may be advantageous for the suitable graphite to constitute from about 0.1 wt. % to about 95.1 wt. % of the total weight of the electrode (including active material particles, conductive and other functional additives, binder, surfactant, etc., but not counting the weight of the current collector or tabs)—in some designs, from about 0.1 wt. % to about 10 wt. %; in other designs, from about 10 wt. % to about 25 wt. %; in yet other designs, from about 25 wt. % to about 95.1 wt. %. In case of “dry” (solvent-free) electrode processing (or electrode processing with a significantly reduced amount of solvents) of anodes for use in Li-ion batteries, the other components of electrodes may include, but not limited to various Si-comprising particles (e.g., nanocomposite silicon, silicon-carbon composite, silicon-graphite composite, silicon oxide including carbon-coated silicon oxide, silicon oxide-carbon composite; silicon nitride-carbon composite, silicon oxynitride-carbon composites, etc.), other graphite particles, metal oxide particles, among others.

In one or more embodiments of the present disclosure, graphite (e.g., broadly-carbon) that exhibits a relatively low hardness may be one of the key characteristics to provide superior performance as a component of “dry” electrodes (solvent-free) or electrodes processed with a significantly reduced amount of solvents.

In order to test graphite (carbon) powder sample hardness, graphite (carbon) particles arranged as a dry powder were placed onto a hardened steel disk and distributed as evenly as possible in small quantities with the particles spread out as much as possible so that individual particles are discernible directly on the hardened steel surface. The hardened steel disk with the spread-out graphite particles was then added to a Shimadzu MCT Micro Compression Testing tool. The hardened steel disk was placed on a platform that could move between an optical microscope and a compressor tip. The optical microscope from the tool was used to find individual particles from the graphite samples. Once an individual graphite particle was found, the platform was switched to the compressor tip and the hardness test was conducted with indenting (crushing) of the individual graphite particle while measuring both the force and displacement to calculate the pressure (abbreviated as Cx, expressed in MPa) required to deform the graphite particle by 10% (linear dimensions). At least ten graphite particles were measured for each sample and the average Cx was calculated.

It was found that Cx values in the range from about 1 MPa to about 30 MPa made graphite samples more suitable for use in “dry”-electrode processing (solvent-free) or electrode processing with a significantly reduced amount of solvents. In some designs, it may be preferable for such graphite (or at least majority, about 50 wt. % or more of such graphite) to exhibit average Cx values of less than around 30 MPa; in other designs, it may be more preferable for such graphite (or at least majority, about 50 wt. % or more of such graphite) to exhibit average Cx values of less than around 25 MPa; in other designs, it may be more preferable for such graphite (or at least majority, about 50 wt. % or more of such graphite) to exhibit average Cx values of less than around 20 MPa; in other designs, it may be more preferable for such graphite (or at least majority, about 50 wt. % or more of such graphite) to exhibit average Cx values of less than around 15 MPa; in other designs, it may be more preferable for such graphite (or at least majority, about 50 wt. % or more of such graphite) to exhibit average Cx values of less than around 11 MPa; in other designs, it may be more preferable for such graphite (or at least majority, about 50 wt. % or more of such graphite) to exhibit average Cx values of less than around 10 MPa; in other designs, it may be more preferable for such graphite (or at least majority, about 50 wt. % or more of such graphite) to exhibit average Cx values of less than around 9 MPa; in other designs, it may be more preferable for the GRSBA (or at least majority, about 50 wt. % or more of such graphite) to exhibit average Cx values of less than around 8 MPa; in other designs, it may be more preferable for such graphite (or at least majority, about 50 wt. % or more of such graphite) to exhibit average Cx values of less than around 7 MPa; in other designs, it may be more preferable for such graphite (or at least majority, about 50 wt. % or more of such graphite) to exhibit average Cx values of less than around 6 MPa. In some designs, it may be preferable for the majority of such graphite (e.g., about 50-60 wt. % or about 60-70 wt. % or about 70-80 wt. % or about 80-100 wt. %) in the “dry”-processed anodes to exhibit average Cx values in the range from about 1 MPa to about 18 MPa (e.g., from about 1 MPa to about 7 MPa or from about 7 MPa to about 10 MPa or from about 10 MPa to about 14 MPa or from about 14 MPa to about 18 MPa). Note that in some designs soft graphite that are too soft (e.g., with average Cx values of less than 1 MPa) may lead to electrode (particularly anode) degradation or inferior rate performance, while too hard graphites (e.g., with average Cx value of more than about 30 MPa; in some designs, of more than about 25 MPa) may not allow sufficient or desirable performance characteristics.

In one or more embodiments of the present disclosure, the tap density of graphite particles may be another one of the key characteristics to provide superior performance as a component of “dry” electrodes.

For the tap density measurements disclosed herein, graphite (carbon) particles arranged as a dry powder were added into a graduated cylinder, which was then loaded into the TDI Tap Density Tester tool and initially tapped 10 times. The initial volume [mL] was then determined and documented. Depending on the sample size, the cylinder was further “tapped” a different number of times. For example, the filled 25 mL cylinder, which was commonly suitable for approximately 10 g samples, was tapped 6,000 times. A 100 mL (which was commonly suitable for approximately 50 g samples) filled cylinder was tapped 12,000 times. After the “tapping” was finished, the final volume was measured and the mass added and volume observed was used in tap density calculation (mass/volume), as known in the art.

In some designs, suitable tap density values of graphite particles used in “dry” (solvent-free) processed electrodes or electrodes processed with a significantly reduced amount of solvents may typically range from about 0.100 g/ml (or g/cc) to about 1.250 g/ml (or g/cc) (e.g., in some designs, from about 0.100 g/ml to about 0.250 g/ml; in other designs, from about 0.250 g/ml to about 0.600 g/ml; in other designs, from about 0.600 g/ml to about 0.900 g/ml; in other designs, from about 0.900 g/ml to about 1.100 g/ml; in yet other designs, from about 1.100 g/ml to about 1.250 g/ml). However, in some designs, too high density (e.g., in some designs, in excess of about 1.250 g/ml; in other designs, in excess of about 1.100 g/ml) may undesirably reduce performance of Li-ion battery cells with blended anodes. In some designs, too low density (e.g., in some designs, below about 0.050 g/ml; in other designs, below about 0.100 g/ml), as, for example, in some expanded graphites may also induce undesirable effects, including, in some cases, lower volumetric capacity performance. In some designs, graphite (carbon) samples with tap density values from about 0.900 g/ml to about 1.100 g/ml (e.g., in some designs, from about 0.900 g/ml to about 0.950 g/ml; in other designs, from about 0.950 g/ml to about 1.000 g/ml; in other designs, from about 0.950 g/ml to about 1.050 g/ml; in yet other designs, from about 1.050 g/ml to about 1.100 g/ml) were often found to work particularly well as components of electrodes produced via “dry” (substantially free of conventional solvents) electrode processing or electrode processing with a significantly reduced amount of solvents.

In one or more embodiments of the present disclosure, pycnometry density (as measured by using a nitrogen gas (N₂) pycnometer) of graphite particles may be another one of the key characteristics to provide superior performance as components of electrodes produced via “dry” electrode processing (i.e., processing substantially free of conventional solvents) or electrode processing with a significantly reduced amount of solvents.

For the pycnometry density measurements described herein, a Micromeritics AccuPyc II 1340 Pycnometer with a 1 cc chamber was used. To prepare the sample, a vial of sample powder was vortexed for 15 seconds and was allowed to sit for a few minutes before use. Using an electronic balance, 195 mg-200 mg of sample powder was weighed out in a designated cup from the instrument for pycnometry density measurements.

In some designs, suitable tap density values of graphite component of “dry” electrodes (i.e., electrodes made by processes substantially free of conventional solvents) may typically range from about 2.150 g/ml (or g/cc) to about 2.350 g/ml (g/cc) (e.g., in some designs, from about 2.150 g/ml to about 2.200 g/ml; in other designs, from about 2.200 g/ml to about 2.250 g/ml; in other designs, from about 2.250 g/ml to about 2.275 g/ml; in other designs, from about 2.275 g/ml to about 2.300 g/ml; in other designs, from about 2.300 g/ml to about 2.325 g/ml; in other designs, from about 2.325 g/ml to about 2.350 g/ml). Note that in some designs the theoretical density of crystallographically perfect graphite at room temperature and atmospheric pressure is around 2.265 g/ml (g/cc). Too low pycnometry-measured density (e.g., below about 2.150 g/ml or g/cc) may lead to excessive losses during the first or subsequent cycles or other undesirable cell performance characteristics, in some designs. Too high pycnometry-measured density may also reduce cell performance characteristics or induce challenges during the slurry and electrode preparations, in some designs, and may indicate the presence of small micropores.

For the particle size analysis disclosed herein, samples were prepared within 1 hour of analysis on the Malvern Mastersizer 3000 laser PSA (particle size distribution analysis) instrument. The original sample vial was vortexed for 15 seconds to ensure powder homogeneity. Approximately 20.0 mg (+5.0 mg) of thoroughly mixed sample was weighed and transferred into a 20 mL glass vial. Once the sample was transferred to the vial, 15-20 mL of a 20 g/L lecithin in ISOPAR G solution (the dispersant) was added to the glass vial. To break down agglomerated particles that may be present in some samples, the samples were also sonicated for 30 minutes. The sample vial containing powder, lecithin, and ISOPAR G was then vortexed using the maximum setting on the vortexer for 15 seconds. Once the samples were prepared, the samples were analyzed using the Malvern Mastersizer 3000 laser PSA instrument.

In one or more embodiments of the present disclosure, the size distribution of the graphite particles may also affect their performance for use as components of “dry” (solvent-free) processed electrode or electrodes processed with a significantly reduced amount of solvents. In some designs, both particles that are too large and particles that are too small may reduce performance of Li-ion battery cells with blended anodes. Excessively large particles, for example, may induce local non-uniformities in both the distribution of mechanical properties of the anodes and their areal capacities. Excessively small particles, for example, may increase anode tortuosity (e.g., for the same anode density) thus affecting Li-ion battery charging rate performance and power capabilities (e.g., for the fixed areal capacity loadings), require the use of large binder fraction or reduce anode packing and volumetric capacity, in some designs. The total mass fraction of such graphite particles, areal capacity loadings, the size of active material particles, the desired cell characteristics, and/or other factors, however, may affect the most desirable size distribution of the suitable graphite (carbon). In some (e.g., most) designs, however, the suitable D₅₀ values of the suitable graphite may range from about 0.025 μm to about 10 μm (in some designs, from about 0.025 μm to about 0.2 μm; in other designs, from about 0.2 μm to about 1 μm; in other designs, from about 1 μm to about 2 μm; in other designs, from about 2 μm to about 5 μm; in yet other designs, from about 5 μm to about 10 μm). In some (e.g., most) designs, the suitable Doo values of the suitable graphite (carbon) may range from about 0.1 μm to about 15 μm (in some designs, from about 0.1 μm to about 0.5 μm; in other designs, from about 0.5 μm to about 2 μm; in other designs, from about 2 μm to about 5 μm; in other designs, from about 5 μm to about 15 μm). In some (e.g., most) designs, the suitable D₁₀ values of the graphite particles may range from about 0.005 μm to about 2 μm (in some designs, from about 0.005 μm to about 0.05 μm; in other designs, from about 0.05 μm to about 0.5 μm; in other designs, from about 0.5 μm to about 2 μm).

In one or more embodiments of the present disclosure, the BET SSA of the graphite particles may also affect their performance for use in “dry” (“solvent-free”) processed electrodes or electrodes processed with a significantly reduced amount of solvents. In some designs, both too high BET SSA and too low BET SSA may reduce performance of Li-ion battery cells. The most optimal BET SSA value, however, may depend on various factors, including the desired cell characteristics for particular applications. In some (e.g., most) designs, however, the suitable BET SSA values of the graphite may range from about 0.5 m²/g to about 1000 m²/g (in some designs, from about 0.5 m²/g to about 10 m²/g; in other designs, from about 10 m²/g to about 20 m²/g; in other designs, from about 20 m²/g to about 30 m²/g; in other designs, from about 30 m²/g to about 50 m²/g; in other designs, from about 50 m²/g to about 100 m²/g; in other designs, from about 100 m²/g to about 200 m²/g; in other designs, from about 200 m²/g to about 500 m²/g; in yet other designs, from about 500 m²/g to about 1000 m²/g). In some designs, however, (e.g., when long calendar or long cycle life is important or when lower fraction of polymer binder may be advantageous, etc.) lower BET SSA value and more narrow range of BET SSA values may be advantageous (e.g., from about 0.5 m²/g to about 250 m²/g; in some designs, from about 1 m²/g to about 100 m²/g; in yet some designs, from about 2 m²/g to about 30 m²/g).

The microstructural features of the graphite (carbon) samples may also affect their performance for use in “dry”-processed (solvent-free) electrodes or electrodes processed with significantly reduced amount of solvents. Some of such features may be revealed by X-ray diffraction (XRD) techniques, by Raman spectroscopy and/or other characterization techniques.

For the microstructural feature analysis disclosed herein, graphite (carbon) particles arranged as a powder were prepared for powder XRD using standard material preparation practices. Aluminum sample holders were used with 1 mm glass slides placed in the bottom of the sample well to prevent measurement contribution from the metallic sample holder. Approximately 100-300 mg of each powder was added to the sample holder and smoothed using a glass slide such that a uniform sample surface resulted. A Rigaku Smartlab was used for all measurements utilizing a copper X-Ray source, (λ=1.5406 Å). The Cu anode was operated at a tube voltage and current of 40 kV and 44 mA, respectively. All measurements were performed using Bragg-Brentano measurement geometries between 10 and 90 degrees 2θ, at a continuous scan rate of 1 degree per minute. An incident limiting slit of 10 degrees was used in addition to 5.0 degree Soller slits for both incident and detector. Copper K-beta (K_{β}) radiation was directly filtered through the use of a Ni filter prior to reaching a 1D silicon strip detector. Full width at half maximum (FWHM) values for the graphite (002) reflection peaks were calculated by fitting the respective peak with a Gaussian-Lorentzian cross product function defined as follows:

$$y = {y}_{0} + \frac{A}{1 + \frac{{e}^{\frac{0.5 ( 1 - s ) {( x - {x}_{c} )}^{2}}{{w}^{2}}} {s ( x - {x}_{c} )}^{2}}{{w}^{2}}} \qquad ( Formula 1 )$$

where y₀ is defined as the functions base, xₑ is the peak center, A is the peak amplitude, w is the peak width, and s is a parameter defining the peak shape. Scherrer crystallite size was calculated directly from the fit data for each graphite (carbon) sample based on the known Scherrer formula:

$$D = \frac{K λ}{β cos θ} \qquad ( Formula 2 )$$

where D is the calculated crystallite size, K is a shape factor set to 0.7, λ is the X-Ray wavelength (1.5406 Å), B is the FWHM of the peak at the Bragg angle, and θ is the Bragg angle which was calculated from the 2θ position of the (002) reflection peak.

Both too narrow and too wide FWHM of the (002) graphite reflection peak, and, correspondingly, both too large and too small average crystallite sizes estimated using Scherrer formula for (002) reflection peaks may reduce performance of Li-ion battery cells with blended anodes, in some designs. In some designs, however, the optimal values for particular applications may depend on the fraction of the graphite (carbon), properties of all active material particles, areal capacity loadings, binder amount and type, the desired cell performance characteristics, and/or other factors. However, in some (e.g., most) designs, the suitable FWHM for (002) graphite reflection peak (as measured using the employed analytical procedure and setup) may preferably range from about 0.220 degrees to about 5.620 degrees (in some designs, from about 0.220 degrees to about 0.250 degrees; in other designs, from about 0.250 degrees to about 0.300 degrees; in other designs, from about 0.300 degrees to about 0.340 degrees; in other designs, from about 0.340 degrees to about 0.500 degrees; in other designs, from about 0.500 degrees to about 0.600 degrees; in other designs, from about 0.600 degrees to about 1.220 degrees; in other designs, from about 1.220 degrees to about 5.620 degrees). Also, in some (e.g., most) designs, the suitable for the graphite average crystallite sizes estimated using Scherrer formula for (002) reflection peaks (as measured using the employed analytical procedure and setup) may preferably range from about 1 nm to about 40 nm (in some designs, from about 1 nm to about 5 nm; in other designs, from about 5 nm to about 10 nm; in other designs, from about 10 nm to about 15 nm; in other designs, from about 15 nm to about 21 nm; in other designs, from about 15 nm to about 30 nm; in other designs, from about 21 nm to about 26 nm; in other designs, from about 26 nm to about 29 nm; in other designs, from about 29 nm to about 40 nm).

For the Raman analysis described herein, graphite (carbon) particles arranged as a dry powder were prepared for Raman scattering experiments using standard material preparation practices. The graphite (carbon) powder sample was collected and placed in a glass microscope slide with a spatula. The powder was then pressed into the tape on the glass slide firmly to transfer a sufficiently thick layer of the powder from spatula to the top of the tape. This process was repeated until the powder fully coated the tape. Once the tape was fully coated by the powder, a hand-held air pump was used to blow residual powder from the tape. Once the residual powder was blown from the tape, the sample was ready for Raman analysis. A Renishaw In-Via Qontor Raman Microscope was used to analyze the samples using a 532 nm laser diode with a maximum laser power of 3 mW. A laser beam was focused on the sample using a 100×1.2 numerical aperture (NA) objective. The laser beam was purposefully aimed at the center of large particles, unless noted otherwise. Renishaw 1800 diffraction grating was used to record the spectrum with 3 sec acquisition time, 10 spectra were averaged (per sample) to increase signal to noise ratio. The following graphite (carbon) peaks were selected in the spectra: D peak (1200-1500 cm⁻¹), G peak (1500-1750 cm⁻¹), 2D₁ peak (2600-2800 cm⁻¹), and 2D₂ peak (2400-3700 cm⁻¹). For D/G ratio, the height of the D peak in D peak range (1200-1500 cm⁻¹) was divided by height of the G peak in G peak range (1500-1750 cm⁻¹) after linear background subtraction in the spectra in the 1000-2000 cm⁻¹ range. For 2D₁/G ratio, the height of the 2D₁ peak in the 2D₁ peak range (2600-2800 cm⁻¹) was divided by the height of the G peak in G peak range (1500-1750 cm⁻¹). Peak height was calculated after linear background subtraction for each peak in the 1000-2000 cm⁻¹ range for G peak and in the 2000-4000 cm⁻¹ range for 2D₁ peak. FWHM values were calculated using Scipy (scientific Python) peak quantification function scipy.signal.peak_widths with peak width measured at 0.5 of the relative height.

The value of the FWHM of D, G and 2D₁ bands as well as the D/G and 2D₁/G intensity ratios of graphite (carbon) samples may correlate with the performance of Li-ion battery cells with electrodes that are “dry” (solvent-free) processed or processed with a significantly reduced amount of solvents, in some designs. In some designs, however, the optimal values for particular applications may depend on the fraction of the graphite in the described “dry” (solvent-free) processed electrodes or electrodes processed with a significantly reduced amount of solvents, properties of all the active material particles, areal capacity loadings, binder amount and type, the desired cell performance characteristics, and/or other factors. However, in some (e.g., most) designs, the suitable FWHM of D bands for suitable graphite (carbon) (as determined using the described methodology) may typically range from about 30 cm⁻¹ to about 90 cm⁻¹ (in some designs, from about 30 cm⁻¹ to about 40 cm⁻¹; in other designs, from about 40 cm⁻¹ to about 60 cm⁻¹; in other designs, from about 60 cm⁻¹ to about 70 cm⁻¹; in yet other designs, from about 70 cm⁻¹ to about 90 cm⁻¹). In some (e.g., most) designs, the suitable FWHM of G bands for graphite (as determined using the described methodology) may typically range from about 5 cm⁻¹ to about 105 cm⁻¹ (in some designs, from about 5 cm⁻¹ to about 15 cm⁻¹; in other designs, from about 15 cm⁻¹ to about 30 cm⁻¹; in other designs, from about 15 cm⁻¹ to about 18 cm⁻¹; in other designs, from about 18 cm⁻¹ to about 22 cm⁻¹; in other designs, from about 22 cm⁻¹ to about 30 cm⁻¹; in other designs, from about 30 cm⁻¹ to about 50 cm⁻¹; in yet other designs, from about 50 cm⁻¹ to about 105 cm⁻¹). In some (e.g., most) designs, the suitable FWHM of 2D₁ bands for graphite (as determined using the described methodology) may typically range from about 30 cm⁻¹ to about 110 cm⁻¹ (in some designs, from about 30 cm⁻¹ to about 50 cm⁻¹; in other designs, from about 50 cm⁻¹ to about 65 cm-1; in other designs, from about 65 cm⁻¹ to about 80 cm⁻¹; in yet other designs, from about 80 cm⁻¹ to about 105 cm⁻¹; in yet other designs, from about 105 cm⁻¹ to about 110 cm⁻¹). In some (e.g., most) designs, the suitable D/G peak intensity ratios for suitable graphite (or carbon) (as determined using the described methodology) may typically range from about 0.02 to about 1.12 (in some designs, from about 0.02 to about 0.12; in other designs, from about 0.12 to about 0.30; in other designs, from about 0.30 to about 0.50; in other designs, from about 0.50 to about 0.80; in yet other designs, from about 0.80 to about 1.12). In some (e.g., most) designs, the suitable 2D₁/G ratio for suitable graphite (or carbon) (as determined using the described methodology) may typically range from about 0.10 to about 0.90 (in some designs, from about 0.10 to about 0.35; in other designs, from about 0.35 to about 0.50; in other designs, from about 0.41 to about 0.55; in other designs, from about 0.41 to about 0.45; in other designs, from about 0.45 to about 0.50; in other designs, from about 0.50 to about 0.55; in other designs, from about 0.50 to about 0.60; in other designs, from about 0.30 to about 0.65; in other designs, from about 0.60 to about 0.75; in yet other designs, from about 0.75 to about 0.90).

An aspect is directed to the advantageous use of active material particles pre-coated with (1) a binder (or a binder precursor or other binder component) or (2) a combination of a binder (or a binder precursor or other binder component) and conductive additives, in “dry” electrode processing technologies. Herein, for brevity, the foregoing pre-coatings of types (1) and (2) are referred to collectively as “polymer binder coatings.” The conventional solvent-based slurry processing in electrode fabrication enables relatively uniform distribution of the binder within the electrode. In contrast, such uniformity largely remains a challenge in “dry” electrode processing due to agglomeration of particles. In addition to better uniformity, the polymer binder coatings on active material particles may enable better tribological properties, thus reducing stresses and defects and thus improving electrode quality and uniformity (e.g., by minimizing micro-cracks and defects, while maximizing volumetric capacity). In some designs, the binder, binder precursor, or other binder component may be chemically attached to the surface of active material particles. In some designs, the polymer binder coating on the surface of active material particles may be electrically and/or ionically conductive (e.g., when swollen in the electrolyte). In some designs, the polymer binder coating attached to the surface of active material particles may comprise electrically conductive additives (e.g., carbon nanoparticles, carbon nanotubes, carbon nanoflakes (e.g., defective graphene), conductive metal carbide flakes, conductive metal oxide nanoparticles, conductive metal oxide nanowires or nanofibers, conductive metal oxide flakes, conductive metal nanowires, conductive polymer nanowires or nanoflakes, etc.) to enhance particle-to-particle electrical contact. In some designs, such conductive additives may also enhance mechanical or tribological (lubricating) properties of the pre-coated active material particles. In some designs, the polymer binder coating may enhance tribological properties of the electrode mass. In some designs, the polymer binder coating may enhance mechanical properties of the final electrode. In some designs, the polymer binder coating may control the charge on the surface of the electrode particles or provide other advantages. In some designs, particles pre-coated with a polymer binder coating are more stable against aggregation and agglomeration because of the large decrease in their surface energy compared to the bare (e.g., inorganic active material or additive) particles. In some designs, the polymer binder coating of the particle surface may partially coat the particle surface, while in other designs the polymer binder coating may cover nearly the entire particle surface. Suitable average thickness of the polymer binder coating layer may typically range from about 0.10 nm to about 50 nm (in some designs, from about 0.10 nm to about 1 nm; in other designs, from about 1 nm to about 5 nm; in other designs, from about 5 nm to about 15 nm; in yet other designs, from about 15 nm to about 50 nm).

Several suitable processes can be utilized for the formation of a polymer binder coating (the so-called pre-coating) on active material particles and/or functional additive particles.

In some designs, particles may be first dispersed in a polymer binder solution and then the binder may be precipitated on the particle surface by the addition of a non-solvent. In other designs, particles may be dispersed in a material (e.g., a solution) comprising a polymerizable binder precursor (e.g., liquid monomers, liquid oligomers, liquid polymers, or combinations thereof) followed by heterogeneous (e.g., on particle surface) polymerization. In some designs, grafting polymers to the particle surface may be performed by generation of active polymeric species (radicals or cations/anions) in a suspension of the particles (e.g., in an organic solvent or in aqueous solution, when possible). In some designs, a polymerizable binder precursor (e.g., monomers, oligomers, polymers) may be spray-coated onto and/or into the particle under constant stirring. Conversion to a polymer binder coating may be realized by using ready-made polymers (in the case of radical initiation) or in-situ polymerization of monomers or oligomers in various types of initiation.

In some designs, a so-called “grafting from” approach may be effectively utilized for the formation of polymer binder coatings on the particle surface. Efficiency of the “grafting from” approach is higher than that of “grafting to” one. This “grafting from” method involves the growth of polymers from a surface-bound initiating moiety on the surface of (e.g., active electrode material) particles. This results in the formation of high-density polymer brushes where the distance between anchor points (grafting density) can be smaller than the radius of gyration of a free polymer. The attachment of initiators to surfaces results in a heterogeneous initiating system. In this case, the kinetics of initiation can be different from those of a free polymer. This has important consequences for the final properties of the polymer binder coatings on the particle surfaces. In some designs, controlled radical polymerization techniques, such as stable nitroxide-mediated radical polymerization (NMRT), atom transfer radical polymerization (ATRP), reversible addition fragmentation chain-transfer (RAFT) polymerization, ring-opening metathesis polymerization (ROMP), and/or living anionic/cationic polymerization may be effectively utilized for “grafting from” approach. Controlled “living” radical polymerization approach may be a particularly versatile and robust method to prepare well-defined organic polymers with pre-programmed size, composition, and architecture. The difference between conventional radical and controlled radical polymerizations is the lifetime of the propagating radical during the polymerization reaction. In conventional radical processes, radicals generated by decomposition of the initiator or in other ways undergo propagation and bimolecular termination reactions within a second. In contrast, the lifetime of a growing (living) radical polymerization may be tuned to exceed several hours.

In some designs, it may be advantageous to attach the initiators to the surface of the electrode particles. For example, the ATRP initiators may be first attached to the particle surface. Such initiators are particularly effective in the polymerization of various acrylate monomers (including, but not limited to the formation of methyl methacrylate (MMA), tert-butyl acrylate, etc.). In some designs, enzyme(s) may be attached to the surface of the particles (in some designs, by acylation of the particle surface followed by amidation). In some designs, poly(methyl methacrylate) (PMMA), poly(n-butyl acrylate) (PBA), and polystyrene (PS) brushes may be attached to the surface of particles by ATRP of the corresponding vinyl monomers (in some designs, especially for anode particles or additive particles, the particle surface may be modified by electrochemical reduction; for example, by brominated acryl diazonium or other suitable salts; sometimes in the presence of a suitable catalyst; in some designs, a sacrificial ATRP initiator (e.g., 1-phenylethyl bromide, etc.) may be added).

In some designs, surface initiated ATRP may be performed from halogen-terminated surfaces (e.g., Cl or Br), which may enable formation of functional polymer brushes (e.g., poly(2-hydroxyethyl methacrylate), poly((2-dimethylamino)ethyl methacrylate, etc.).

In some designs, peptides-comprising component(s) of adhesive proteins (e.g., containing 3,4-dihydroxyphenylalanine, DOPA) may be conjugated to monomethoxy-terminated PEG polymers and so the reaction of —OH groups on the particle surface (e.g., on the surface of a metal oxide) with the —OH groups on the end of the mPEG-DOPA may result in the depletion of the OH groups and the formation of covalent bonding. In some designs, mini-emulsion polymerization may be used for the formation of polymer surface layer (e.g., by using sodium lauryl sulfate surfactant and hexadecane co-stabilizer in the presence of particles comprising an oxide (or oxide on their surface) coated with 3-(trimethoxysilyl)propyl methacrylate). The hydroxyl group-coated particles may be effectively coated by using polymer grafting by radical copolymerization (e.g., of styrene) in the presence of a coupling agent (e.g., (3-(trimethoxysilyl)propyl methacrylate) for styrene). Co-polymerization of styrene monomers with the methacrylate group of MPS may also be effective in some designs.

In some designs, to stabilize particle suspension in a polymer binder solution or in a polymerizable binder precursor (e.g., liquid monomer, liquid oligomer) it may be advantageous to employ static stabilization (surface charge repelling the particles). The magnitude of the repulsion may depend on the surface potential (or zeta potential) and the electrolyte concentration and valence. In some designs, to stabilize particle suspension in a polymer binder solution or in a polymerizable binder precursor (e.g., liquid monomer, liquid oligomer), it may be advantageous to employ steric stabilization. For example, to stabilize particle suspension in a polymer binder solution or in a polymerizable binder precursor (e.g., liquid monomer, liquid oligomer) it may be advantageous to employ polymeric surfactants (e.g., non-ionic, which may tolerate high electrolyte concentrations), where surface-active polymers adsorb very strongly on the particle surface. The high absorption energy is often attributed to the large value of the integral van der Waals interaction between the surface and the numerous repeating monomer units of the polymer chain. The total adsorption energy per must compensate for the configurational entropy loss of the adsorbed polymer. In some other designs, a homopolymer may also adsorb at the solid surface by a specific interaction (e.g. hydrogen bonding, as, for example, adsorption of poly(ethylene oxide) (PEO) or poly(vinylpyrrolidone) (PVP), on ceramic (e.g., oxide or Si or C surfaces). Since no ionic charges may be involved, these polymer surfactants can also be used in the presence of high electrolyte concentrations and at high temperatures. This mechanism is usually referred to as steric stabilization. In some designs, the polymeric surfactants may be designed or selected to have a strong “anchor” chain and a stabilizing chain that extends from the surface typically producing 1-5 nm layer that may prevent compression (e.g., if the solvation energy is high) and thus minimize particle agglomeration. In some designs, instead of homopolymers, it may be advantageous to use copolymers as dispersants. Illustrative examples of suitable copolymers include, but are not limited to: PEO-PPO-PEO (with different chain lengths of the blocks; the hydrophobic PPO chain may anchor to the hydrophobic surface, leaving the two PEO chains dangling in an aqueous solution and providing a steric stabilization); various other diblock and triblock copolymers, such as of polystyrene (PS)-poly(vinyl alcohol) (PVA) and PS-PEO, triblocks of poly(methyl methacrylate) (PMMA)-PEO-PMMA and PEO-PS-PEO, comb-like copolymers comprising PMMA or PS; “Inulin” based on a natural polysaccharide, in which alkyl groups randomly distributed on the sugar backbone and attached to primary hydroxyl functions, as well as to the secondary ones, are strongly adsorbed on hydrophobic solids, such as carbon black or PS, where the water-soluble backbone sugar chain serves to stabilize the polymer moiety, among many others.

In some designs, it may be advantageous to use polyelectrolyte as a polymeric surfactant, since both steric and electrostatic stabilizing effects are combined in one molecule (illustrative examples include, but are not limited to partially sulfonated PS, polybutadiene and polyisoprene, or block copolymers of the corresponding repeat units, like polybutadiene-b polyoxyethylene, to name a few).

In some designs, it may be advantageous to use the reactive polymeric surfactants, which combine traditional non-covalent and covalent interactions with the particles by introducing a definite functional reactive group in the surfactant molecule. Illustrative examples of such reactive polymeric surfactants include, but not limited to: (i) non-ionics, such as vinyl polyalkylene glycol ether, dodecyl polyethylene oxide maleate, alkenyl carboxy functional hydrophobe, polyalkylene glycol methacrylate, methoxy polyalkylene glycol methacrylate, among others; (ii) ionics, such as allyl-alkyl sulfate, hexadecyl maleic hemiester, methacryloyloxyethyl maleate, methacryloyloxyethyl succinate, among others.

In some designs, some relatively exotic molecules may be used as very effective surfactants. For example, in some designs, (e.g., when particles comprise carbon coating on the surface or made of carbon, etc.), DNA (either single-stranded and double-stranded) may be effectively used as a surfactant (possibly due to pi-pi interactions between aromatic bases of DNA and the carbon surfaces). In other designs, amphiphilic peptides consisting of a short hydrophobic alkyl tail coupled to a more hydrophilic peptide sequence may be effectively used as surfactants. Conjugated polymers also exhibit strong π-π interactions and may be effectively used as well. Illustrative examples may include, but are not limited to poly [2-methoxy-5-(2-ethyl-hexyloxy)-p-phenylenevinylene] (MEH-PPV), poly(m-phenylenevinylene-co-2,5-dioctoxy-p-phenylene vinylene) (PmPV), poly{(2,6-pyridinylene-vinylene)-co-[(2,5-dioctyloxy-p-phenylene)vinylene]} (PPyPV), to name a few.

In some designs, polymerization of conductive polymers on the surface of active material particles may be effectively employed. For example, poly(phenylacetylene) (PPA) or polypyrrole (PPy) or polyaniline (PANI) or other conductive polymers may be deposited on the particle surface by (e.g., catalytic) polymerization of monomers or oligomers in the presence of the particles.

Note that various surfactants utilized in the described particle pre-coatings by a binder, a binder precursor, or other binder components or used during electrode mass processing may effectively become components of the fully prepared “dry” processed electrodes and finally fully assembled batteries. As such, these need to be selected to be compatible with the battery electrolytes used and be sufficiently stable to prevent excessive undesirable side reactions during the battery operation.

In some designs, polymers (or polymer solution) may be spray-coated on the particle surface under constant stirring of the particles. Such a method may also be applicable to polymerizable binder precursors in the form of liquid or meltable monomers or oligomers, which may be relatively easy to spray-coat without the aid of any solvents. These coated monomers or oligomers may be subsequently polymerized in order to form uniformly coated particles using suitable solid-state polymerization techniques such as heat treatment, UV treatment, and e-beam treatment.

An aspect is directed to the advantageous use of functionalized active material (or other conductive or functional) particles in electrode processing that is “dry” (solvent-free) or with a significantly reduced amount of solvents. Functionalized particles may attain more uniform polymer binder coverage and provide other benefits including tribological properties. In some designs, the active particle surface (anode and cathode) may be selectively modified to afford modified particles functionalized with suitable functional groups, such as hydroxy (OH), carboxylic acid (COOH), and others. In some designs, Diels-Alder type reaction may be advantageously used to deposit functional monomers (e.g., maleic anhydride) on a particle surface containing carbon-carbon double bonds, which may be hydrolyzed to afford COOH groups. In some design, diazonium coupling reaction may be suitable to functionalize the particle surface to have desired functional groups other than OH and COOH, such as, for example, amino (NH₂), thiol (SH), aromatic groups (e.g., phenyl, naphthyl), ester (COOR, where R is methyl, ethyl, propyl, isopropyl, tolyl), azide, isocyanate, nitrile, etc. These surface modifications may further facilitate grafting of polymers and/or monomers/oligomers through specific chemical interaction (H-bond or covalent bonds). This may ensure that the polymer binder coatings are strong and binder polymers are permanently attached to the particle surface.

In some designs, it may be beneficial to have two or more different layers of polymers in the polymer binder coating on the particle surfaces. The inner layer adjacent to the particle surface may be designed to strongly adhere to the particle surface through one or more types of strong covalent bonds. In contrast, the outer layer (e.g., adjacent to and outside of the inner layer) may be designed to interface the bulk binder and (or) electrolyte. In some designs, the inner layer may swell less and the outer layer may swell more in the presence of electrolyte to facilitate ion-conduction through the polymer binder coating.

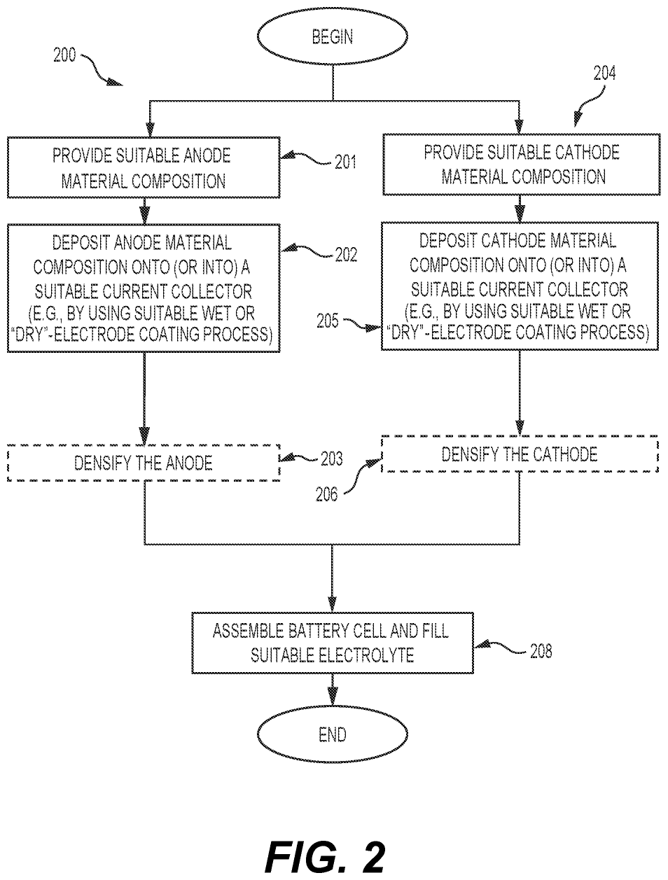

FIG. 2 illustrates an example method (200) for the formation of a Li-ion battery using “dry” processing of electrode(s). While in this illustrative example both electrodes may be produced by “dry” processing, it should be understood that only one of the electrodes (e.g., either anode or cathode) may be processed by such a method and the other electrode (e.g., either cathode or anode) may be processed by conventional wet slurry-based coating technology. Example method 200 includes a left branch relating to anode fabrication including stages 201, 202, and 203 and a right branch relating to cathode fabrication including stages 204, 205, and 206. The left and right branches may be carried out concurrently. In addition, method 200 also includes stage 208, after the production of the anode and the cathode. This example method (200) includes: (i) providing a suitable anode material composition (in the case of “dry” processing according to some embodiments, this composition may be referred to as a battery electrode (e.g., anode) precursor composition, comprising suitable components, e.g., graphite active materials, silicon oxide or silicon-comprising active materials (including composites or nanocomposites), metal oxide and other active anode materials, conductive additives, other functional additives, polymerizable binder precursor compounds, etc., but may be substantially free of conventional solvents)—(stage 201); (ii) depositing the anode material composition onto (or into) a suitable anode current collector by suitable solvent-free deposition process to form an anode precursor disposed on and/or in the anode current collector (e.g., by using a suitable “dry” electrode coating process) and transforming the anode precursor to form the anode (e.g., which may include conversion (e.g., polymerization) of the polymerizable binder precursor into the final (e.g., polymerized) form of the binder)—(stage 202); (iii) (optionally in some designs, but often highly desired or required) densifying (compacting/calendering) and/or flattening the anode by suitable process (e.g., by gradually increasing pressure, by pulse compaction, by changing compaction pressure, by vibration-assistant compacting, and/or by temperature-assistant compacting, etc.)—(stage 203); (iv) providing a suitable cathode material composition (in the case of “dry” processing according to some embodiments, this composition may be referred to as a battery electrode (e.g., cathode) precursor composition, comprising suitable components, e.g., intercalation-type active cathode materials, conversion-type active cathode materials (including composites or nanocomposites), lithium metal oxide and other active cathode materials, conductive additives, other functional additives, polymerizable binder precursor compounds, etc., but may be substantially free of conventional solvents)—(stage 204); (v) depositing the cathode material composition onto (or into) a suitable cathode current collector by suitable solvent-free deposition process to form a cathode precursor disposed on and/or in the cathode current collector (e.g., by using a suitable “dry” electrode coating process) and transforming the cathode precursor to form the cathode (e.g., which may include conversion (e.g., polymerization) of the polymerizable binder precursor into the final (e.g., polymerized) form of the binder)—(stage 205); (vi) (optionally in some designs, but often highly desired or required) densifying (compacting/calendering) and/or flattening the cathode by suitable process (e.g., by gradually increasing pressure, by pulse compaction, by changing compaction pressure, by vibration-assistant compacting, and/or by temperature-assistant compacting, etc.)—(stage 206); (vii) assembling the battery cell using the produced anode and the cathode, a suitable separator (which may comprise, for example, polymer and/or ceramic components), packaging materials, and other cell components, filling the cell with a suitable electrolyte, and carrying out electrochemical formation, degassing, sealing and aging processes, among others, to produce a superior battery cell for use in a battery system for an energy storage in transportation, electronic devices, electrical grid, and many other important applications (stage 208). Note that in some designs (e.g., when using extrusion) the “dry” electrode deposition onto and/or into the current collector (stage 202 or 205) may already include compaction during extrusion, corresponding to stage 203 or stage 206.

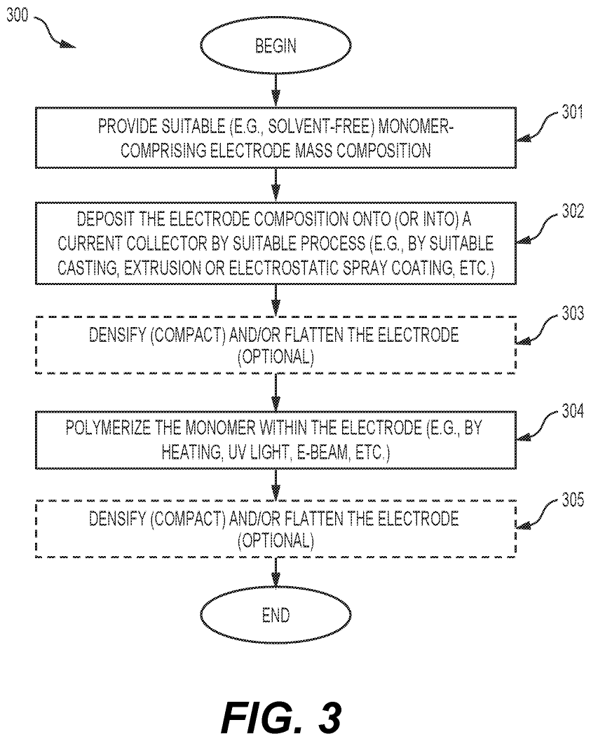

FIG. 3 illustrates an example method (300) for the “dry” (i.e., substantially free of conventional solvents) formation of electrodes. This example method (300) may comprise the following stages: (i) providing a suitable battery electrode precursor composition (for brevity, sometimes referred to as “electrode mass”), comprising, e.g., active materials, conductive additives, other functional additives, polymerizable binder precursor, other binder components, etc.) (the polymerizable binder precursor may include liquid monomer(s) and/or oligomer(s))—(stage 301); (ii) depositing the electrode mass onto (or into) a suitable current collector (e.g., a metal foil or metal mesh, etc.) to form a battery electrode precursor disposed on and/or in the current collector by a suitable “dry” (solvent-free) coating process (e.g., by a suitable casting, a suitable extrusion or a suitable electrostatic spray coating process, etc.)—(stage 302); (iii) densifying (compacting) and/or flattening the electrode by suitable process (optional in some designs)—(stage 303, being carried out before the subsequent stage 304); (iv) polymerizing the polymerizable binder precursor (e.g., monomer(s) and/or oligomer(s) and/or polymer(s) within the electrode precursor) by suitable process (e.g., by heating, UV light, e-beam, etc.)—(stage 304); (v) densifying (compacting) and/or flattening the electrode by suitable process (optional in some designs)—(stage 305, being carried out after the preceding stage 304).

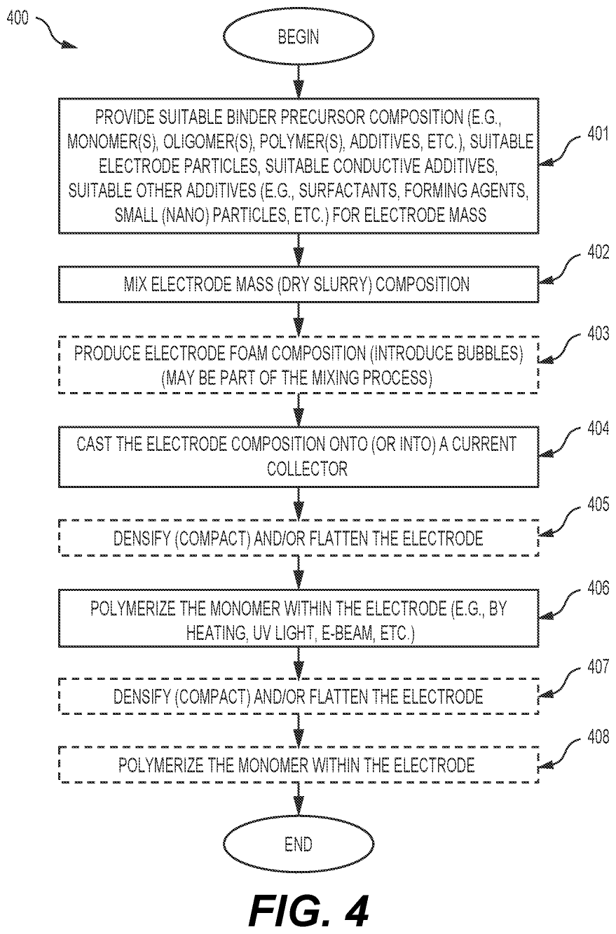

FIG. 4 illustrates an example casting method (400) for the “dry” (i.e., substantially free of conventional solvents) formation of electrodes. This example method (400) may comprise the following stages: (i) providing a suitable battery electrode precursor composition (“electrode mass”), comprising, e.g., a polymerizable binder precursor (e.g., monomer(s), oligomer(s), polymer(s), additives, etc.), suitable active electrode particles (which may be pre-coated with a suitable binder component, in some designs), suitable conductive additives, suitable other functional additives (e.g., surfactants, forming agents, small (nano) particles, etc.)—(stage 401); (ii) mixing the battery electrode precursor composition—(stage 402) and (optionally) forming electrode foam (introducing gas bubbles of suitable sizes into the battery electrode precursor composition)—(stage 403) (in some designs, stages 402 and 403 may be combined or carried out concurrently (e.g., as part of 402); (iii) casting the battery electrode precursor composition on a suitable current collector—(stage 404); (iv) (optionally) densifying (compacting) and flattening the battery electrode precursor—(stage 405); (v) converting (e.g., polymerizing, cross-linking) the polymerizable binder precursor (e.g., monomer(s), oligomer(s), polymer(s)) within the battery electrode precursor by a suitable process to form the electrode (e.g., by heating, UV light, e-beam, etc.)—(stage 406); (optionally) conducting additional densification, compacting, and/or flattening processes (stage 407); and polymerization (and cross-linking) processes (stage 408) (the second polymerization and/or cross-linking at 408 are optional). Note that in some designs, some densification (stage 405) may be desirable prior to polymerization of the polymerizable binder precursor (stage 406), while in other designs such a polymerization stage (or, at least, initial polymerization) (stage 406) may precede the densification/compacting/flattening stage (stage 406). More than one densification (compacting)/flattening stage (stages 405, 407) may be employed in some designs. More than one polymerization stage (stages 406, 408) may be employed in some designs.

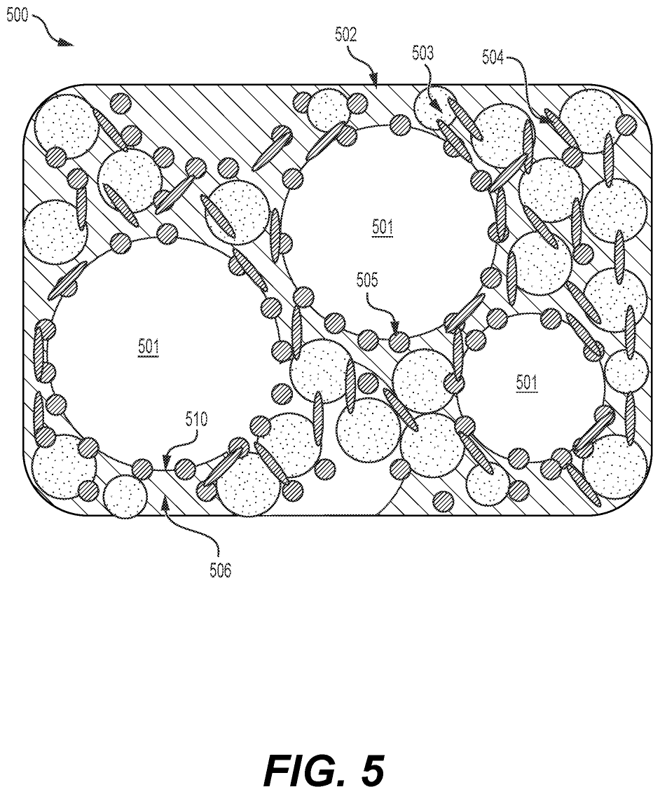

FIG. 5 schematically illustrates an example of a foamed battery electrode precursor composition (500), which may be implemented in “dry” (i.e., substantially free of conventional solvents) electrode processing (e.g., casting). This composition or electrode mass (500) may comprise: gas bubbles (501) of a suitable size distribution (the gas bubbles 501 are represented as white round regions) and the dispersed phase of electrode mass (502), wherein the following components may be present in the electrode mass dispersed phase (502) or at the interfaces (510) between the electrode mass dispersed phase (502) and the respective gas bubbles (501): electrode active material particles (503), conductive additives (504), additives (505) (in the example shown, the additives are represented as hatched circles and may be in solid form although additive may also be in liquid form) (e.g., particles, surfactants, polymers, etc. added for enhancing foam stability), a binder precursor (or other binder components) (506) (shown as a continuous phase for simplicity and for illustrative purposes only; the binder precursor or other binder components may coat the individual particles, may comprise nanofibers; there may additionally be pores within the binder precursor phase or pores between the particles, etc.).

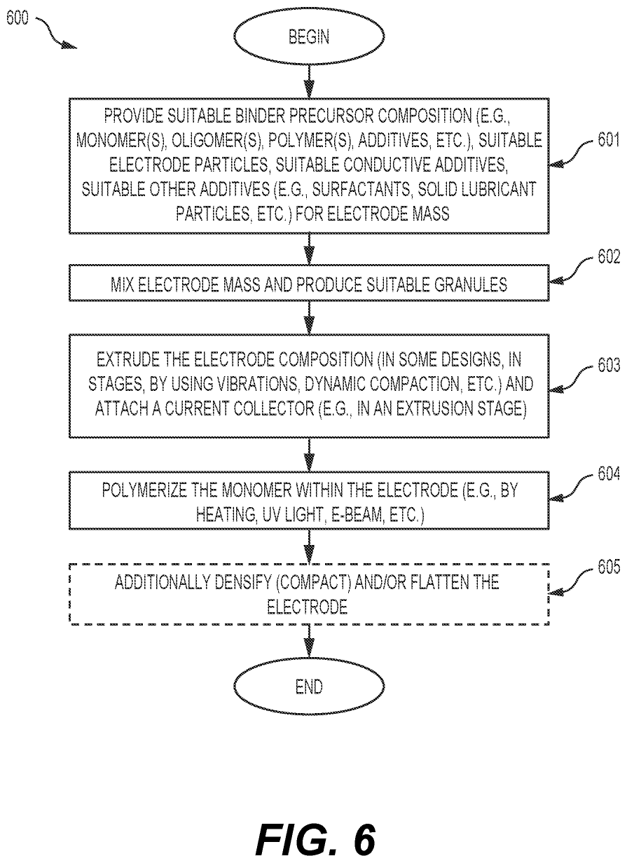

FIG. 6 illustrates an example extrusion method (600) for the “dry” (i.e., substantially free of conventional solvents) formation of electrodes. This example method (600) may comprise the following stages: (i) providing a suitable battery electrode precursor composition (“electrode mass”), comprising, e.g., a polymerizable binder precursor (e.g., monomer(s), oligomer(s), polymer(s), additives, etc.), suitable electrode active material particles (which may be pre-coated with a suitable binder component, in some designs), suitable conductive additives, suitable other functional additives (e.g., surfactants, solid lubricant particles, etc.)—(stage 601); (ii) mixing the electrode mass, and in some designs, producing electrode mass granules of suitable size—(stage 602); (iii) adding the uniformly mixed electrode mass or electrode mass granules into the extruder and extruding the battery electrode precursor composition by a suitable process to form a battery electrode precursor (in some designs, in stages, and by using vibrations, dynamic compaction, etc.) and attaching (e.g., laminating) the battery electrode precursor to a current collector (which may be done in one of the extrusion stages in some designs)—(stage 603); (iv) converting (e.g., polymerizing, cross-linking) the polymerizable binder precursor (e.g., monomer(s), oligomer(s), polymer(s)) within the battery electrode precursor by a suitable process to form the electrode (e.g., by heating, UV light, e-beam, etc.)—(stage 604); and (v) (optionally) conducting additional densification, compacting, and/or flattening processes—(stage 605).

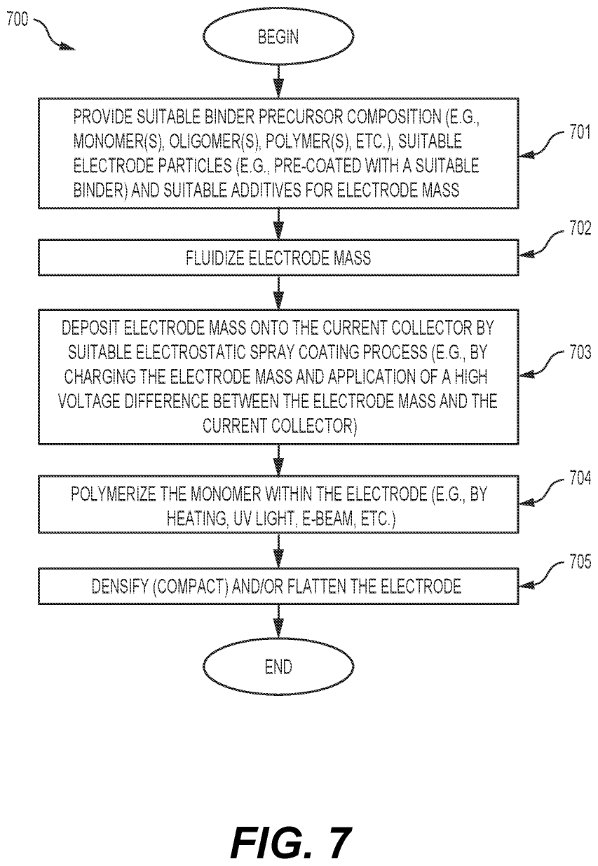

FIG. 7 illustrates an example electrostatic spray coating method (700) for the “dry” (i.e., substantially free of conventional solvents) formation of electrodes. This method (700) may comprise the following stages: (i) a suitable battery electrode precursor composition (“electrode mass”), comprising, e.g., a polymerizable binder precursor (e.g., monomer(s), oligomer(s), polymer(s), additives, etc.), suitable electrode active material particles (which may be pre-coated with a suitable binder component, in some designs), suitable conductive additives, suitable other functional additives (e.g., surfactants, solid lubricant particles, etc.)—(stage 701); (ii) mixing and fluidizing the electrode mass by a suitable process—(stage 702); (iii) depositing the electrode mass onto and/or into the current collector by a suitable electrostatic spray coating process (e.g., by charging the electrode mass and application of a high voltage difference between the electrode mass and the current collector)—(stage 703); (iv) converting (e.g., polymerizing, cross-linking) the polymerizable binder precursor (e.g., monomer(s), oligomer(s), polymer(s)) within the battery electrode precursor by a suitable process to form the electrode (e.g., by heating, UV light, e-beam, etc.)—(stage 704); and (v) densifying (compacting) and flattening the electrode by suitable process—(stage 705).

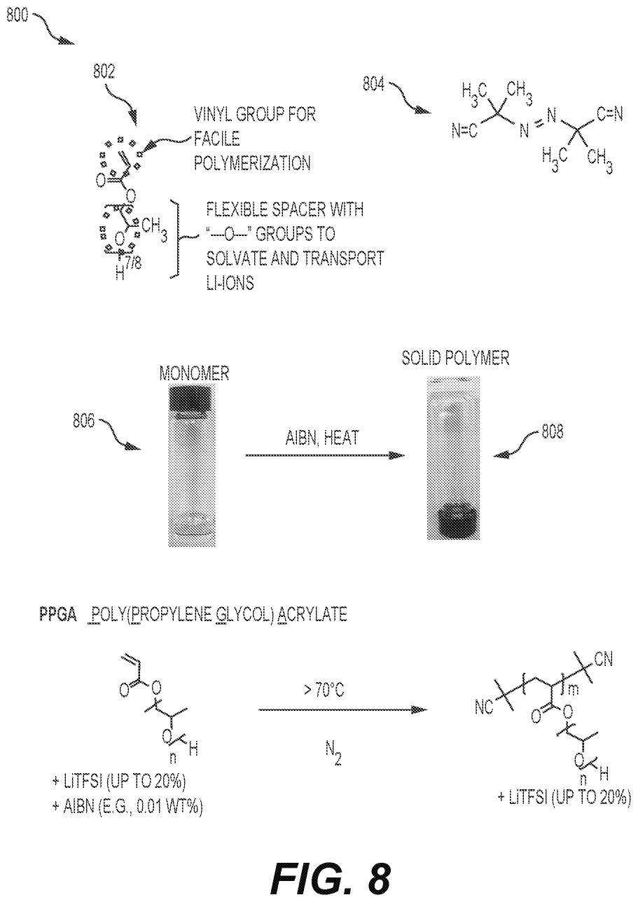

FIG. 8 illustrates an example polymerization process (800) using an acrylate-based binder chemistry for use in a “dry” electrode manufacturing process. The oligomer 802 (poly(propylene glycol)acrylate) (abbreviated as PPGA) is a liquid commercially available polymerizable oligomer, which contains an oligomeric PEG chain to facilitate ion-transport through the binder. In the example shown, the initiator is azobisisobutyronitrile (AIBN), shown as 804 in FIG. 8. The oligomer (PPGA) can readily dissolve the initiator (AIBN) at concentrations in a range of about 0.1-15%, and is stable at room temperature (that is, virtually no polymerization occurs at room temperature within hours or days). Upon heating the oligomer and initiator solution above about 60° C., the polymerization reaction typically begins and the monomer may polymerize into a solid within a few seconds, as seen in FIG. 8 (note the transformation of a vial 806 containing a transparent oligomer to a vial 808 containing an opaque polymer. Upon polymerization, all (or nearly all) the vinyl groups may be converted into poly(ethylene) backbone with chains terminated by nitrile groups. From the backbone, the PEG chains hang and organize into an assembly. This polymerization reaction may also be feasible in the presence of a suitable Li salt (e.g., lithium bis(trifluoromethanesulfonyl)imide (LiTFSI), among others), which may enable loading of Li-salt supplement into the binder, as needed. Such a polymerization reaction may be performed within an electrode precursor, whereby the formed polymer can serve as a binder in the resulting electrode (cathode, anode). The polymerization concepts schematically shown in FIG. 8 may be extended to other polymerizable binder precursor materials that polymerize by acrylate chemistry (as well as other chemistries).

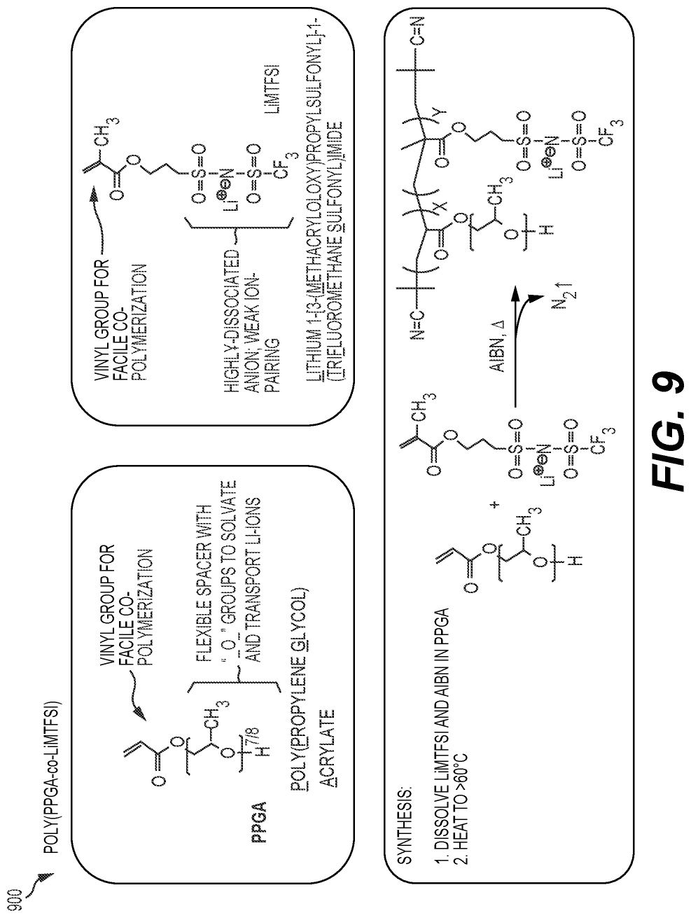

FIG. 9 illustrates an example polymerization process (900) using an acrylate-based co-polymer binder chemistry for use in a “dry” electrode manufacturing process. In this particular example, PPGA is copolymerized with another acrylate that contains lithium (i.e., a lithium salt known as lithium 1-[3-(methacryloyloxy)propylsulfonyl]-1-(trifluoromethane sulfonyl)imide, abbreviated as LiMTFSI). The polymerization reaction involves dissolving LiMTFSI in PPGA at a mole fraction in a range of about 1-50 mol % relative to the amount of PPGA, adding AIBN (initiator), and subsequently heating to above about 65° C. for a few seconds to a few minutes. The resulting copolymer formed by polymerization, often called a single Li-ion conducting polymer, can serve as an ion-conducting binder in the resulting electrode (cathode, anode) when the polymerization reaction is performed within the electrode precursor.

In some designs, the conventional “dry” or “solvent-free” electrode processing that relies on the use of fibrillated PTFE-like polymers (including copolymers) may be significantly improved by using one or more aspects of this disclosure (e.g., to attain a higher electrode uniformity, reduced amount of agglomerates, reduced number of defects, improved yield, improved adhesion to current collector foils, etc.). In some implementations, a binder may comprise multiple binder components (e.g., a first binder component and a second binder component and optionally one or more additional binder components) The first and second binder components may have the same or different relative significance, the same or different relative quantity, and so on. In some designs, active materials (such as, for example, Si—C nanocomposites in case of the “dry” anode processing) may be advantageously coated or functionalized with other polymers prior to “dry” processing with conventional PTFE-like polymers. In some designs, active materials (electrode active material particles) may be pre-mixed with suitable secondary polymerizable binder precursor(s) (e.g., monomers, oligomers, etc.) and/or suitable (e.g., F-free) secondary polymers (e.g., binder polymers) (in some designs, active materials may additionally be pre-mixed with conductive additives and other additives) prior to “dry” processing with conventional primary PTFE-like polymers in order to (1) attain a higher level of electrode uniformity without “over-fibrillating” the PTFE-like polymers or to (2) improve adhesion of or mechanical properties of the electrodes or to (3) use less (i.e., smaller amounts of) PTFE-like polymers. If monomers (or oligomers) are used as a polymerizable binder precursor, these could be further polymerized prior to battery assembling or prior to battery use. In some designs, a suitable secondary polymerizable binder precursor (e.g., monomers, oligomers, etc.) or suitable secondary (e.g., fluorine-free) polymers may be mixed with conductive additives and other additives, active materials, and conventional primary PTFE-like polymers to produce an improved “dry” electrode mass. In some designs, the mass fraction (wt. %) of suitable monomers and/or suitable F-free polymers in such electrodes may range from about 0.5 wt. % to about 5 wt. % (e.g., about 0.5-1 wt. % or about 1-2 wt. % or about 2-3 wt. % or about 3-4 wt. % or about 4-5 wt. %) relative to the overall weight of dry electrodes. In some designs, the ratio of the weight of suitable monomers and/or suitable F-free polymers to the weight of PTFE-like polymers in dry electrodes may range from about 5:1 to about 1:20 (in some designs, from about 5:1 to about 2:1; in other designs, from about 2:1 to about 1:2; in other designs, from about 1:2 to about 1:5; in yet other designs, from about 1:5 to about 1:20).

Monomers or oligomers that may be utilized in combination with PTFE-like polymers are chemistry-specific. In the case of acrylate chemistry involving polymerization of unsaturated ester monomers or oligomers, illustrative examples of acrylate precursor include, but not limited to, methyl acrylate, methyl methacrylate, ethyl acrylate, ethyl methacrylate, n-propyl acrylate, n-propyl methacrylate, isopropyl acrylate, isopropyl methacrylate, lauryl acrylate, stearyl acrylate, butyl acrylate, 2-hydroxyethyl acrylate, 2-hydroxyethyl methacrylate, 3-hydroxypropyl methacrylate, 3-glycidyl propyl methacrylate, trimethylolpropane triacrylate, polyethylene glycol diacrylate, 1,6-hexanediol diacrylate, ethoxylated bisphenol A dimethacrylate, isobornyl acrylate, polyurethane acrylate, epoxy acrylate, polyethylene glycol monomethacrylate, aliphatic urethane acrylate oligomers, and aromatic urethane acrylate oligomers. Suitable commercially available acrylates include ARKEMA's SARTOMER products, such as SR-307, SR-306, SR-454, SR-9053, CN-131B, CN-502, CN-975, CN-986 and CN-301. Examples of thermal initiators include, but are not limited to, azobisisobutyronitrile (AIBN), 2,2′-azobis(2-methylpropionamidine) dihydrochloride (V-50), 2,2′-azobis(2,4-dimethylvaleronitrile) (ADMVN), benzoyl peroxide (BPO), di-tert-butyl peroxide (DTBP), diisopropyl peroxydicarbonate (DIPC), cumyl hydroperoxide (CHP), 2,2′-azobis(2-amidinopropane) dihydrochloride (V-511), and 2,2′-Azobis[2-(2-imidazolin-2-yl)propane] dihydrochloride (VA-044). Some examples of UV initiators are 2,2-1-dimethoxy-1,2-diphenylethan-1-one, 2-hydroxy-2-methyl-1-phenylpropanone, hydroxy-cyclohexylphenylketone, benzophenone, and isopropyl thioxanthone. Suitable commercially available photoinitiators include DAROCUR 1173, DAROCUR 4265, IRGACURE 184, IRGACURE 369, IRGACURE 651, IRGACURE 819, IRGACURE 907, IRGACURE 1700, ESACURE KIP 150, ESACURE TZT, and LUCIRIN TPO-L.

In the case of epoxy chemistry, various epoxy resins can be used with different cross-linking agents. Examples include bisphenol A diglycidyl ether, Novolac epoxy resin, aliphatic epoxy resin, cycloaliphatic epoxy resin, and glycidyl amine epoxy resin. These epoxy resins can be used with hardening agents or curing agents. These are typically amine based reagents, such as diethylenetriamine, triethylenetetramine, and polyamines, which react with the epoxide functional groups to form a crosslinked network. Amines could be nonaromatic (e.g., alkane, ether-functionalized alkane based containing suitable O, S or F functionalization), or aromatic amines (e.g., phenyl, naphthyl, or other heteroaromatic systems). Commercially available amines include JEFFAMINE products sold by HUNTSMAN, which include a range of monoamines, diamines and triamines attached to a polyether backbone. Selected examples are JEFFAMINE M-600, D-230, D-400, D-2000, ED-600, ED-900, EDR-148, T-403, T-3000, SD-2001, and RFD-270. Alternatively, anhydrides, such as phthalic anhydride and maleic anhydride, can react with the epoxide groups. Other anhydride examples include tetrahydrophthalic anhydride, methyltetrahydrophthalic anhydride, hexahydrophthalic anhydride, and nadic methyl anhydride. For the formation of epoxy resins using aromatic amines, polyanhydrides, dicyandiamide and combinations, with phenol formaldehyde and melamine formaldehyde, etc.), it may be advantageous in some designs to use one of the following curing methods: (i) application of heat, (ii) application of an electron beam (e-beam), (iii) a combination of both heat and e-beam exposure.

In the case of the urethane/urea chemistry, it may be advantageous to utilize heat. Polyurethane can be formed by mixing a polyisocyanate with a polyol. Polyurethane chemistry can be further modified by the choice of polyol, polyisocyanate, and crosslinking agent. For example, the final properties of the polyurethane can be custom tailored by using polyols with different molecular weights, functionalities and structures. Examples of polyols include polyester polyols, polyether polyols, polycaprolactone polyols, acrylic polyols, and polysaccharide polyols. Similarly, the choice of polyisocyanate and crosslinking agent can be used to modify the reactivity and performance of the polyurethane. Examples of isocyanates include toluene diisocyanate (TDI), diphenylmethane diisocyanate (MDI), hexamethylene diisocyanate (HDI), isophorone diisocyanate (IPDI), naphthalene diisocyanate (NDI), and polymethylene polyphenyl isocyanate (PAPI). These isocyanates can be blocked to temporarily suppress their reactivity towards polyols at ambient temperature, but activated at an elevated temperature. When a blocked isocyanate is heated, the blocking agent is released, allowing isocyanate groups to react with the polyols. Some common blocking agents used in the preparation of blocked isocyanates include phenols, oximes and lactams. Polyurethane prepolymers can further react with a low molecular weight diol or diamine to extend the polymer chain length or crosslinked with a crosslinking agent. The crosslinking agent is typically a compound with multiple isocyanate reactive groups, such as a polyol or a polyamine.

Illustrative examples of suitable polymers that may be utilized in combination with PTFE-like polymers include, but are not limited to: carboxymethyl cellulose (and its derivative with different degrees of substitution), polytetrafluoroethylene (PTFE) (and its derivatives), polyvinylidene fluoride, alginate, xanthan gum, polystyrene, poly(styrene-butadiene) rubber (SBR), poly(acrylonitrile-butadiene-styrene) (ABS), polymethylmethacrylate (PMMA), high- and low-density polyethylene, polycarbonate, polypropylene, polyurethane, polyvinylchloride-acrylic acid/ester copolymers, polychlorotrifluoroethylene (PCTFE), ethylene-chlorotrifluoroethylene (E-CTFE), fluorinated ethylene propylene (FEP), ethylene tetrafluoroethylene (ETFE), perfluoroalkoxy alkanes (PFA), styrene-acrylonitrile (SAN), styrene-co-acrylic acid and salts thereof, styrene-maleic anhydride (SMA), polyethylene terephtalate (PET), polyesters, polybutylene terephtalate (PBT), polyarylate (PAR), polyamides (nylons) of different types, polyimides, polyetherimides, polyaryletherketone (PAEK), polysulfone (PSF), polyethersulfone (PES), chitosan, polyacrylic acid, polyacrylonitrile, polyvinyl alcohol, xanthan gum, poly(3,4-ethylenedioxythiophenc) polystyrene sulfonate (PEDOT:PSS), polymers with heterocycles (e.g., pyridine, thiophene), polyacrylamide, polyacrylamide-acrylic acid (or salts) copolymers, etc.

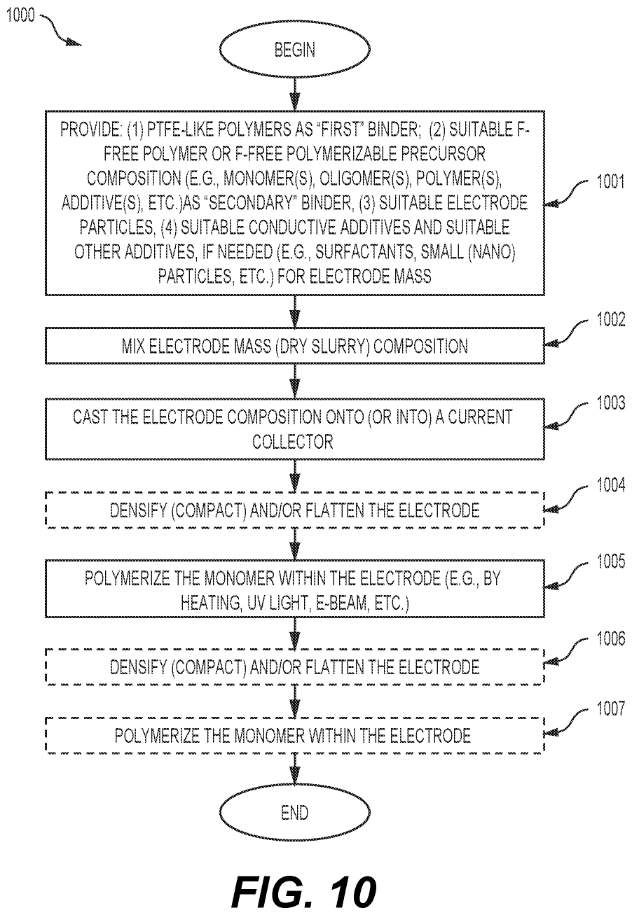

FIG. 10 illustrates an example method (1000) for the “dry” (i.e., substantially free of conventional solvents) formation of electrodes. This example method (1000) may comprise the following stages: (i) providing a suitable battery electrode precursor composition (“electrode mass”), comprising: a fluorinated primary polymer such as a PTFE-like polymer as a first binder composition, a fluorine-free polymerizable binder precursor (e.g., monomer(s), oligomer(s), polymer(s), additives, etc.) and/or one or more of another F-free polymer or their various mixtures as a second binder composition, suitable active electrode particles (which may be pre-coated with a suitable binder component, in some designs), suitable conductive additives, suitable other functional additives (e.g., surfactants, forming agents, small (nano) particles, etc.)—(stage 1001); (ii) mixing the battery electrode mass composition—(stage 1002); (iii) casting the battery electrode mass composition on a suitable current collector—(stage 1003); (iv) (optionally) densifying (compacting) and flattening the battery electrode—(stage 1004); (v) converting (e.g., polymerizing, cross-linking) the secondary polymerizable binder precursor (e.g., monomer(s), oligomer(s), polymer(s)) within the battery electrode precursor by a suitable process to form the electrode (e.g., by heating, UV light, e-beam, etc.) (in implementations in which the electrode mass comprises no polymerizable composition, this stage may be omitted)—(stage 1005); (optionally) conducting additional densification, compacting, and/or flattening processes—(stage 1006); and (optionally) polymerization (and optionally cross-linking) processes—(stage 1007). More than one densification (compacting)/flattening stage may be employed in some designs. More than one polymerization stage or no polymerization stage may be employed in some designs.

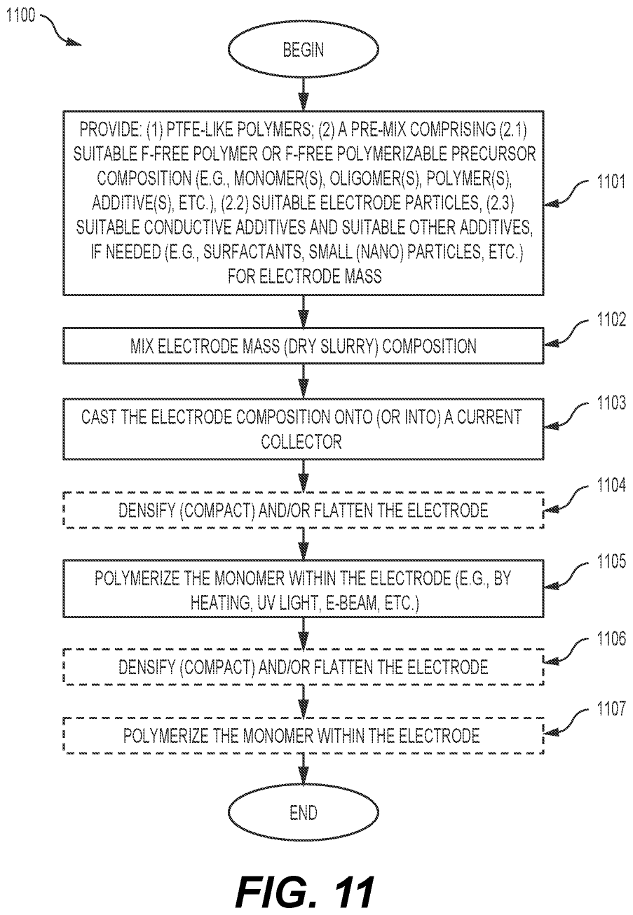

FIG. 11 illustrates an example method (1100) for the “dry” (i.e., substantially free of conventional solvents) formation of electrodes. This example method (1100) may comprise the following stages: (i) providing a suitable fluorinated primary polymer such as PTFE-like polymers and a suitable pre-mix of fluorine-free polymerizable binder precursor (e.g., monomer(s), oligomer(s), polymer(s), additives, etc.) and/or one or more of another F-free polymer or their various mixtures, suitable active electrode particles (which may be pre-coated with a suitable binder component, in some designs), suitable conductive additives, suitable other functional additives (e.g., surfactants, forming agents, small (nano) particles, etc.) for electrode mass—(stage 1101); (ii) mixing the battery electrode mass composition (i.e., the materials provided at 1101)—(stage 1102); (iii) casting the battery electrode mass composition on a suitable current collector—(stage 1103); (iv) (optionally) densifying (compacting) and flattening the battery electrode—(stage 1104); (v) converting (e.g., polymerizing, cross-linking) the polymerizable binder precursor (e.g., monomer(s), oligomer(s), polymer(s)) within the battery electrode precursor by a suitable process to form the electrode (e.g., by heating, UV light, e-beam, etc.) (in implementations in which the electrode mass comprises no polymerizable composition, this stage may be omitted)—(stage 1105); (optionally) conducting additional densification, compacting, and/or flattening processes—(stage 1106); and (optionally) polymerization (and optionally cross-linking) processes—(stage 1107). More than one densification (compacting)/flattening stage may be employed in some designs. More than one polymerization stage or no polymerization stage may be employed in some designs. Note that not all the active material(s) or not all conductive or other additives may be added into the pre-mix-some of these may be added as individual components for the electrode mass (stage 1101) prior to mixing (stage 1102).

Some embodiments of the present disclosure on Li-ion batteries may benefit from the use of certain separators or separator components in battery cell fabrication using “dry” electrode processing. In some designs, for example, the separator (or one or more layers of the separator) may comprise an initiator component to induce polymerization of the polymerizable binder precursor (e.g., monomers, oligomers) in one of the later stages of the “dry” electrode fabrication, after processing of the battery electrode precursor composition to form a battery electrode precursor. In some designs, the separator (or the separator layer(s)) may help to minimize adhesion between the rollers and the solvent-free (“dry”) electrode during densification (compaction) and/or contact heating.

In some designs, it may be advantageous for a separator layer to be directly deposited onto the surface of the electrode or electrode precursor. In some designs, the stack of the “dry” electrode and the separator may be further jointly densified (compacted) and heated.

In some designs, it may be advantageous for the separator or a separator layer to comprise nanoparticles or, in some designs, nanofibers, nanotubes or nanowires (e.g., polymer or ceramic nanofibers or nanowires). Such 1D materials (nanowires, nanofibers, nanotubes, etc.) may enhance mechanical properties and enable fast electrolyte diffusion into the electrode. Because “dry”-processed electrodes may exhibit lower tortuosity than regularly slurry-cast electrodes, the high ion conductivity of the separator layer (e.g., enabled using 1D materials) becomes particularly important. In some designs, it may be advantageous for these nanofibers and nanowires to be porous. In some designs, the pores in such fibers may be impregnated with functional additives (e.g., initiators, etc.).

Illustrative examples of suitable nanoparticle, nanofiber, nanotube or nanowire compositions include, but are not limited to: (i) metal oxides including mixed metal oxides (e.g., aluminum oxide (e.g., Al₂O₃) or magnesium oxide (e.g., MgO) or mixed aluminum-magnesium oxide or mixed aluminum-lithium oxide or mixed aluminum-lithium-sodium oxide or mixed aluminum-magnesium-lithium-sodium oxide or other (e.g., silicon-comprising) oxides, etc.); (ii) metal hydroxide and oxyhydroxides (e.g., Mg(OH)₂, AlOOH, Mg₂O(OH)₂, etc.) which may comprise Li, Na and other metals; (iii) metal oxy-fluorides and mixed metal oxy-fluorides (including those comprising Al, Mg, Si, Li, Na, etc.); (iv) ultra-high and high strength polymers (e.g., aramid, polyarylate, polybenzoxazole, high and ultra-high molecular weight polyethylene, polyester, polyimide, etc.); (v) natural polymers (e.g., cellulose, chitin, etc.), to name a few.

In some designs, the suitable diameter of nanowires and nanofibers may range from about 5 nm to about 500 nm (in some designs, from about 5 nm to about 25 nm; in other designs, from about 25 nm to about 100 nm; in other designs, from about 100 nm to about 250 nm; in yet other designs, from about 250 nm to about 500 nm).

Some embodiments of the present disclosure on Li-ion batteries may benefit from the use of certain electrolyte compositions in battery cell fabrication to attain superior characteristics. In some designs, suitable electrolyte composition may comprise (i) one, two, three or more Li salts with the total concentration in the range from about 0.8 M to about 2.0 M (in some designs, from about 0.8 M to about 1.0 M; in other designs, from about 1 M to about 1.1 M; in other designs, from about 1.1 M to about 1.2 M; in other designs, from about 1.2 M to about 1.3 M; in other designs, from about 1.3 M to about 1.4 M; in other designs, from about 1.4 M to about 1.5 M; in other designs, from about 1.5 M to about 1.6 M; in other designs, from about 1.6 M to about 1.7 M; in other designs, from about 1.7 M to about 1.8 M; in other designs, from about 1.8 M to about 2.0 M); (ii) one, two or more cyclic carbonates (in some designs, fluorinated cyclic carbonates, such as fluoroethylene carbonate (FEC), among others), (iii) zero, one, two, three or more nitrogen-comprising co-solvents (in some designs, at least some of the nitrogen comprising co-solvents may advantageously comprise two or three or more nitrogen atoms per molecules), (iv) zero, one, two, three or more sulfur comprising co-solvents, (v) zero, one, two, three or more phosphorous comprising co-solvents (note that some co-solvents may advantageously comprise both phosphorus and sulfur), (vi) zero, one, two, three or more linear or branched esters as co-solvents, (vii) zero, one, two, or more linear carbonates as co-solvents, (viii) zero, one, two, three or more additional electrolyte co-solvents or additives. In some designs, the volume fraction of linear esters (as a fraction of all co-solvents in the electrolyte) may range from about 20 vol. % to about 85 vol. % (in some designs, from about 20 vol. % to about 40 vol. %; in other designs, from about 40 vol. % to about 60 vol. %; in yet other designs, from about 60 vol. % to about 85 vol. %). In some designs, the volume fraction of branched esters (as a fraction of all co-solvents in the electrolyte) may range from about 10 vol. % to about 80 vol. % (in some designs, from about 10 vol. % to about 30 vol. %; in other designs, from about 30 vol. % to about 60 vol. %; in yet other designs, from about 60 vol. % to about 80 vol. %). In some designs, the volume fraction of cyclic carbonates (as a fraction of all co-solvents in the electrolyte) may range from about 5 vol. % to about 40 vol. % (in some designs, from about 5 vol. % to about 10 vol. %; in other designs, from about 10 vol. % to about 20 vol. %; in yet other designs, from about 20 vol. % to about 40 vol. %). In some designs, the volume fraction of fluorinated cyclic carbonates (as a fraction of all co-solvents in the electrolyte) may range from about 1 vol. % to about 20 vol. % (in some designs, from about 1 vol. % to about 4 vol. %; in other designs, from about 4 vol. % to about 6 vol. %; in other designs, from about 6 vol. % to about 12 vol. %; in yet other designs, from about 12 vol. % to about 20 vol. %). In some designs, the volume fraction of vinylene carbonate (VC) (as a fraction of all co-solvents in the electrolyte) may range from about 0.25 vol. % to about 6 vol. % (in some designs, from about 0.25 vol. % to about 0.5 vol. %; in other designs, from about 0.5 vol. % to about 1 vol. %; in other designs, from about 1 vol. % to about 2 vol. %; in yet other designs, from about 2 vol. % to about 6 vol. %). In some designs, 50 vol. % or more of the co-solvents may advantageously exhibit a melting point below about minus (−) 60° C. (in some designs, below about −70° C.; in other designs, below about −80° C.). In some designs utilizing two or more salts (e.g., two salts or three salts or four salts or five salts, etc.), it may be advantageous for the two or more salts to comprise LiPF₆. In some designs, the incorporation of such salts may enhance battery performance properties (cycle stability, resistance, thermal stability, performance at high or low temperatures, etc.), enhance properties of the cathode-electrolyte interphase (CEI) or of the anode's solid-electrolyte interphase (SEI), or provide other performance advantages. In some designs utilizing two or more salts (e.g., the first salt being LiPF₆), it may be additionally advantageous for at least one other salt to also be a salt of Li. Examples of some of such suitable additional salts include, but are not limited to, lithium bis(fluorosulfonyl) imide (LiFSI), lithium bis(trifluoromethanesulfonyl)imide (LiTFSI), lithium Bis(pentafluoroethanesulfonyhimide (LiBETI) (and other Li imide salts), lithium bis(oxalato)borate (LiBOB), lithium difluoro(oxalato)borate (LiDFOB), lithium 4,5-dicyano-2-(trifluoromethyl)imidazole (LiTDi), lithium 4,5-dicyano-2-(pentafluoroethyl) imidazolide (LiPDi), lithium difluorophosphate (LiDFP), and lithium nitrate (LiNO₃).

Battery cell modules or battery cell packs may advantageously comprise cells with anode electrodes, cathode electrodes, separators and/or electrolyte compositions provided in this disclosure. Such cell modules or packs may offer improved performance characteristics, simplified designs, better safety features, and/or lower cost.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of making a battery electrode, the method comprising: (A1) providing a battery electrode precursor composition comprising an electrochemically active material and a polymerizable binder precursor; (A2) processing the battery electrode precursor composition to form a battery electrode precursor disposed on or in a current collector; and (A3) transforming the battery electrode precursor to form a battery electrode comprising a binder, wherein: the transforming of the battery electrode precursor comprises polymerizing the polymerizable binder precursor in the battery electrode precursor to form the binder.

Clause 2. The method of clause 1, wherein: the electrochemically active material comprises silicon and carbon.

Clause 3. The method of any of clauses 1 to 2, wherein: the electrochemically active material comprises graphite.

Clause 4. The method of any of clauses 1 to 3, wherein: the polymerizable binder precursor comprises one or more of: a monomer, an oligomer, and a polymer.

Clause 5. The method of any of clauses 1 to 4, wherein: the polymerizable binder precursor is in a liquid form at any temperature in a range of about 20° C. to about 30° C.

Clause 6. The method of any of clauses 1 to 5, wherein: the battery electrode precursor composition comprises a polymerization inhibitor and/or a polymerization initiator.

Clause 7. The method of any of clauses 1 to 6, wherein: the battery electrode precursor composition additionally comprises electrically conductive additives and/or functional additives.

Clause 8. The method of any of clauses 1 to 7, wherein: the battery electrode precursor composition is substantially free of conventional solvents.

Clause 9. The method of any of clauses 1 to 8, wherein: the battery electrode precursor composition additionally comprises a Li salt.

Clause 10. The method of any of clauses 1 to 9, wherein: the providing of the battery electrode precursor composition comprises mixing the electrochemically active material and the polymerizable binder precursor.

Clause 11. The method of any of clauses 1 to 10, wherein: the providing of the battery electrode precursor composition comprises making gas bubbles in the battery electrode precursor composition.

Clause 12. The method of any of clauses 1 to 11, wherein: the processing of the battery electrode precursor composition comprises casting the battery electrode precursor composition onto the current collector or extruding the battery electrode precursor composition.

Clause 13. The method of any of clauses 1 to 12, wherein: the processing of the battery electrode precursor composition comprises (1) granulating the battery electrode precursor composition and (2) extruding the granulated battery electrode precursor composition.

Clause 14. The method of any of clauses 1 to 13, wherein: the processing of the battery electrode precursor composition comprises coating the battery electrode precursor composition onto the current collector by electrostatic spray coating.

Clause 15. The method of any of clauses 1 to 14, wherein: the polymerizing of the polymerizable binder precursor comprises applying one or more of the following to the battery electrode precursor: (1) a heat treatment, (2) an ultraviolet light treatment, and (3) an electron beam treatment.

Clause 16. The method of any of clauses 1 to 15, additionally comprising: (A4) densifying the battery electrode.

Clause 17. A battery electrode, wherein: the battery electrode is made according to the method of claim 1.

Clause 18. The battery electrode of clause 17, wherein: the battery electrode is characterized by a reversible areal capacity loading in a range of about 2 mAh/cm² to about 16 mAh/cm².

Clause 19. A lithium-ion battery, comprising: an anode current collector; a cathode current collector; an anode disposed on or in the anode current collector; a cathode disposed on or in the cathode current collector; and an electrolyte ionically coupling the anode and the cathode, wherein: at least one of the anode and the cathode comprises the battery electrode of clause 17 or clause 18.

Clause 20. The lithium-ion battery of clause 19, wherein: the lithium-ion battery additionally comprises a separator electrically separating the anode and the cathode.

Clause 21. The lithium-ion battery of any of clauses 19 to 20, wherein: an energy content of the lithium-ion battery is in a range of about 1 Wh to about 2000 Wh.

Clause 22. A method of making a lithium-ion battery, the method comprising: (B1) making a first electrode according to the method of claim 1, the battery electrode being the first electrode, the first electrode being disposed on or in a first current collector; (B2) making or providing a second electrode disposed on or in a second current collector; and (B3) assembling a battery cell from the first electrode and the second electrode and filling a space between the first electrode and the cathode with an electrolyte ionically coupling the first electrode and the second electrode to form the lithium-ion battery, wherein: the first electrode is configured as an anode and the second electrode is configured as a cathode, or the first electrode is configured as a cathode and the second electrode is configured as an anode.

Clause 23. A lithium-ion battery, wherein: the lithium-ion battery is made according to the method of clause 22.

Clause 24. The lithium-ion battery of clause 23, wherein: an energy content of the lithium-ion battery is in a range of about 1 Wh to about 2000 Wh.

This description is provided to enable any person skilled in the art to make or use embodiments of the present invention. It will be appreciated, however, that the present invention is not limited to the particular formulations, process steps, and materials disclosed herein, as various modifications to these embodiments will be readily apparent to those skilled in the art. That is, the generic principles defined herein may be applied to other embodiments without departing from the spirit or scope of the invention.

1. A method of making a battery electrode, the method comprising:
(A1) providing a battery electrode precursor composition comprising an electrochemically active material and a polymerizable binder precursor;
(A2) processing the battery electrode precursor composition to form a battery electrode precursor disposed on and/or in a current collector; and
(A3) transforming the battery electrode precursor to form a battery electrode comprising a binder,
wherein:
the transforming of the battery electrode precursor comprises polymerizing the polymerizable binder precursor in the battery electrode precursor to form the binder.

2. The method of claim 1, wherein:
the electrochemically active material comprises composite particles comprising silicon and carbon.

3. The method of claim 1, wherein:
the electrochemically active material comprises graphite.

4. The method of claim 1, wherein:
the polymerizable binder precursor comprises one or more of: a monomer, an oligomer, and a polymer.

5. The method of claim 1, wherein:
the polymerizable binder precursor is in a liquid form at any temperature in a range of about 20° C. to about 30° C.

6. The method of claim 1, wherein:
the battery electrode precursor composition comprises a polymerization inhibitor and/or a polymerization initiator.

7. The method of claim 1, wherein:
the battery electrode precursor composition additionally comprises electrically conductive additives and/or functional additives.

8. The method of claim 1, wherein:
the battery electrode precursor composition is substantially free of conventional solvents.

9. The method of claim 1, wherein:
the battery electrode precursor composition additionally comprises a Li salt.

10. The method of claim 1, wherein:
the providing of the battery electrode precursor composition comprises mixing the electrochemically active material and the polymerizable binder precursor.

11. The method of claim 1, wherein:
the providing of the battery electrode precursor composition comprises making gas bubbles in the battery electrode precursor composition.

12. The method of claim 1, wherein:
the processing of the battery electrode precursor composition comprises casting the battery electrode precursor composition onto and/or into the current collector or extruding the battery electrode precursor composition.

13. The method of claim 1, wherein:
the processing of the battery electrode precursor composition comprises (1) granulating the battery electrode precursor composition and (2) extruding the granulated battery electrode precursor composition.

14. The method of claim 1, wherein:
the processing of the battery electrode precursor composition comprises coating the battery electrode precursor composition onto and/or into the current collector by electrostatic spray coating.

15. The method of claim 1, wherein:
the polymerizing of the polymerizable binder precursor comprises applying one or more of the following to the battery electrode precursor: (1) a heat treatment, (2) an ultraviolet light treatment, and (3) an electron beam treatment.

16. The method of claim 1, additionally comprising:
(A4) densifying the battery electrode.

17. A battery electrode, wherein:
the battery electrode is made according to the method of claim 1.

18. The battery electrode of claim 17, wherein:
the battery electrode is characterized by a reversible areal capacity loading in a range of about 2 mAh/cm² to about 16 mAh/cm².

19. A lithium-ion battery, comprising:
an anode current collector;
a cathode current collector;
an anode disposed on and/or in the anode current collector;
a cathode disposed on and/or in the cathode current collector; and
an electrolyte ionically coupling the anode and the cathode,
wherein:
at least one of the anode and the cathode comprises the battery electrode of claim 17.

20. The lithium-ion battery of claim 19, wherein:
the lithium-ion battery additionally comprises a separator electrically separating the anode and the cathode.

21. The lithium-ion battery of claim 19, wherein:
an energy content of the lithium-ion battery is in a range of about 1 Wh to about 2000 Wh.

22. A method of making a lithium-ion battery, the method comprising:
(B1) making a first electrode according to the method of claim 1, the battery electrode being the first electrode, the first electrode being disposed on and/or in a first current collector;
(B2) making or providing a second electrode disposed on and/or in a second current collector; and
(B3) assembling a battery cell from the first electrode and the second electrode and filling a space between the first electrode and the cathode with an electrolyte ionically coupling the first electrode and the second electrode to form the lithium-ion battery,
wherein:
the first electrode is configured as an anode and the second electrode is configured as a cathode, or
the first electrode is configured as a cathode and the second electrode is configured as an anode.

23. A lithium-ion battery, wherein:
the lithium-ion battery is made according to the method of claim 22.

24. The lithium-ion battery of claim 23, wherein:
an energy content of the lithium-ion battery is in a range of about 1 Wh to about 2000 Wh.
